(19) United States
(12) Patent Application Publication
(10) Pub. No.: US 2003/0227607 A1
(43) Pub. Date: Dec. 11, 2003

(54) Exposure apparatus and an exposure method

(76) Inventors: Masaki Kato, Yokohama-shi (JP); Motoo Koyama, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 10/338,017

(22) Filed: Jan. 8, 2003

(30) Foreign Application Priority Data
Jan. 9, 2002 (JP) P2002-002623
Apr. 2, 2002 (JP) P2002-099814

(51) Int. Cl. G03B 27/42

(52) U.S. Cl. 355/53

(57) ABSTRACT

There is disclosed an exposure apparatus for transferring a pattern formed on a mask to a photosensitive substrate, comprising a light source; and an illumination optical system that illuminates the mask with light from this light source, wherein the illumination optical system comprises wavelength width changeover unit that changes over the wavelength width of the light that is directed onto said mask in accordance with the photosensitivity characteristics of the photosensitive substrate.

### BACKGROUND OF THE INVENTION

1. Field of the Invention

The present invention relates to an exposure apparatus and method used in the process of fabricating semiconductor device, liquid-crystal display device, image pickup device, thin-film magnetic heads or other micro-devices and to a method of fabricating a micro-device employing this exposure apparatus and method.

2. Related Background Art

Liquid-crystal display device, which are one type of micro-device, are usually fabricated by forming switching device such as TFTs (thin-film transistors) and electric wiring by patterning transparent thin film electrodes in a desired shape on a transparency substrate such as a glass substrate (plate) by a photolithographic technique. In this fabrication process using a photolithographic technique, a projection exposure apparatus is employed that effects projection exposure of a pattern constituting an original image formed on a mask onto a plate to which has been applied a photosensitive agent such as a photoresist, through a projection optical system. Conventionally, a projection exposure apparatus of the step and repeat type (so-called “stepper”) is frequently employed; after relative positional alignment of the mask and plate, this transfers the pattern formed on the mask en bloc onto a single shot region that is defined on the plate and, after this transfer has been effected, executes stepped movement over the plate and exposes another shot region.

In recent years, liquid-crystal display device of large area are being demanded and, accompanying this, expansion of the exposure region of the projection and exposure apparatus that is employed in the photolithographic step is desired. In order to expand the exposure region of the projection and exposure apparatus, it is necessary to make the projection optical system of large size; however, design and fabrication of such a large projection optical system in which residual aberration is reduced to the utmost present increased costs. In order to avoid as far as possible increase in the size of the projection optical system, a so-called “step and scan” type projection optical apparatus has therefore been proposed wherein, in a condition in which an illuminating beam in the form of a slit whose length in the longitude direction is set to be of the same order as the clear aperture diameter of the projection optical system on the object side (mask side) of the projection optical system is directed onto the mask and this slit-shaped beam that has passed through the mask is directed onto the plate through the projection optical system, scanning is effected by relative movement of the mask and the plate with respect to the projection optical system and, after transference has been effected to one of shot regions constituted by defining a partial pattern formed on the mask sequentially on the plate, stepwise movement of the plate is performed so that another shot region is exposed in the same way.

Also, in recent years, in order to further expand the exposure region, there has been proposed (see for example U.S. Pat. No. 5,729,331) a projection exposure apparatus which, instead of employing a single large projection optical system, comprises a so-called multi-lens type projection optical system wherein a first arrangement in which a plurality of small partial projection optical systems are arranged with a prescribed separation in a direction orthogonal to the scanning direction (non-scanning direction) and a second arrangement in which a partial optical system is arranged between this partial projection optical system arrangement are arranged in the scanning direction.

The degree of resolution that is required when fabricating a liquid-crystal display element using such a projection exposure apparatus is that required for fabricating a TFT and is for example of the order of 3 μm; with recent increases in plate size, flatness of the plate surface tends to be adversely affected by plate's warp etc. and there are limits to the extent to which this lack of flatness can be improved by altering the stage construction. The exposure projection apparatus is therefore designed such that the focal depth of the projection optical system is at least a little deeper, in order to obtain a resolution of the order of 3 μm, even if flatness of the plate surface is degraded.

In the fabrication of a liquid crystal display device, a substrate is formed that is formed with switching device such as TFTs and electrode wiring by applying a photoresist onto a plate, then transferring a pattern formed on a mask using one of the above projection exposure apparatuses onto the plate and repeating the steps of development of the photoresist, etching and exfoliation of the photoresist. A liquid-crystal display element is then fabricated by placing next to this substrate a counter substrate provided with color filters fabricated in a separate process, the liquid crystal being clamped between these.

While a conventional liquid-crystal display device was fabricated by separately forming and placing against each other a substrate formed of TFTs as described above and a counter substrate provided with color filters, in recent years, with changes in the construction of liquid-crystal display device, liquid crystal display device have been proposed of a construction in which the color filters are also formed on the substrate where the TFTs are formed. The process of fabricating a liquid-crystal display element of such a structure includes steps of applying a resin resist in which a colored pigment is dispersed onto a substrate formed with TFTs and forming color filters by developing this resin resist by exposing it using a projection exposure apparatus.

Whereas the sensitivity of a photoresist employed in forming TFTs etc. is of the order of 15 to 30 mJ/cm², the sensitivity of a resin resist is of the order of 50 to 100 mJ/cm² and the energy required for exposure of the resin resist is from a few times to a few tens of times that of an ordinary photoresist; The resolution required when exposing this resin resist may be a resolution of an order capable of forming an optically opaque layer between pixels of the liquid crystal display device so for example a resolution of the order of 5 μm is considered sufficient. That is, when forming TFTs etc. using an ordinary photoresist, since the sensitivity of the photoresist is high, only a small amount of exposure energy is required; however, a resolution of the order of 3 μm is necessary. In contrast, when color filters are formed using a resin resist, more exposure energy is required than in the case of a photoresist, but the resolution can be of the order of 5 μm.

Since, in the step and scan type projection exposure apparatus and projection exposure apparatus comprising a multi-lens type projection optical system described above, exposure is performed whilst moving the plate, the exposure energy is determined by the exposure power and the speed of movement of the plate. Since the speed of movement of the plate is determined by the appropriate amount of exposure of the resist employed, if the exposure power is constant, the plate may be moved at high speed when using a resist of high sensitivity but must be moved with low speed when using a resist of low sensitivity. However, since the stage becomes of large size when moved in a condition carrying the plate, the maximum speed that may be employed during exposure is prescribed beforehand with control performance in view. Also, moving it with too low a speed is a cause of lowered throughput. If we take the resist sensitivity as E, exposure power as P, the width of the exposure region in the scanning direction as 1, and the speed of the stage as S, the relationship of expression (1) below exists:

S=l.P/E (1)

Let us now assume that the maximum speed of the stage is 300 mm/sec and consider the case where a photoresist and a resin resist are exposed with this speed. It will further be assumed that the sensitivity of the photoresist is 20 mJ/cm² and that the sensitivity of the resin resist is 60 mJ/cm². Also, hereinbelow, the description will be given assuming that the width of the exposure region in the scanning direction is l=20 mm.

First of all, the case where the exposure power is determined with a photoresist in view will be described. Since the sensitivity of the photoresist is 20 mJ/cm², from the above expression (1), for an exposure power of 300 mW/cm², the maximum speed obtained by the stage is 300 mm/sec. In other words, since there is a restriction on the maximum speed of the stage, the exposure power cannot be made more than 300 mW/cm². If the exposure power is 300 mW/cm², in order to expose a resin resist, since the sensitivity of the resin resist is 60 mJ/cm², from the above expression (1), the speed of the stage must be set at 100 mm/sec. That is, if the exposure power is determined with a photoresist in view, the throughput when exposing a resin resist is greatly lowered.

Next, the case where the exposure power is determined with a resin resist in view will be described. Since the sensitivity of the resin resist is 60 mJ/cm², from expression (1) above, for an exposure power of 900 mW/cm², the maximum speed attained by the stage is 300 mm/sec. If the exposure power is 900 mW/cm², in order to expose a photoresist, since the sensitivity of the photoresist is 20 mJ/cm², from expression (1) above, the speed of stage must be set at 900 mm/sec; however, this value exceeds the maximum speed of the stage. Accordingly, if the exposure power is determined with a resin resist in view, in order to set the speed of the stage when exposing a photoresist at the maximum speed of 300 mm/sec, the power of the exposure beam must be reduced to an exposure power of the order of one third i.e. exposure power is wasted.

Thus, when exposing a photoresist, the exposure power must be set to ensure a resolution of the order of 3 μm and such that the maximum speed of the stage is not reached and when exposing a resin resist maximum exposure power must be set to ensure a resolution of the order of 5 μm and that the throughput is not lowered. Also, when exposing either resist, a depth of focus which is as deep as possible must be ensured in order to take account of degradation of flatness due to increased plate size.

The first object of the present invention is therefore to provide an exposure apparatus and method whereby the conditions during exposure such as the exposure power, stage speed and depth of focus can be optimally set in accordance with the sensitivity characteristic of the photosensitive substrate or the resolution required for forming the pattern on the photosensitive substrate and a method of fabricating micro-devices fabricated by forming a fine pattern using this apparatus or method.

Also, when forming TFTs etc. using an ordinary photoresist, since the sensitivity of the photoresist is high, the exposure energy need not be large, but a resolution of the order of 3 μm is necessary. In contrast, when forming color filters using resin resist, a larger exposure energy than in the case of a photoresist is necessary, but a resolution of the order of 5 μm is sufficient. Thus, since the required exposure energy is different spending on the sensitivity of the resist that is applied to the substrate, it is necessary to control the illuminance of the illuminating light that is directed onto the substrate such that the exposure energy has a prescribed value depending on the resist sensitivity.

However, in a projection exposure apparatus, it may be expected that the illuminance of the illuminating light directed onto the substrate through the projection optical unit may fluctuate due to secular deterioration of the lamp constituting the light source emitting the illuminating light or due to fluctuation of the amount of power supplied to the lamp. Since in the event of such fluctuation of the illuminance of the illuminating light in a projection exposure apparatus of the step and repeat type the amount of exposure is controlled by controlling the opening/closing time of a shutter, unevenness is generated in the amount of exposure, tending to lower the accuracy of the control of the amount of exposure. Also, in a projection exposure apparatus of the step and scan type, unevenness of exposure is produced when the illuminance of the illuminating light fluctuates during scanning exposure.

Accordingly, a second object of the present invention is to provide an exposure apparatus and an exposure method employing this exposure apparatus capable of performing exposure that is optimum in accordance with the spectral characteristics of the photosensitive material with which the substrate is covered and using illuminating light of a constant illuminance.

### SUMMARY OF THE INVENTION

In order to achieve the above first object, in an exposure apparatus according to an embodiment of the present invention comprising a light source (1) and an illumination optical system (IL) that illuminates a mask (M) with light from this light source (1) and that transfers a pattern (DP) formed on said mask (M) to said photosensitive substrate (P) by illuminating the photosensitive substrate (P) with light that has passed through said mask (M) said illumination optical system (IL) comprises wavelength width changeover means (6, 7) that changes over the wavelength width of the light that is directed onto said mask (M) in accordance with the photosensitivity characteristics of said photosensitive substrate (P). Preferably the photosensitivity characteristics of the photosensitive substrate include the photosensitive material.

Also, in order to achieve the second object, an exposure apparatus according to another embodiment of the present invention wherein a pattern formed on a mask is transferred onto a substrate to which photosensitive material has been applied comprises a light source and illuminance detection means that detects illumination by the light from this light source and comprises an illumination device that controls the light from said light source so as to produce a constant illuminance in accordance with recipe data including the detected value from this illuminance detection means and information relating to the spectral characteristics of said photosensitive material and a projection optical system that projects said pattern on the mask illuminated by the light from said illumination device onto the substrate.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a perspective view showing the diagrammatic construction of the entire exposure apparatus according to a first embodiment of the present invention;

FIG. 2 is a side face view of the illumination optical system IL;

FIG. 3 is a view given in explanation of the spectrum of the light transmitted through the wavelength selection filters 6 and 7;

FIGS. 4A and 4B show the relationships between the telecentricity of the illumination optical system IL and the illuminance distribution, FIG. 4A being a view showing the illuminance distribution at the input face of a fly's eye integrator and FIG. 4B being a view showing the illuminance distribution of the light directed onto the plate P;

FIG. 5A and FIG. 5B are views showing how the telecentricity of the illumination optical system is adjusted by altering the angle of the emission terminal 9b of the light guide 9;

FIG. 6 is a view showing an example of illuminance unevenness produced on the plate P;

FIG. 7 is a perspective view showing a modified example of the elimination optical system IL;

FIG. 8 is a side face view showing the construction of a projection optical unit PL1 constituting part of the projection optical system PL;

FIG. 9 is a view showing a diagrammatically the construction of a mask side magnification correction optical system 35a and a plate side magnification correction optical system 35b of FIG. 8;

FIG. 10 is a view showing diagrammatically the construction of a focus correction optical system 38 of FIG. 8;

FIG. 11 is a view showing the MTF when exposure light of wavelength width including a g-line, h-line and i-line is employed as the exposure light;

FIG. 12A is a view showing diagrammatically the construction of an illuminance measurement section 29 and given in explanation of a method of measuring the illuminance unevenness;

FIG. 12B and FIG. 12C are views showing the illuminance distribution obtained by the method of FIG. 12A;

FIG. 13 is a perspective view showing diagrammatically the construction of a space image measurement apparatus 24;

FIG. 14 is a view given in explanation of a method of detecting the optical characteristics of the projection optical units PL1 to PL5 using the aerial image measurement apparatus 24;

FIG. 15 is a flow chart showing an example of the operation of an exposure apparatus according to the first embodiment of the present invention;

FIG. 16 is a perspective view showing diagrammatically the construction of the entire exposure apparatus according to a second embodiment of the present invention;

FIG. 17 is a view showing the construction of an optical system of plate alignments sensors 70a to 70d;

FIG. 18 is a side face view showing the construction of a projection optical unit PL1 constituting part of the projection optical system PL in the exposure apparatus according to a third embodiment of the present invention;

FIG. 19 is a view showing diagrammatically the construction of a focus correction optical system 58 of FIG. 18;

FIG. 20 is a perspective view showing diagrammatically the construction of the entire exposure apparatus according to a fourth embodiment of the present invention;

FIG. 21 is a side face view of an illumination optical system according to a fourth embodiment of the present invention;

FIGS. 22A and 22B are views showing the shape of a light-absorbing plate and a heat sink according to an embodiment of the present invention;

FIG. 23 is a view given in explanation of the spectrum of the light transmitted through a wavelength selection filter according to an embodiment of the present invention;

FIG. 24 is a constructional view of an illumination optical system of an exposure apparatus according to a fifth embodiment of the present invention;

FIG. 25 is a constructional view of the light source unit of an illumination optical system according to a fifth embodiment of the present invention;

FIG. 26 is a constructional view of an illumination optical system of an exposure apparatus according to a sixth embodiment of the present invention;

FIG. 27 is a constructional view of an illumination optical system of an exposure apparatus according to a seventh embodiment of the present invention;

FIG. 28 is a constructional view of a light source unit of an illumination optical system according to a seventh embodiment of the present invention;

FIG. 29 is a flow chart of a method of fabricating a semiconductor device constituting a micro-device according to an embodiment of the present invention; and

FIG. 30 is a flow chart of a method of fabricating a liquid-crystal display element constituting a micro-device according to an embodiment of the present invention.

### DESCRIPTION OF THE PREFERRED EMBODIMENTS

In order to achieve the above first object, in an exposure apparatus according to a first aspect of the present invention comprising a light source (1) and an illumination optical system (IL) that illuminates a mask (M) with light from this light source (1) and that transfers a pattern (DP) formed on said mask (M) to said photosensitive substrate (P) by illuminating the photosensitive substrate (P) with light that has passed through said mask (M) wherein said illumination optical system (IL) comprises wavelength width changeover means (6, 7) that changes over the wavelength width of the light that is directed onto said mask (M) in accordance with the photosensitivity characteristics of said photosensitive substrate (P).

With the present invention, exposure can be effected in an appropriate manner of photosensitive substrates having various different photosensitivity characteristics, since it is arranged to be possible to obtain exposure power that is necessary for exposure in accordance with the photosensitivity characteristics of the photosensitive substrate by changing the exposure power by changing over the wavelength width of the light that is directed onto the mask in accordance with the photosensitivity characteristics of the photosensitive substrate. In this connection, preferably the photosensitivity characteristics of the photosensitive substrate include the photosensitive material.

In order to achieve the above first object, an exposure device according to a second aspect of the present invention comprising a light source (1) and an illumination optical system (IL) that illuminates a mask (M) with light from this light source (1) and that transfers a pattern (DP) formed on said mask (M) to said photosensitive substrate (P) by illuminating the photosensitive substrate (P) with light that has passed through said mask (M) wherein said illumination optical system (IL) comprises wavelength width changeover means (6, 7) that changes over the wavelength width of the light directed onto said mask (M) in accordance with the resolution of the pattern (DP) that is transferred onto said photosensitive substrate (P).

With the present invention, transfer of a pattern can be performed with a fully sufficient required resolution both in the case where a fine pattern that requires high resolution is transferred and in the case where a pattern that does not require such a high resolution is transferred, since the wavelength width of the light that is directed onto the mask is changed over in accordance with the resolution of the pattern that is transferred to the photosensitive substrate. Also, the exposure power is changed when the wavelength width of the light that is directed onto the mask is changed over. Consequently, a pattern with the required resolution can be formed in an excellent manner both in the case where for example a pattern must be formed with high resolution on a photosensitive substrate having photosensitivity characteristics such that high exposure power is not required and in the case where a pattern is formed with a resolution which is not particularly high on a photosensitive substrate having photosensitivity characteristics such that high exposure power is required.

Suitably, an exposure apparatus in accordance with the above first aspect or second aspect comprises: storage means (23) that stores processing information indicating the processes and the processing sequence in respect of said photosensitive substrate (P); and control means (20) that controls said wavelength width changeover means (6, 7) in accordance with said processing information.

Furthermore, preferably, said storage means (23) stores before hand illumination optical characteristics information indicating the optical characteristics of said illumination optical system (IL) that are appropriate for transfer of said pattern (DP) onto said photosensitive substrate (P) for each wavelength width to which changeover is effected by said wavelength width changeover means (6, 7) and said control means (20) adjusts the optical characteristics of said illumination optical system (IL) in accordance with said illumination optical characteristics information stored in said storage means (23) when the wavelength width of the light that is directed onto said mask (M) is changed over, by controlling said wavelength width changeover means (6, 7).

Furthermore, suitably the exposure apparatus comprises illumination optical characteristics detection means (29) that detects the optical characteristics of said illumination optical system (IL) and said control means (20) adjusts the optical characteristics of said illumination optical system (IL) while referring to the detection results of said illumination optical characteristics detection means (29) when the wavelength width of the light that is directed onto said mask (M) is changed over by controlling said wavelength width changeover means (6, 7).

In order to achieve said first object, an exposure apparatus according to the third aspect of the present invention comprises: a light source (1) and an illumination optical system (IL) that illuminates the mask (M) with light from this light source (1), in which the pattern (DP) formed on said mask (M) is transferred onto said photosensitive substrate (P) by directing onto the photosensitive substrate (P) light that has passed through said mask (M) and said illumination optical system (IL) comprises wavelength width changeover means (6, 7) that changes over the wavelength width of the light that is directed onto said mask (M); storage means (23) that stores illumination optical characteristics information indicating the optical characteristics of said illumination optical system (IL) appropriate to transfer of said pattern (DP) onto said photosensitive substrate (P) for each wavelength width that is changed over by said wavelength width changeover means (6, 7); and control means (20) that adjusts the optical characteristics of said illumination optical system (IL) in accordance with said illumination optical characteristics information stored in said storage means (23) when the wavelength width of the light that is directed onto said mask (M) is changed over by controlling said wavelength width changeover means (6, 7).

With the present invention, the mask pattern can be faithfully transferred to the photosensitive substrate, since illumination optical characteristics information indicating the optical characteristics of the illumination system that are suitable for transfer of the mask pattern to the photosensitive substrate is found beforehand for each wavelength width of the light that is directed onto the mask, the optical characteristics of the illumination optical system are adjusted in accordance with the illumination optical characteristics information when the wavelength width of the light that is directed onto the mask is changed over, and the illumination conditions of the mask can thereby be optimized for each wavelength width of the light it is directed onto the mask.

In order to achieve said first object, an exposure apparatus according to the fourth aspect of the present invention comprises: a light source (1); and an illumination optical system (IL) that illuminates the mask (M) with light from this light source (1); in which the pattern (DP) formed on said mask (M) is transferred onto said photosensitive substrate (P) by directing onto the photosensitive substrate (P) light that has passed through said mask (M) and said illumination optical system (IL) comprises wavelength width changeover means (6, 7) that changes over the wavelength width of the light that is directed onto said mask (M); illumination optical characteristics detection means (29) that detects the optical characteristics of said illumination optical system (IL); and control means (20) that adjusts the optical characteristics of said illumination optical system (IL) in accordance with the detection results of said illumination optical characteristics detection means (29) when the wavelength width of the light that is directed onto said mask (M) is changed over by controlling said wavelength width changeover means (6, 7).

With the present invention, the mask pattern can be faithfully transferred to the photosensitive substrate by adjusting the optical characteristics of the illumination optical system optimally in accordance with the actually detected optical characteristics, since the optical characteristics of the illumination optical system are detected when the wavelength width of the light that is directed onto the mask is changed over, and the optical characteristics of the illumination optical system are adjusted in accordance with the result of this detection.

In an exposure apparatus according to the first aspect to the fourth aspect above, the optical characteristics of said illumination optical system (IL) include at least one of the telecentricity of said illumination optical system (IL) and the illuminance unevenness of the light that is directed onto said mask (M).

Also, suitably, in an exposure apparatus according to the first aspect to the fourth aspect above, said illuminating optical system (IL) may comprise a plurality of illumination optical paths for forming a plurality of illumination regions on said mask (M) and said control means (20) may adjust the optical characteristics of said illumination optical system (IL) for each of said plurality of illumination optical paths.

Furthermore, preferably, in an exposure apparatus according to the first aspect to the fourth aspect above, said illuminating optical system (IL) comprises a sensor (17b) that detects the intensity of the light that is directed onto said mask (M) and said control means (20) adjusts the characteristics of said sensor in accordance with said wavelength width when the wavelength width of the light that is directed onto said mask (M) is changed over by controlling said wavelength width changeover means (6, 7).

In order to achieve the above first object, an exposure apparatus according to a fifth aspect of the present invention comprises: a light source (1) and an illumination optical system (IL) that illuminates the mask (M) with light from this light source (1); in which the pattern (DP) formed on said mask (M) is transferred onto said photosensitive substrate (P) by directing onto the photosensitive substrate (P) light that has passed through said mask (M) and said illumination optical system,(IL) comprises wavelength width changeover means (6, 7) that changes over the wavelength width of the light that is directed onto said mask (M); a sensor (17b) that detects the intensity of the light directed onto said mask (M); and control means (20) that adjusts the characteristics of said sensor (17b) in accordance with said wavelength width when the wavelength width of the light that is directed onto said mask (M) is changed over by controlling said wavelength width changeover means (6, 7).

With the present invention, every time the wavelength width of the light that is directed onto the mask is changed over, the characteristics of the sensor that detects the intensity of the light that is directed onto the mask are adjusted, so even if for example the sensor has wavelength dependence, the intensity can be accurately detected for each wavelength width of the light that is directed onto the mask.

Suitably, also, in an exposure apparatus according to the first to the fifth aspects above, said illumination optical system (IL) comprises a plurality of illumination optical paths for forming a plurality of illumination regions on said mask (M) and said sensor (17b) comprises a plurality of sensors for detecting the intensity of the light for each of said plurality of illumination optical paths.

Suitably, an exposure apparatus according the first aspect to the fifth aspect above further comprises a projection optical system (PL) that projects the pattern (DP) on said mask (M) onto said photosensitive substrate (P); a mask stage (MS) on which said mask (M) is placed; and a substrate stage (PS) on which said photosensitive substrate (P) is placed; in which at least one of said mask stage (MS) and said substrate stage (PS) is constructed so as to be capable of movement in the direction along the optical axis of said projection optical system (PL).

Furthermore, preferably, said storage means (23) stores beforehand projection optical characteristics information indicating the optical characteristics of said projection optical system (PL) that are appropriate for transfer of said pattern (DP) onto said photosensitive substrate (P) for each wavelength width to which changeover is effected by said wavelength width changeover means (6, 7) and said control means (20) adjusts at least one of the optical characteristics of said projection optical system (PL), the position of said mask (M) along said optical axis direction and the position of said photosensitive substrate (P) along said optical axis direction in accordance with said projection optical characteristics information stored in said storage means (23) when the wavelength width of the light that is directed onto said mask (M) is changed over by controlling said wavelength width changeover means (6, 7).

Yet further, suitably there is provided projection optical characteristics detection means (24) that detects the optical characteristics of said projection optical system (PL) and said control means (20) adjusts at least one of the optical characteristics of said projection optical system (PL), the position of said mask (M) along said optical axis direction and the position of said photosensitive substrate (P) along said optical axis direction while referring to the detection results of said projection optical characteristics detection means (24), when the wavelength width of the light that is directed onto said mask (M) is changed over by controlling said wavelength width changeover means (6, 7).

Also, preferably said storage means (23) stores beforehand variation information indicating the relationship between the period of illumination in respect of said projection optical system (PL) and the amount of variation of the optical characteristics of said projection optical system (PL) for each wavelength width that is changed over by said wavelength width changeover means (6, 7) and said control means (20) adjusts at least one of the optical characteristics of said projection optical system (PL), the position of said mask (M) along said optical axis direction and the position of said photosensitive substrate (P) along said optical axis direction in accordance with the illumination history in respect of said mask (M) and said variation information.

In order to achieve said first object, an exposure apparatus according to a sixth aspect of the present invention comprises: a light source (1) an illumination optical system (IL) that illuminates the mask (M) with light from this light source (1); and a projection optical system (PL) that projects the pattern (DP) formed on said mask (M) using light from this illumination optical system (IL) onto said photosensitive substrate (P); and further comprises a mask stage (MS) on which said mask (M) is placed; and a substrate stage (PS) on which said photosensitive substrate (P) is placed; wavelength width changeover means (6, 7) that changes over the wavelength width of the light that is directed onto said mask (M); storage means (23) that stores projection optical characteristics information indicating the optical characteristics of the projection optical system (PL) that are appropriate for transfer of said pattern (DP) onto said photosensitive substrate (P) for each wavelength width to which changeover is effected by said wavelength width changeover means (6, 7); and control means (20) that controls said wavelength width changeover means (6, 7); in which at least one of said mask stage (MS) and said substrate stage (PS) is constructed so as to be capable of movement in the direction along the optical axis of said projection optical system (PL); and said control means (20) adjusts at least one of the optical characteristics of said projection optical system (PL), the position of said mask (M) along said optical axis direction and the position of said photosensitive substrate (P) along said optical axis direction in accordance with the projection optical characteristics information stored in said storage means (23) when the wavelength width of the light that is directed onto said mask (M) is changed over by controlling said wavelength width changeover means (6, 7).

With the present invention, since the projection conditions of the pattern that is transferred to the photosensitive substrate can be optimized for each wavelength of the light that is directed onto the mask by adjusting at least one of the optical characteristics of the projection optical system, the position of the projection optical system along the optical axis direction, the position of the mask along the optical axis direction and the position of the photosensitive substrate along the optical axis direction in accordance with projection optical characteristics information when the wavelength width of the light that is directed onto the mask is changed over, by finding beforehand projection optical characteristics information indicating the optical characteristics of the projection optical system that are appropriate to the transfer of the pattern on the mask to the photosensitive substrate for each wavelength width of the light that is directed onto the mask, the mask pattern can be faithfully transferred to the photosensitive substrate.

In order to achieve said first object, an exposure apparatus according to a seventh aspect of the present invention comprises: a light source (1) an illumination optical system (IL) that illuminates the mask (M) with light from this light source (1); and a projection optical system (PL) that projects the pattern (DP) formed on said mask (M) using light from this illumination optical system (IL) onto said photosensitive substrate (P); and further comprises a mask stage (MS) on which said mask (M) is placed; and a substrate stage (PS) on which said photosensitive substrate (P) is placed; wavelength width changeover means (6, 7) that changes over the wavelength width of the light that is directed onto said mask (M); projection optical characteristics detection means (24) that detects the optical characteristics of said projection optical system (PL); and control means (20) that controls said wavelength width changeover means (6, 7); in which at least one of said mask stage (MS) and said substrate stage (PS) is constructed so as to be capable of movement in the direction along the optical axis of said projection optical system (PL); and said control means (20) adjusts at least one of the optical characteristics of said projection optical system (PL), the position of said mask (M) along said optical axis direction and the position of said photosensitive substrate (P) along said optical axis direction in accordance with the detection results of said projection optical characteristics detection means (24) when the wavelength width of the light that is directed onto said mask (M) is changed over by controlling said wavelength width changeover means (6, 7).

With the present invention, since the optical characteristics of the projection optical system are detected when the wavelength width of the light that is directed onto the mask is changed over and at least one of the optical characteristics of the projection optical system, the position of the projection optical system along the optical axis direction, the position of the mask along the optical axis direction and the position of the photosensitive substrate along the optical axis direction is adjusted in accordance with the results of this detection, the mask pattern can be faithfully transferred to the photosensitive substrate by optimally adjusting the optical characteristics of the projection optical system in accordance with the optical characteristics that are actually detected.

In order to achieve said first object, an exposure apparatus according to an eighth aspect of the present invention comprises: a light source (1); an illumination optical system (IL) that illuminates the mask (M) with light from this light source (1); and a projection optical system (PL) that projects the pattern (DP) formed on said mask (M) using light from this illumination optical system (IL) onto said photosensitive substrate (P); and further comprises a mask stage (MS) on which said mask (M) is placed; and a substrate stage (PS) on which said photosensitive substrate (P) is placed; wavelength width changeover means (6, 7) that changes over the wavelength width of the light that is directed onto said mask (M); storage means (23) that stores variation information indicating the relationship between the period of illumination in respect of said projection optical system (PL) and the amount of variation of the optical characteristics of said projection optical system (PL) for each wavelength width that is changed over by said wavelength width changeover means (6, 7) and control means (20) that controls said wavelength width changeover means (6, 7); in which at least one of said mask stage (MS) and said substrate stage (PS) is constructed so as to be capable of movement in the direction along the optical axis of said projection optical system (PL); and said control means (20) adjusts at least one of the optical characteristics of said projection optical system (PL), the position of said mask (M) along said optical axis direction and the position of said photosensitive substrate (P) along said optical axis direction in accordance with the variation information that is stored in said storage means (23) when the wavelength width of the light that is directed onto said mask (M) is changed over by controlling said wavelength width changeover means (6, 7).

With the present invention, since variation information indicating the relationship between the period of illumination in respect of the projection optical system and the amount of variation of the optical characteristics of the projection optical system for each wavelength width that is changed over is obtained beforehand and at least one of the optical characteristics of the projection system, the position of the projection optical system along the optical axis direction, the position of the mask along the optical axis direction and the position of the photosensitive substrate along the optical axis direction is adjusted in accordance with the variation information when the wavelength width of the light that is directed onto the mask is changed over and the projection conditions of the pattern that is transferred to the photosensitive substrate can thereby be optimized for each wavelength width of the light that is directed onto the mask, the mask pattern can be faithfully transferred to the photosensitive substrate.

In an exposure apparatus according to the first aspect to the eighth aspect above, the optical characteristics of the projection optical system (PL) may include at least one of the position of the focal point of said projection optical system (PL), the magnification, the image position, the image rotation, field curvature aberration, astigmatism aberration and distortion aberration.

In the above, position includes both position of the projection optical system in the optical axis direction and position in a plane orthogonal to the optical axis (object plane, image plane). It should be noted that the optical axis of the projection optical system includes a bent optical axis if the optical axis in the projection optical system is folded by means of a deflecting member provided in the projection optical system.

Also, image rotation of the projection optical system includes both rotation about the optical axis of the projection optical system and rotation about axis orthogonal to the optical axis.

In the exposure apparatus according to the first to eighth aspects above, the projection optical system (PL) comprises a plurality of projection optical systems that respectively project an image of said mask (M) onto said photosensitive substrate (P) and said control means (20) adjusts the optical characteristics of said projection optical system for each of said plurality of projection optical systems.

Also, an exposure apparatus according to said first aspect to eighth aspect above preferably comprises position measurement devices (27a, 27b) that measure the position of a reference member (28) formed on said substrate stage (PS) and a mark formed on said photosensitive substrate (P) using light of wavelength width that is changed over by said wavelength width changeover means (6, 7) and that finds the position of the photosensitive substrate (P) placed on said substrate stage (PS) from the respective measurement results, in which said position measurement devices (27a, 27b) find the reference position of said substrate stage (PS) by measuring the position of said reference member (28) every time the wavelength width of the light that is directed onto said mask (M) is changed over by said control means (20) controlling said wavelength width changeover means (6, 7).

Furthermore, suitably, the exposure apparatus comprises: a first measurement device (24) that measures the position where the pattern (DP) that is formed on said mask (M) is projected; a second measurement device (70a to 70d) provided laterally with respect to said projection optical system (PL) and that measures the mark that is formed on said photosensitive substrate (P) that is placed on said substrate stage (PS); and position calculating means (20) that finds the position of said photosensitive substrate (P) with respect to the position where said pattern (DP) is projected from the measurement result of the said first measurement device (24) and the measurement result of the said second measurement device (70a to 70d); in which the first measurement device (24) finds the position where said pattern (DP) is projected every time the wavelength width of the light that is directed onto said mask (M) is changed over by said control means (20) controlling said wavelength width changeover means (6, 7).

In order to achieve said first object, an exposure apparatus according to a ninth aspect of the present invention comprises: alight source (1); an illumination optical system (IL) that illuminates the mask (M) with light from this light source (1); and a projection optical system (PL) that projects the pattern (DP) formed on said mask (M) using light from this illumination optical system (IL) onto said photosensitive substrate (P); and further comprises a mask stage (MS) on which said mask (M) is placed; and a substrate stage (PS) on which said photosensitive substrate (P) is placed; wavelength width changeover means (6, 7) that changes over the wavelength width of the light that is directed onto said mask (m); control means (20) that controls said wavelength width changeover means (6, 7); and position measurement devices (27a, 27b) that measure the position of a reference member (28) formed on said substrate stage (PS) and a mark formed on said photosensitive substrate (P) using light of wavelength width that is changed over by said wavelength width changeover means (6, 7) and that finds the position of the photosensitive substrate (P) placed on said substrate stage (PS) from the respective measurement results, in which said position measurement devices (27a, 27b) find the reference position of said substrate stage (PS) by measuring the position of said reference member (28) every time the wavelength width of the light that is directed onto said mask (M) is changed over by said control means (20) controlling said wavelength width changeover means (6, 7).

With the present invention, since, when the wavelength width of the light that is directed onto the mask is changed over, the position measurement device that measures the position of the photosensitive substrate placed on the substrate stage using this light finds a reference position of the substrate stage by measuring the position of a reference member provided on the substrate stage that specifies a reference position of the substrate stage, the position of the photosensitive substrate on the substrate stage can be accurately measured even when the wavelength width of the light that is directed onto the mask is changed over.

In order to achieve said first object, an exposure apparatus according to a tenth aspect of the present invention comprises: alight source (1); an illumination optical system (IL) that illuminates the mask (M) with light from this light source (1); and a projection optical system (PL) that projects the pattern (DP) formed on said mask (M) using light from this illumination optical system (IL) onto said photosensitive substrate (P); and further comprises a mask stage (MS) on which said mask (M) is placed; and a substrate stage (PS) on which said photosensitive substrate (P) is placed; wavelength width changeover means (6, 7) that changes over the wavelength width of the light that is directed onto said mask (M); control means (20) that controls said wavelength width changeover means (6, 7); and a first measurement device (24) that measures the position where the pattern (DP) that is formed on said mask (M) is projected; a second measurement device (70a to 70d) provided laterally with respect to said projection optical system (PL) and that measures the mark that is formed on said photosensitive substrate (P) that is placed on said substrate stage (PS); and position calculating means (20) that finds the position of said photosensitive substrate (P) with respect to the position where said pattern (DP) is projected from the measurement result of the said first measurement device (24) and the measurement result of the said second measurement device (70a to 70d); in which the first measurement device (24) finds the position where said pattern (DP) is projected every time the wavelength width of the light that is directed onto said mask (M) is changed over by said control means (20) controlling said wavelength width changeover means (6, 7).

With the present invention, since the position where the pattern that is formed on the mask is projected is measured by a first measurement device when the wavelength width of the light that is directed onto the mask is changed over even when the wavelength width of the light that is directed onto the mask is changed, an accurate value of the position of the photosensitive substrate with respect to the projection position of the pattern can be found from the measurement results of the first measurement device and the measurement results of a mark on the photosensitive substrate obtained by a second measurement device provided laterally with respect to the projection optical system.

The wavelength width changeover means that are provided in the exposure apparatus according to the first aspect to the tenth aspect of the present invention above include not merely means whereby the wavelength width that is directed onto the mask is changed in discrete fashion but also means whereby the wavelength width is continuously variable; however, it is preferable that the wavelength width is made variable in discrete fashion because of various factors such as restrictions in regard to the light source employed.

In the exposure apparatus according to the first aspect to the tenth aspect above, suitably, the light source emits light having a spectrum in which peaks are present at different wavelengths and the wavelength width changeover means changes over the wavelength width of the light that is directed onto the mask, thereby changing the peaks of the spectrum contained in the light that is directed onto the mask.

Preferably the wavelength width changeover means may further change the number of peaks of the spectrum contained in the light that is directed onto the mask by changing over the wavelength width of the light and further preferably the wavelength width changeover means includes a wavelength selection filter that selectively transmits some of the wavelengths of the light from the light source.

In order to achieve the first object, an exposure method according to a first aspect of the present invention includes: an illumination step of illuminating said mask (M) using an exposure apparatus according to any of the above; and an exposure step of transferring a pattern (DP) formed on said mask (M) onto said photosensitive substrate (P).

In order to solve the above problem, an exposure method according to a second aspect of the present invention wherein the pattern (DP) formed on a mask (M) is transferred to a photosensitive substrate (P) by directing light from alight source (1) onto the mask (M) comprises a changeover step (S11) of changing over the wavelength width of the light that is directed onto said mask (M) in accordance with the photosensitivity characteristics of the photosensitive substrate (P).

Preferably, in an exposure method according to the second aspect above, in said changeover step (S11), the wavelength width of the light that is directed onto said mask (M) is changed over furthermore in accordance with the resolution of the pattern (DP) that is to be transferred onto said photosensitive substrate (P).

Suitably, also, there are further provided correction steps (S13, S15) of correcting changes in the optical characteristics produced by changeover of said wavelength width with execution of said changeover step (S11).

Also, in order to achieve said second object, an exposure apparatus according to an eleventh aspect of the present invention whereby a pattern formed on a mask is transferred to a substrate to which a photosensitive material has been applied, comprises: an illumination device comprising a light source and illuminance detection means that detects the illuminance of the light from this light source and that exercises control such that the light from said light source has a constant illuminance, in accordance with recipe data including the detection value from this illuminance detection means and information relating to the spectral characteristics of said photosensitive material; and a projection optical system that projects said pattern on the mask illuminated with light from said illumination device on to said substrate.

With an exposure apparatus according to the eleventh aspect of the present invention, the illuminance of the light from the light source is detected by illuminance detection means arranged in the illumination device, so the illuminance of the light from the light source can be controlled so as to be a constant illuminance in accordance with the spectral characteristics of the photosensitive material, by using this detected value and recipe data including information regarding the spectral characteristics of the photosensitive material. Exposure of the photosensitive material can therefore be performed using illuminating light of optimum, constant illuminance in accordance with the spectral characteristics of the photosensitive material that is applied to the substrate.

Also, suitably, in the exposure apparatus according to the eleventh aspect, said illumination device further comprises wavelength region alteration means that alters the wavelength region of light from said light source and control is exercised such that light of wavelength altered by said wavelength region alteration means has a constant illuminance in accordance with said recipe data including information relating to the spectral characteristics of said photosensitive material and the detection value from said illuminance detection means.

With this construction, the wavelength of the light from the light source is altered by the wavelength region alteration means by detecting the illuminance of the light from the light source by the illuminance detection means. Control can therefore be exercised such that the illuminance of the light, of the light from the light source, of wavelength that has been altered by the wavelength region alteration means is a constant illuminance, in accordance with the detection value obtained by the illuminance detection means and the recipe data including information relating to the spectral characteristics of the photosensitive material. Exposure of the photosensitive material can therefore be performed using illuminating light of optimum, constant illuminance in accordance with the spectral characteristics of the photosensitive material applied to the substrate.

Suitably, also, in exposure apparatus according to the eleventh aspect, said illumination device comprises a plurality of light sources, a plurality of illuminance detection means that detect the illuminance of the light sources and a plurality of wavelength region alteration means that alter the wavelength regions of the light from said light sources and in which control is exercised such that light whose wavelength region has been altered by said wavelength region alteration means has a constant illuminance in accordance with the detection value from said illuminance detection means.

With this construction, the illuminance of the light from the light sources is detected by the plurality of illuminance detection means that are provided in the illumination device and the wavelength of light from the light sources is altered by the respective wavelength region alteration means. Control can therefore be exercised such that the illuminance of the light, of the light from the light sources, of wavelengths that have been altered by the wavelength region alteration means is a constant illuminance, in accordance with the detection values obtained by the respective illuminance detection means and the recipe data including information relating to the spectral characteristics of the photosensitive material. Exposure of the photosensitive material can therefore be performed using illuminating light of optimum, constant illuminance in accordance with the spectral characteristics of the photosensitive material applied to the substrate.

Suitably, in the construction described above, the illuminance detecting means respectively detects the illuminance of light of a plurality of wavelength regions having mutually different wavelength distributions.

With this construction, the illuminance of light of a plurality of wavelength regions having mutually different wavelength distributions is respectively detected by the illuminance detection means and control is exercised such that the illuminance of the light, of the light from the light sources, whose wavelength has been altered by the wavelength region alteration means, is a constant illuminance, in accordance with these detected values and the recipe data including information relating to the spectral characteristics of the photosensitive material. Exposure of the photosensitive material can therefore be performed using illuminating light of optimum, constant illuminance in accordance with the spectral characteristics of the photosensitive material applied to the substrate.

Suitably, also, in the construction described above, said illumination device comprises a reflecting mirror that reflects illuminating light from said light source towards said mask and said illuminance detection means detects the illuminance of the light from said light source by using the leakage light from said reflecting mirror.

With this construction, the illuminance of the illuminating light that is emitted from the light source is detected using the leakage light from the reflecting mirror and control is exercised in accordance with this detected illuminance such that the illuminance of the illuminating light from the light source is constant. The illuminance of the illuminating light from the light source can therefore be detected without loss of illuminating light.

Also, with an exposure apparatus according to the eleventh aspect, suitably, there is further provided an illuminance sensor that detects the illuminance on said substrate. Also, with an exposure device according to the eleventh aspect, suitably, said illuminance sensor that detects the illuminance on said substrate is placed on said substrate stage.

With a construction as described above, control can be exercised with reference to the illuminance on the substrate detected by the illuminance sensor placed on for example the substrate stage such that the illuminance of the illuminating light on the substrate is an optimum, constant illuminance in accordance with the spectral characteristics of the photosensitive material.

Suitably, also, in the construction described above, said illuminance sensor that detects the illuminance on said substrate is a sensor that detects the illuminance at a position that is optically conjugate with said substrate.

With this construction, the illuminance on the substrate can be detected even during exposure, by means of the sensor that detects the illuminance at a position that is conjugate with the substrate stage. Consequently, control can be exercised such that the illuminance of the illuminating light on the substrate is an optimum, constant illuminance in accordance with the spectral characteristics of the photosensitive substrate even during exposure, with reference to this detected illuminance on the substrate.

Suitably, also, with an exposure apparatus according to the eleventh aspect, said illuminance sensors respectively detect the illuminance of light of a plurality of wavelength regions having mutually different wavelength distributions.

With this construction, the illuminance of the light on the substrate of a plurality of wavelength regions having mutually different wavelength distributions is respectively detected by the illuminance sensors. Consequently, control can be exercised such that the illuminance of the illuminating light of a specified wavelength region on the substrate is an optimum, constant illuminance in accordance with the spectral characteristics of the photosensitive substrate, with reference to this detection value.

Also, in the construction described above, suitably, there is further provided light-adjustment means that adjusts the illuminance of the light from said light source and said light source or said light-adjustment means is controlled in accordance with the illuminance of the light of a plurality of wavelength regions having mutually different wavelength distributions detected by said illuminance sensors.

With this construction, control can be exercised such that the illuminance on the substrate of light of a specified wavelength region is an optimum, constant illuminance in accordance with the spectral characteristics of the photosensitive material that is applied to the substrate, by controlling the light source or the light-adjustment means in accordance with the illuminance of the light of a plurality of wavelength regions having mutually different wavelength distributions, detected by illuminance sensors.

Also, an exposure method according to a third aspect of the present invention includes: an illumination step of illuminating a mask using the exposure apparatus in an exposure method using exposure apparatus according to any of the above; and a projection step of projecting a pattern image of said mask using said projection optical system.

With this exposure method, exposure of the photosensitive material can be performed using illuminating light of optimum, constant illuminance in accordance with the spectral characteristics of the photosensitive material applied to the substrate, since, in the illumination step, the mask is illuminated with an illuminance in accordance with the sensitivity of the photosensitive material applied to the substrate.

Also, in order to achieve the above object, a method of manufacturing a microdevice according to the present invention includes: an exposure step (S44) of exposing a pattern (DP) formed on said mask (M) onto said photosensitive substrate (P) using an exposure apparatus according to any of the above or an exposure method according to any of the above; and a development step (S46) of developing said exposed photosensitive substrate (P).

Hereinbelow, an exposure apparatus and method as well as a method of manufacturing a microdevice according to an embodiment of the present invention are described in detail with reference to the drawings.

[First Embodiment]

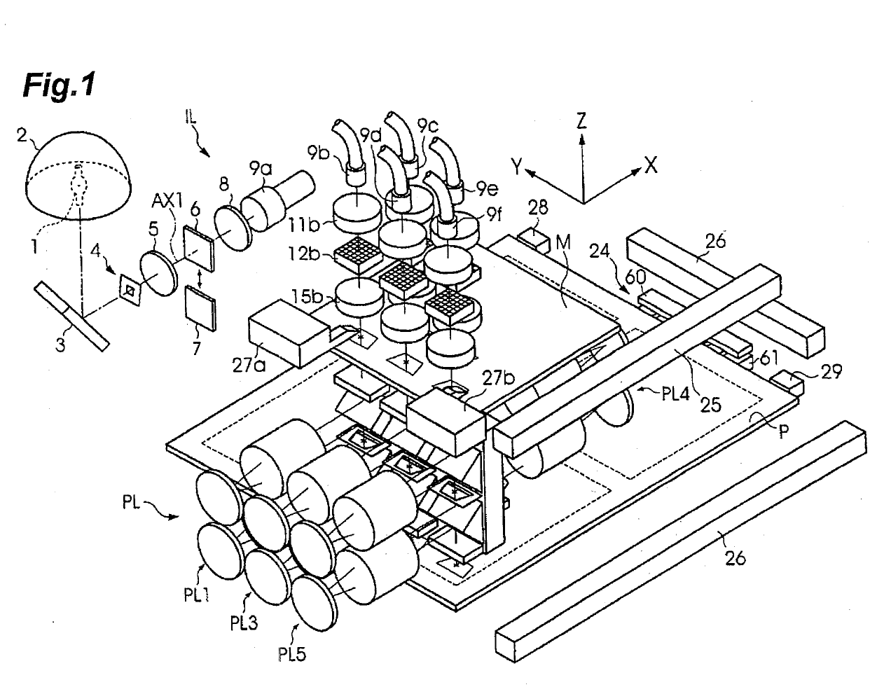

FIG. 1 is a perspective view showing diagrammatically the construction of the entire exposure apparatus according to a first embodiment of the present invention. In this first embodiment, there will be described by way of example the case where the invention is applied to an exposure apparatus of the step and scan type in which the image of a pattern DP of a liquid-crystal display element formed on a mask M is transferred to a plate P whilst relatively moving the mask M and the plate P constituting the photosensitive substrate with respect to a projection optical system PL comprising a plurality of projection optical units PL1 to PL5 of the reflecting and refracting type. In this embodiment, a photoresist (sensitivity: 20 mJ/cm²) or a resin resist (sensitivity: 60 mJ/cm²) is applied to the plate P.

In the description below, an XYZ orthogonal co-ordinate system indicated in each Fig. is defined and the positional relationships of the various members are described with reference to this XYZ orthogonal co-ordinate system. In the XYZ orthogonal co-ordinate system, the X axis and Y axis are defined parallel with respect to the plate P and the Z axis is defined in a direction orthogonal to the plate P. In the XYZ co-ordinate system in the Figs., the XY plane is actually defined in a plane parallel to the horizontal plane and the Z axis is defined in the vertical direction. Also, in the embodiment, the direction in which the mask M and plate P are moved (scanning direction) is defined in the X axis direction.

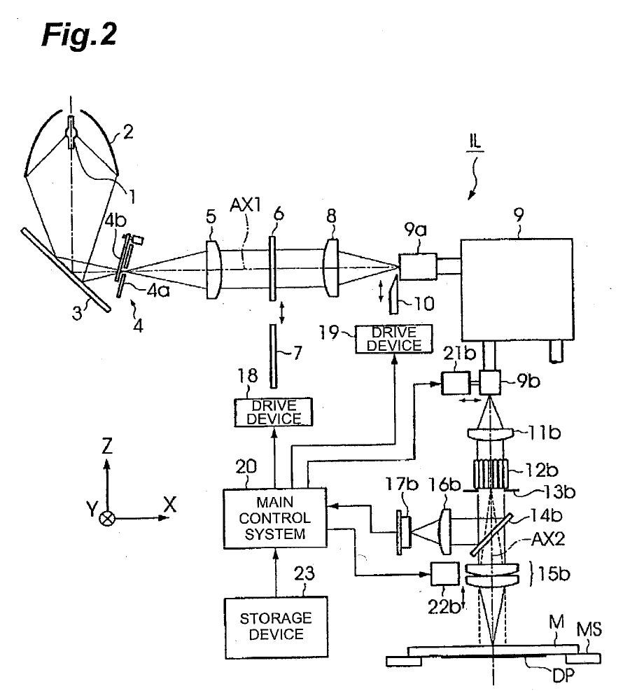

The exposure apparatus of this embodiment comprises an exposure optical system IL for uniformly illuminating a mask M supported parallel with the XY plane by means of a mask holder (not shown) in a mask stage (not shown in FIG. 1). FIG. 2 is a side face view of an illumination optical system IL; members which are the same as the members shown in FIG. 1 are given the same reference symbols. Referring to FIG. 1 and FIG. 2, the illumination optical system IL comprises a light source 1 consisting for example of a super-high pressure mercury lamp. Since the light source 1 is arranged at the first focal point position of an elliptical mirror 2, the illuminating light beam (radiation beam) emitted from the light source 1 forms a light source image at the position of the second focal point of the elliptical mirror 2, through a dichroic mirror 3.

In this embodiment, since the light that is emitted from the light source 1 is reflected by the reflective film formed on the inside face of the elliptical mirror 2 and by the dichroic mirror 3, the light source image produced by light of a wavelength region including g-line (436 nm) light, h-line (405 nm) light and i-line (365 nm) light is formed at the second focal point position of the elliptical mirror 2. That is, components outside the wavelength region including the g-line, h-line and i-line, which are unnecessary for exposure, are removed during the reflection by the elliptical mirror 2 and a dichroic mirror 3.

A shutter 4 is arranged at the second focal point position of the elliptical mirror 2. The shutter 4 comprises an aperture plate 4a (see FIG. 2) arranged slantwise with respect to the optical axis AX1 and a light-shielding plate 4b (see FIG. 2) that shields or uncovers the aperture formed in the aperture plate 4a. The reason for arranging a shutter 4 at the second focal point position of the elliptical mirror 2 is that the aperture that is formed in the aperture plate 4a can be shielded with only a small amount of movement of the light-shielding plate 4b, since the illuminating light beam that is emitted from the light source 1 is focused at this position and in order to obtain an illuminating light beam of pulse form by abruptly varying the amount of light of the illuminating light beam that passes through the aperture.

The dispersed light beam from the light source image formed at the position of the second focal point of the elliptical mirror 2 is converted into a substantially parallel light beam by a collimator lens 5 before being input to a wavelength selection filter 6. The wavelength selection filter 6 transmits only light beam of the desired wavelength region and is constructed so that it can be insertable/removable with respect to the optical path (optical axis AX1). Also, a wavelength selection filter 7 arranged to be insertable/removable with respect to the optical path like the wavelength selection filter 6 is provided together with the wavelength selection filter 6, one or other of these wavelength selection filters 6 and 7 being arranged in the optical path. One or other of the wavelength selection filters 6 and 7 is arranged in the optical path by controlling a drive device 18 by means of a main control system 20 in FIG. 2.

In this embodiment, it will be assumed that the wavelength selection filter 6 transmits light of a wavelength region including only the i-line and the wavelength selection filter 7 transmits light of a wavelength region including light of the g-line, light of the h-line and light of the i-line (365 nm). In this way, in this embodiment, the wavelength width of the light that is directed onto the mask is changed over by arranging one or other of the wavelength selection filters 6 and 7 in the optical path. The wavelength selection filters 6 and 7 correspond to the wavelength width changeover means referred to in the present invention.

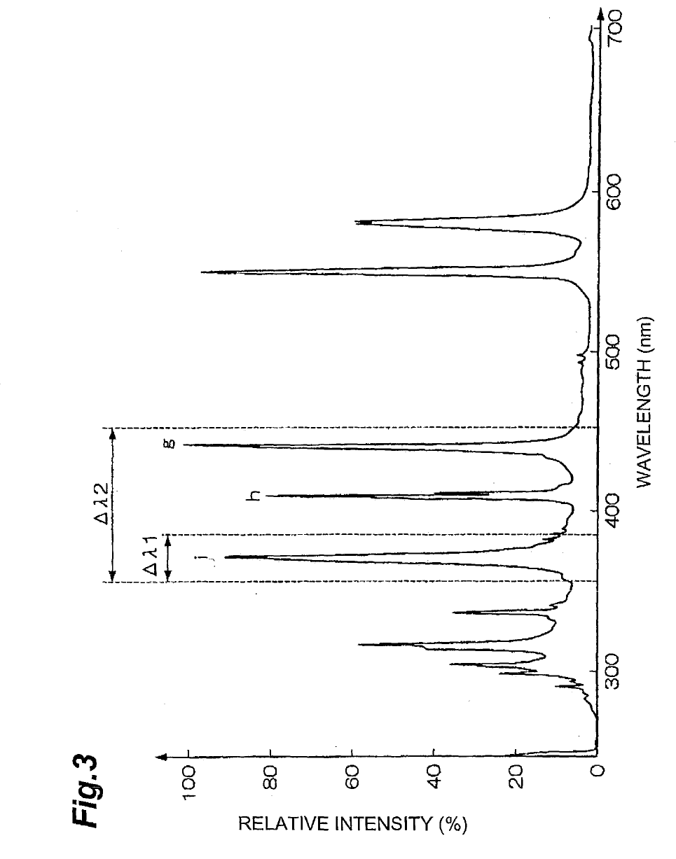

The spectrum of the light transmitted through the wavelength selection filters 6 and 7 will now be described. FIG. 3 is a view given in explanation of the spectrum of the light transmitted through the wavelength selection filters 6 and 7. As shown in FIG. 3, the light source 1 emits light of a spectrum including a plurality of peaks (emission lines) over a wide wavelength region of the order of wavelengths 300 to 600 μm. Of the light that is emitted from the light source 1, the wavelength components that are not required for performing exposure are removed during reflection by the elliptical mirror 2 and a dichroic mirror 3 as described above. When this light from which the components that are not required for exposure have been removed is directed onto the wavelength selection filter 6 arranged in the optical path, light of wavelength width Δλ1 including the i-line shown in FIG. 3 is transmitted. In contrast, when the wavelength selection filter 7 is arranged in the optical path, light of wavelength width Δλ2 including the g-line, h-line and i-line is transmitted.

Also, the power of the light transmitted through the wavelength selection filter 6 is obtained by integrating the spectrum within the wavelength width Δλ1 while the power of the light transmitted through the wavelength selection filter 7 is obtained by integrating the spectrum within the wavelength width Δλ2. Since, as shown in FIG. 3, the respective spectra of the g-line, h-line and i-line show practically the same distribution, the ratio of the power of the light transmitted through the wavelength selection filter 6 and the power of the light transmitted through the wavelength selection filter 7 is roughly of the order 1:3.

Thus, as mentioned above, in this embodiment, the case is assumed where photoresist of sensitivity 20 mJ/cm² or resin resist of sensitivity 60 mJ/cm² is applied onto the plate P, the ratio of these sensitivities being 1:3. Consequently, if the wavelength selection filter 6 whose transmission beam power is low is arranged on the optical path if photoresist, which is of high sensitivity, is applied to the plate P, whereas the wavelength selection filter 7 of high transmission beam power is arranged on the optical path if resin resist, which is of low sensitivity, is applied to the plate P, exposure can be performed with the speed with which the plate stage PS on which the plate P is placed kept constant (maximum speed: for example 300 mm/sec). Thus, in this embodiment, the power of the beam that is directed onto the plate P is altered by changing over the wavelength width of the transmitted beam by exchanging the wavelength selection filters that are arranged on the optical path in accordance with the sensitivity (sensitivity characteristic) of the resist that is applied to the plate P.

Returning to FIG. 1, after the light has passed through the wavelength selection filter 6 or the wavelength selection filter 7 it is again made to form an image by passing through a relay lens 8. The input terminal (end) 9a of a light guide 9 is arranged in the vicinity of this imaging position. The light guide 9 is a random light guide fiber constituted by randomly bundling for example a large number of fiber element lines and comprises input terminals 9a of a number which is the same as the number of light sources 1 (one in FIG. 1) and output terminals (ends) 9b to 9f (only the output terminal 9b is shown in FIG. 2) of a number which is the same as the number of projection optical units constituting the projection optical system PL (five in FIG. 1). Thus, the light that is input to the input terminal 9a of the light guide 9, after being propagated through the interior thereof, is emitted divided between the five emission terminals 9b to 9f.

As shown in FIG. 2, a plate 10 which is constructed such that its position can be continuously varied is arranged at the input terminal 9a of the light guide 9. This light guide 10 serves for continuously varying the intensities of the beams output respectively from the five emission terminals 9b to 9f of the light guide 9 by shielding part of the input terminal 9a of the light guide 9. Control of the amount of light for the input terminal 9a of the light guide 9 of the plate 10 is performed by controlling a drive device 19 by means of a main control system 20 in FIG. 2.

As described above, in this embodiment, the case is envisaged in which a photoresist of sensitivity 20 mJ/cm² or resin resist of sensitivity 60 mJ/cm² is applied onto the plate P; however, by adjusting the intensity of the beams that are respectively emitted from the emission terminals 9b to 9f of the light guide 9 by the plate 10, even if a resist of different sensitivity to the resists described above (for example a resist of sensitivity 50 mJ/cm²) is applied, the power of the light that is directed onto the resist can be set to a suitable power in accordance with the sensitivity of this resist. In this way, exposure can be effected without lowering the speed of movement of the plate stage PS from the maximum speed.

Between the emission terminal 9b of the light guide 9 and the mask M, there are arranged in sequence a collimating lens 11b, fly's eye integrator 12b, aperture stop 13b (not shown in FIG. 1), beam splitter 14b (not shown in FIG. 1) and condenser lens system 15b. Likewise, between the emission terminals 9c to 9f of the light guide 9 and the mask M, there are arranged respectively in sequence collimating lenses 11c to 11f, fly's eye integrators 12c to 12f, aperture diaphragms 13c to 13f, beam splitters 14c to 14f and condenser lens systems 15c to 15f. To simplify the description, the construction of the optical members provided between the emission terminals 9b to 9f of the light guide 9 and the mask M will be described taking the collimator lens 11b the fly's eye integrator 12b, the aperture stop 13b, the beam splitter 14b, and the condenser lens system 15b provided between the emission terminal 9b of the light guide 9 and the mask M as representative.

After the dispersed light beam emitted from the emission terminal 9b of the light guide 9 has been converted to light beam that is substantially parallel by means of the collimating lens 11b, it is input to the fly's eye integrator 12b. The fly's eye integrator 12b is constructed by arranging a large number of positive lens device in a closely packed fashion vertically and horizontally so that their central axial rays extend along the optical axis AX2. Consequently, the wave surface of the light beam that is input to the fly's eye integrator 12b is divided by the large number of lens elements to form a secondary light source consisting of the same number of light source images as the number of lens element in the subsequent focal plane (i.e. the vicinity of the emission face). That is, a substantially planar light source is formed at the focal plane on the downstream side of the fly's eye integrator 12b.

The light beam from the large number of two-dimensional light sources formed in the focal plane on the downstream side of the fly's eye integrator 12b is restricted by the aperture stop 13b arranged in the vicinity of the focal plane on the downstream side of the fly's eye integrator 12b before being input to the condenser lens system 15b through the beam splitter 14b. The aperture stop 13b is arranged in a position that is substantially optically conjugate with the pupil plane of the corresponding projection optical unit PL1 and has a variable aperture section for defining the range of the two-dimensional light source that contributes to the illumination. By changing the aperture diameter of this variable aperture section, the σ value (ratio of the aperture of the two-dimensional light source image on its pupil plane with respect to the aperture diameter on the pupil plane of the projection optical units PL1 to PL5 constituting the projection optical system PL) of the aperture stop 13b that determines the illumination conditions can be set to a desired value.

The light beam that has passed through the condenser lens system 15b illuminates in superimposed fashion the mask M where the pattern DP is formed. Likewise, the dispersed light beam that is emitted from the other emission terminals 9c to 9f of the light guide 9 illuminates in superimposed fashion, respectively, the mask M, through collimating lenses 11c to 11f, fly's eye integrators 12c to 12f, aperture diaphragms 13c to 13f, beam splitters 14c to 14f and condenser lens systems 15c to 15f, in sequence. That is, the illuminating optical system IL illuminates a plurality (a total of five in the case of FIG. 1) of trapezoid regions which are lined up in the Y axis direction on the mask M.

On the other hand, the light that has passed through the beam splitter 14b provided in the illumination optical system IL is detected by an integrator sensor 17b comprising a photoelectric conversion element constituting an energy sensor, through a condenser lens 16b. The photoelectric conversion signal of this integrator sensor 17b is supplied to the main control system 20 through a peak hold circuit and A/D converter, not shown. The correlation factor of the output of the integrator sensor 17b and the energy (exposure amount) per unit area of the light that is directed onto the surface of the plate P (image plane) is found beforehand and stored in the main control system 20.

The main control system 20 controls the opening/closure action of the shutter 4 synchronized with the operating information of this stage system from a stage controller, not shown, that controls the plate stage on which is placed the plate P and the mask stage MS on which is placed the mask M and controls the timing with which the illuminating light from the illumination optical system IL is directed onto the mask M and the intensity of the illuminating light, by outputting control signals to the drive device 19, in response to the photoelectric conversion signal that is output from the integrator sensor 17b. It should be noted that the sensitivity of the integrator sensor 17b is altered by the main control system 20 in accordance with whether the wavelength selection filter 6 is arranged in the optical path or whether the wavelength selection filter 7 is arranged therein. This is in order to provide wavelength dependence of the sensitivity of the sensor 17b.

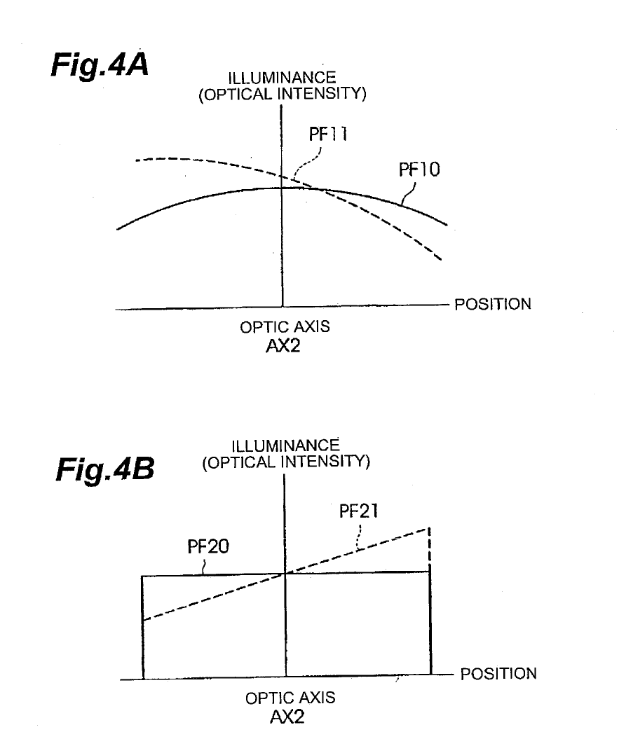

Also, at the emission terminal 9b of the light guide 9, a drive device 21b is provided for altering the angle of the emission terminal 9b with respect to the optical axis AX2. This drive device 21b is provided for adjustment of the telecentricity of the illumination optical system IL. The relationship of the telecentricity of the illumination optical system IL and the illumination distribution will now be described. FIGS. 4A and 4B show the relationship between the telecentricity of the illumination optical system IL and the illuminance distribution, FIG. 4A being a view showing the illuminance distribution at the input face of a fly's eye integrator and FIG. 4B being a view showing the illuminance distribution of the light directed onto the plate P.

If the various members contained in the illumination optical system IL were fabricated without error and the illumination optical system IL were assembled without error, the illumination distribution of the light incident on the fly-eye integrator 12b would be a convex type illumination distribution rotationally symmetrical about the optical axis as shown by the curve indicated by the reference symbol PF10 in FIG. 4A. If light having such an illumination distribution is obtained, as shown by the reference symbol PF20 in FIG. 4B, the illumination distribution of the illuminating light that illuminates the illumination region on the mask M or the illumination distribution of the projection light that is projected onto the projection region of the plate P is a uniform illumination distribution with no unevenness.

However, since slight fabrication errors of the various members contained in the illumination optical system IL and slight errors of assembly of the illumination device are present, as shown by the curve indicated by the reference symbol PF11 in FIG. 4A, the illumination distribution of the light that is incident on the fly's eye integrator 12b is an inclined illumination distribution which is not rotationally symmetric with respect to the optical axis. As a result, the illumination distribution of the illuminating light that illuminates the illumination region on the mask M or the illumination distribution of the projection light that illuminates the projection region on the plate P are also inclined distributions. Also, in this embodiment, the wavelength width of the light that passes through the illumination optical system IL changes depending on which of the wavelength selection filters 6, 7 is arranged on the optical path. As a result, even if for example when the wavelength selection filter 6 is arranged on the optical path the illumination distribution PF20 in FIG. 4B is obtained, as a result of arranging the wavelength selection filter 7 on the optical path in place of the wavelength selection filter 6, the wavelength distribution of the projection light projected into the projection region of the plate P becomes an inclined distribution.

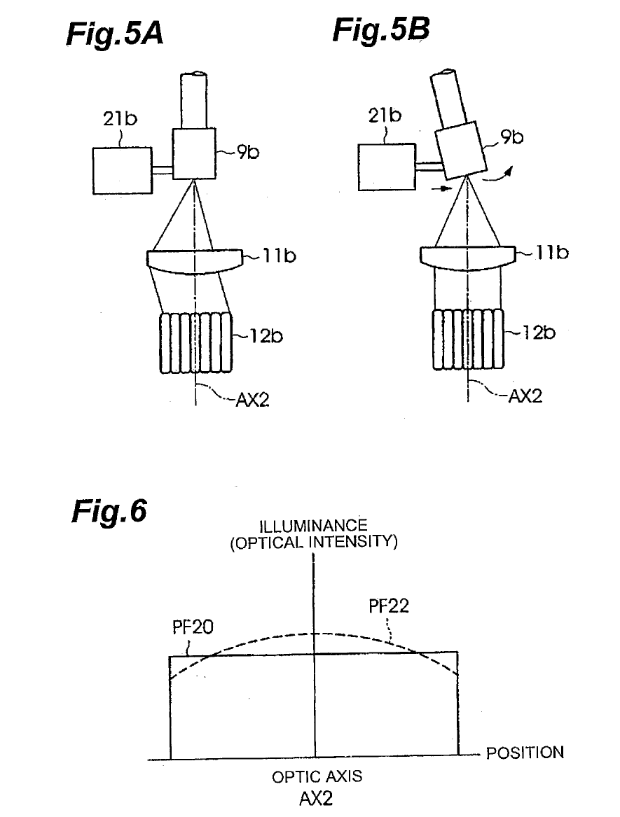

This inclined distribution (illuminance unevenness) is produced by degradation of the telecentricity of the illumination optical system IL, so, in order to improve the telecentricity, a drive device 21b for altering the angle of the emission terminal 9b with respect to the optical axis AX2 is provided. FIGS. 5A and 5B are views showing how the telecentricity of the illumination optical system is adjusted by altering the angle of the emission terminal 9b of the light guide 9. If now the wavelength selection filter 7 is arranged on the optical axis instead of the wavelength selection filter 6 being arranged there, as shown in FIG. 5A, the light is now incident with a certain angle of incidence with respect to the fly's eye integrator 12 (the angle of incidence becomes no longer substantially 0). In order to make this angle of incidence substantially 0, the angle of the emission terminal 9b is adjusted by the control system 20 outputting a control signal to the drive device 21b. As shown in FIG. 5B, a uniform illumination distribution PF20 with no illuminance unevenness in FIG. 4B can be formed by generating an opposite inclined unevenness component as indicated by the reference symbol PF21 in FIG. 4B, by inclining the emission terminal 9b with respect to the optical axis AX2, by pushing the end of the emission terminal 9b in a direction orthogonal to the optical axis AX2, by means of the drive device 21b.

Also, illuminance unevenness that is rotationally symmetric with respect to the optical axis may be produced in the illumination region on the mask M or the projection region on the plate P as shown by the curved indicated by the reference symbol PF22 in FIG. 6, if there is slight fabrication error in the various members included in the illumination optical system IL described above or slight assembly error of the illumination device, or if the wavelength selection filters 6 and 7 are exchanged. FIG. 6 is a view showing an example of illuminance unevenness produced on the plate P. In order to compensate for this illuminance unevenness, a drive device 22b is provided that moves at least one optical element (lens etc.) constituting the condenser lens system 15b in the direction of the optical axis AX2. By generating an illuminance unevenness component of rotational symmetry opposite to the illumination component PF22 of FIG. 6 by using the drive device 22b to move the optical element included in the condenser lens system 15b along the direction of the optical axis AX2, the main control system 20 can form a uniform illumination distribution PF20 with no illuminance unevenness, as shown in FIG. 6.

For details of a method of adjusting the illumination optical characteristics (telecentricity and illuminance unevenness) of an illumination optical system IL by positional adjustment etc. of an optical member provided in the illumination optical system IL, for example Laid-open Japanese Patent Publication Number 2001-305743, Laid-open Japanese Patent Publication Number 2001-313250 (and the corresponding U.S. patent application Ser. No. 09/790,616, applied for in the US on Feb. 23, 2001) and U.S. Pat. No. 5,867,319 maybe consulted. Also, adjustment of illuminance unevenness may also be performed by applying a correction by arranging a field stop such as to make the vicinity of the mask surface (plate surface) or a plane optically conjugate with the mask surface (plate surface) or the width of the aperture in the scanning direction in the vicinity thereof different in a direction orthogonal to the scanning direction (non-scanning direction). For details of such a method of correction, for example European Patent Application Laid-open Number 633506 maybe consulted. It should be noted that, in these correction methods, instead of making the width of the aperture of the field stop different, it would be possible to adopt a construction in which a density distribution filter is provided with a transmission characteristic having a distribution capable of correcting illuminance unevenness in the non-scanning direction.

A storage device 23 such as a hard disk may be connected with the main control system 20 and the exposure data file stored in this storage device 23. The processes and process sequences required for performing a exposure of a plate P are stored in this exposure data file; these include, for each process, information relating to the resist that is applied to the plate P (for example, resist sensitivity), the necessary resolution, the mask M to be employed, the wavelength selection filter employed, the amount of correction of the illumination optical system IL (illumination optical characteristic information), the amount of correction of the projection optical system PL (projection optical characteristic information) and information regarding the flatness of the substrate etc. (i.e. a so-called recipe). These correction amounts of the illumination optical system IL are the correction amounts required in order to achieve suitable characteristics (i.e. a condition in which telecentricity is ensured and illuminance unevenness is not produced) of the illumination optical system IL in order to transfer the pattern DP on the mask M to the plate P when the wavelength selection filters 6, 7 are respectively arranged on the optical path.

The main control system 20 adjusts the illumination conditions of the illumination optical system IL by changeover of the wavelength selection filters, positional adjustment of the plate 10, angular adjustment of the emission terminal 9b of the light guide 9 and positional adjustment of the direction of the optical axis AX2 of the condenser lens system 15b, by controlling the drive devices 18, 19, 21b and 22b in accordance with the exposure data file which is stored in this storage device 23. As will be described in detail later, in this embodiment, the main control system 20 corrects the optical characteristics of the illumination optical system IL using the detection results of the illumination optical characteristics of the illumination optical system IL such as the illuminance unevenness of the light that illuminates the plate P in combination with the correction amounts of the illumination optical system IL that are stored in the storage device 23.

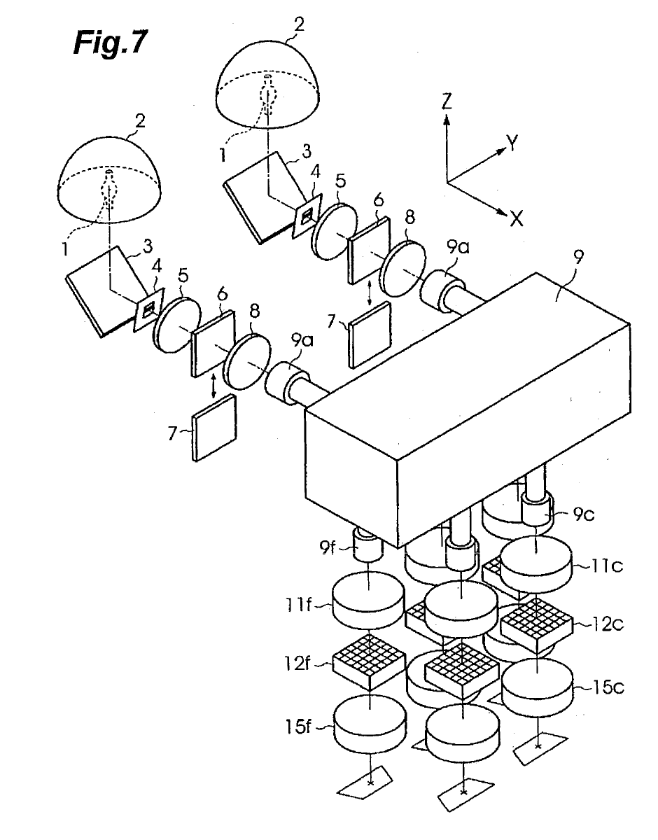

It should be noted that, although, in the illumination optical system IL described above, the light emitted from a single light source 1 is equally divided into five illuminating beams through the light guide 9, there is no restriction regarding the number of light sources 1 or the number of projection optical units and various modified examples of possible. FIG. 7 is a perspective view showing a modified example of an illumination optical system IL. As shown in FIG. 7, two or more light sources may be provided and the illuminating light from these two light sources can be equally divided into five illumination beams by means of a light guide 9 of excellent randomness. Such a construction can be employed in cases where the amount of exposure light produced by a single light source is insufficient. Also, the number of divisions produced by the light guide 9 is not restricted to five and the number of divisions could be set in accordance with the number of projection optical units.

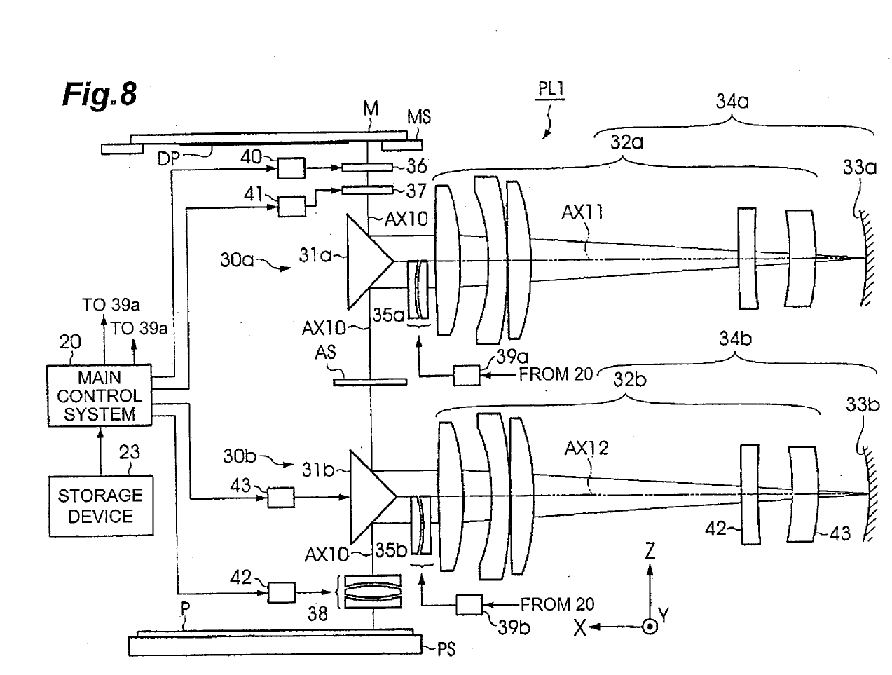

The light from the respective illumination regions on the mask M is input to the projection optical system PL comprising a plurality (a total of five in the case of FIG. 1) of projection optical units PL1 to PL5 arranged along the Y axis direction so as to correspond to each illumination region. Next, the construction of a projection optical system PL according to the present invention will be described. FIG. 8 is a side view showing the construction of a projection optical unit PL1 constituting part of the projection optical system PL. The construction of the projection optical units PL2 to PL5 is substantially the same as the construction of the projection optical unit PL1, so only the construction of the projection optical unit PL1 will be described, a description of the projection optical units PL2 to PL3 being omitted.

The projection optical unit PL1 shown in FIG. 8 comprises a first imaging optical system 30a that forms a primary image of the pattern DP using the light from the mask M and a second imaging optical system 30b that forms on the plate P an erect real image (secondary image) of the pattern DP using the light from this primary image. In the vicinity of the position affirmation of the primary image of the pattern DP, there is provided a field stop AS that defines the field of view region (illumination region) of the projection optical unit PL1 on the mask M and the projection region (exposure region) of the projection optical unit on the plate P.

The first imaging optical system 30a comprises a first right angled prism 31a having a first reflecting face arranged in inclined fashion at an angle of 45° with respect to the mask surface (XY plane) so as to reflect incoming light along the −Z axis direction from the mask M in the −X axis direction. Also, in order from the first right-angled prism 31a, the first imaging optical system 30a comprises a first refractive optical system 32a, and a first concave-surface reflecting mirror 33a facing the concave face on the side of the first right-angled prism 31a. The first refractive (dioptric) optical system 32a and first concave-surface reflecting mirror 33a are arranged along the X axis direction and, as a whole, constitute a first catadioptric optical system 34a. Light that is incident on the first right-angled prism 31a along the +X axis direction from the first catadioptric optical system 34a is reflected in the −Z axis direction by the second reflective surface provided in inclined fashion at an angle of 45° with respect to the mask surface (XY plane).

For its part, the second imaging optical system 30b comprises a second right-angled prism 31b having a first reflective surface that is arranged in inclined fashion at an angle of 45° with respect to the plate surface (XY plane) so as to reflect in the −X axis direction light incoming along the −Z axis direction from the second reflective surface of the first right-angled prism 31a. Also, in order from the side of the second right-angled prism 31b, the second imaging optical system 30b comprises a second refractive (dioptric) optical system 32b having positive refractive power and a second concave surface reflective mirror 33b whose concave surface faces the side of the second right-angled prism 31b. The second refractive optical system 32b and the second concave surface reflective mirror 33b are arranged along the X axis direction and, as a whole, constitute a second catadioptric optical system 34b. The light which is incident on the second right-angled prism 31b along the +X direction from the second catadioptric optical system 34b is reflected in the −Z axis direction by the second reflective surface arranged in inclined fashion at an angle of 45° with respect to the plate surface (XY plane surface)

In this embodiment, a mask-side magnification correction optical system 35a is additionally provided in the optical path between the first catadioptric optical system 34a and the second reflecting surface of the first right-angled prism 31a and a plate-side magnification correction optical system 35b is additionally provided in the optical path between the second catadioptric optical system 34b and the second reflecting surface of the second right-angled prism 31b. Also, an image shifter constituted by a first plane-parallel plate 36 and second plane-parallel plate 37 is additionally provided in the optical path of the mask M and the first reflecting surface of the first right-angled prism 31a. Further, a focus correction optical system 38 is additionally provided in the optical path between the second reflecting surface of the second right-angled prism 31b and the plate P.

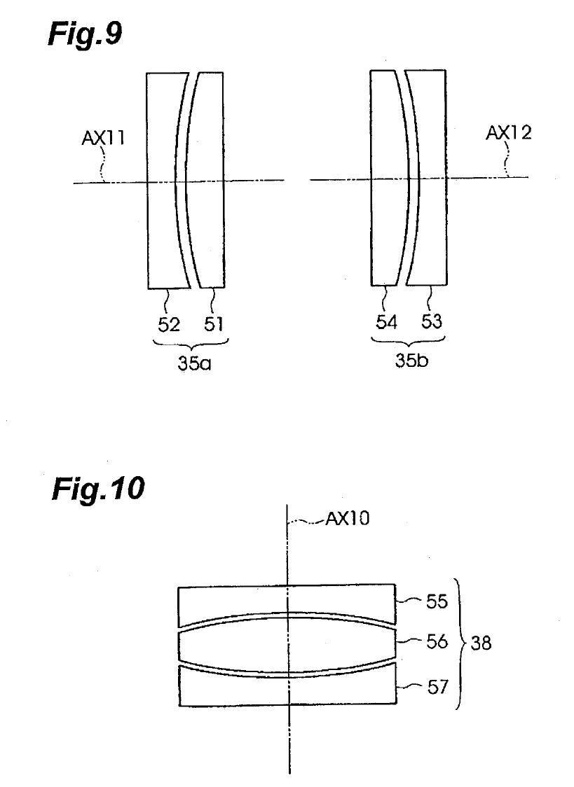

The construction and action of the mask-side magnification correction optical system 35a and the plate-side magnification correction optical system 35b are described below. FIG. 9 is a view showing diagrammatically the construction of the mask-side magnification correction optical system 35a and the plate-side magnification correction optical system 35b of FIG. 8. As shown in FIG. 8, the optical axis of the first catadioptric optical system 34a is designated as AX11 and the optical axis of the second catadioptric optical system 34b is designated as AX12. Also, the path of a light ray advancing in the direction of the −Z axis from the center of the illumination region on the mask M defined by the field stop AS, passing through the center of the field stop AS until it reaches the center of the exposure region on the plate P likewise defined by the field stop AS is designated as the optical axis AX10.

As shown in FIG. 8 and FIG. 9, the mask-side magnification correction optical system 35a is constituted of a plano-convex lens 51 with its planar surface facing the side of the first refractive optical system 32a, and a plano-concave lens 52 with its planar surface facing the side of the second reflective surface of the first right-angled prism 31a, in order from the first refractive optical system 32a on the optical path of the first refractive optical system 32a and the second reflective surface of the first right-angled prism 31a. That is, the optical axis of the mask-side magnification correction optical system 35a coincides with the optical axis AX11 and the convex surface of the plano-convex lens 51 and the concave surface of the plano-concave lens 52 have a curvature of substantially the same magnitude, and face each other with a separation therebetween.

Also, the plate-side magnification correction optical system 35b is constituted of a plano-concave lens 53 with its planar surface facing the side of the second refractive optical system 32b, and a plano-convex lens 54 with its planar surface facing the side of the second reflective surface of the second right-angled prism 31b, in order from the second refractive optical system 32b on the optical path of the second refractive optical system 32b and the second reflective surface of the second right-angled prism 31b. That is, the optical axis of the plate-side magnification correction optical system 35b coincides with the optical axis AX12 and the concave surface of the plano-concave lens 53 and the convex surface of the plano-convex lens 54 have a curvature of substantially the same magnitude, and face each other with a separation therebetween.

In more detail, the mask-side magnification correction optical system 35a and the plate-side magnification correction optical system 35b have mutually identical constructions save only that their inclination along the axes AX11 and AX12 is changed. Thus, if, of the separation between the plano-convex lens 51 and the plano-concave lens 52 constituting the mask-side magnification correction optical system 35a and the separation between the plano-concave lens 53 and plano-convex lens 54 constituting the plate-side magnification correction optical system 35b at least one or other of the separations is changed by a minute amount, the projection magnification of the projection optical unit PL1 changes by a minute amount and the position along the confocal direction of this image plane (along the optical axis AX10) i.e. the focusing position also changes by a minute amount. The mask-side magnification correction optical system 35a is arranged to be driven by a first drive section 39a and the plate-side magnification correction optical system 35b is arranged to be driven by a second drive section 39b.

Next, the image shifter constituted by the first plane-parallel plate 36 and second plane-parallel plate 37 will be described. The first plane-parallel plate 36 is arranged with its planar surface perpendicular to the optical axis AX10 in the reference condition and is constituted so as to be capable of rotation by a minute amount about the X axis. When the first plane-parallel plate 36 is rotated by a minute amount about the X axis, the image formed on the plate P is slightly shifted (image shift) in the Y direction in the XY plane. Also, the second plane-parallel plate 37 is arranged with its planar surface perpendicular to the optical axis AX10 in the reference condition and is constituted so as to be capable of rotation by a minute amount about the Y axis. When the second plane-parallel plate 37 is rotated by a minute amount about the Y axis, the image formed on the plate P is slightly shifted (image shift) in the X direction in the XY plane. The first plane-parallel plate 36 is driven by a third drive section 40 and the second plane-parallel plate 37 is arranged to be driven by a fourth drive section 41.

Next, the focus correction optical system 38 will be described. FIG. 10 is a view showing diagrammatically the construction of the focus correction optical system 38 of FIG. 8. The focus correction optical system 38 is constituted of a plano-convex lens 55 with its planar surface facing the side of the second reflective face of the second right-angled prism 31b, a biconvex lens 56 and a plano-concave lens 57 with its planar surface facing the plate P, in order from the second reflective surface of the second right-angled prism 31b along the optical axis AX10 on the optical path of the second reflective surface of the second right-angled prism 31b and the plate P. The concave surface of the plano-concave lens 55 and the convex surface of the biconvex lens 56 have a curvature of substantially the same magnitude as the concave surface of the plano-concave lens 57, and face each other with a separation therebetween.

When, of the separation between the plano-concave lens 55 and the biconvex lens 56 and the separation between the biconvex lens 56 and the plano-concave lens 57 constituting the focus correction optical system 38, at least one or other separation is changed by a minute amount, the position along the confocal direction of the image plane of the projection optical unit PL1 changes by a minute amount and its projection magnification also changes by a minute amount. This focus correction optical system 38 is arranged to be driven by a fifth drive section 42.

Next, in this embodiment, the second right-angled prism 31b is constructed so as to function as an image rotator. That is, the second right-angled prism 31b is constructed such that the line of intersection (ridgeline) of the first reflective surface and the second reflective surface in the reference condition is arranged so as to extend along the Y axis direction and to be capable of rotation by a minute amount about the optical axis AX10 (about the Z axis). When the second right-angled prism 31b is rotated by a minute amount about the optical axis AX10, the image formed on the plate P is rotated by an minute amount (image rotation) about the optical axis AX10 (about the Z axis) in the XY plane. The second right-angled prism 31b is constituted so as to be driven by a sixth drive section 43. Instead of the second right-angled prism 31b, the first right-angled prism 31a could be constituted so as to function as an image rotator or both the second right-angled prism 31b and first right-angled prism 31a could be constituted so as to function as an image rotator.

Hereinbelow, in order to simplify the description of the basic construction of the various projection optical units, first of all, the condition in which the first plane-parallel plate 36, second plane-parallel plate 37, mask-side magnification correction optical system 35a, plate-side magnification optical system 35b and focus correction optical system 38 are not attached will be described. As described above, the pattern DP formed on the mask M is illuminated with substantially uniform illuminance by the illuminating light (exposure light) from the illumination optical system IL. Light proceeding along the direction of the −Z axis from the pattern DP formed on the various illumination regions on the mask M is deflected by 90° by the first reflecting surface of the first right-angled prism 31a before being input to the first catadioptric optical system 34a along the −X axis direction. After the light has been input to the first catadioptric optical system 34a, it passes through the first refractive optical system 32a, reaching the first concave surface reflective mirror 33a. The light that is reflected by the first concave surface reflective mirror 33a again passes through the first refractive optical system 32a and is input to the second reflective surface of the first right-angled prism 31a along the direction of the +X axis. The light advancing along the −Z axis direction after being deflected by 90° at the second reflective surface of the first right-angled prism 31a forms a primary image of the pattern DP in the vicinity of the visual field stop AS. It should be noted that the lateral magnification in the X axis direction of the primary image is +1 times and the lateral magnification in the Y axis direction is −1 times.

The light proceeding along the −Z axis direction from the primary image of the pattern DP is deflected by 90° by the first reflecting face of the second right-angled prism 31b before being input to the second catadioptric optical system 34b along the −X axis direction. The light that is input to the second catadioptric optical system 34b passes through the second refractive optical system 32b before reaching the second concave surface reflective mirror 33b. The light that is reflected by the second concave surface reflective mirror 33b again passes through the second refractive optical system 32b and is input to the second reflective surface of the second right-angled prism 31b along the +X axis direction. The light that has been deflected by 90° at the second reflective surface of the second right-angled prism 31b before proceeding along the −Z axis direction forms a secondary image of the pattern DP in the corresponding exposure region on the plate P. The lateral magnification of the secondary image in the X axis direction and the lateral magnification in the Y axis direction are both +1 times. That is, the image of the pattern DP formed on the plate P through the projection optical units PL1 to PL5 is an erect real image of equal size, so that the projection optical units PL1 to PL5 constitute a real-size erect system.

It should be noted that, in the case of the first catadioptric optical system 34a described above, since the first concave surface reflecting mirror 33a is arranged in the vicinity of the rear-side focal point position of the first refractive optical system 32a, this is substantially telecentric on the side of the mask M and on the side of the field stop AS. Also, in regard to the second catadioptric optical system 34b, since the second concave surface reflecting mirror 33b is arranged in the vicinity of the rear-side focal point position of the second refractive optical system 32b, this is substantially telecentric on the side of the field stop AS and on the side of the plate P. As a result, the projection optical units PL1 to PL5 constitute telecentric optical systems substantially on both sides (the mask M side and the plate P side).

In this way, the light that has passed through the projection optical system PL constituted of the plurality of projection optical units PL1 to PL5 forms an image of the pattern DP on the plate P supported parallel with the XY plane by means of a plate holder, not shown, on a plate stage PS (not shown in FIG. 1). That is, since, as described above, the respective projection optical units PL1 to PL5 are constituted as a real-size erect system, a real-size direct image of the pattern DP is formed in the plurality of trapezoid exposure regions that are lined up in the Y axis direction so as to correspond to each exposure region on the plate P which constitutes the photosensitive substrate.

In the exposure apparatus of this embodiment, as described above, the wavelength width of the light that is directed onto the plate P is changed over by exchanging the wavelength selection filters 6, 7. Consequently, when the wavelength selection filters 6 and 7 are exchanged, the wavelength width of the light transmitted through the projection optical units PL1 to PL5 changes, so the focal point position, magnification and image position (position in the XY plane and position in the Z direction) and the amount of rotation of the image change. Also, by changing the wavelength width of the light passing through the projection optical units PL1 to PL5, the various types of aberration (for example, field curvature aberration, astigmatism aberration, distortion aberration etc.) of the projection optical units PL1 to PL5 are changed.

In order to correct for the changes of optical characteristics produced by the changes of wavelength width of the light passing through the above projection optical units PL1 to PL5, the respective projection optical units PL1 to PL5 are respectively additionally provided with the mask-side magnification correction optical system 35a and plate-side magnification correction optical system 35b, image shifter constituted by the first plane-parallel plate 36 and second plane-parallel plate 37 and the focus correction optical system 38, and the second right-angled prism 31b is arranged so as to function as an image rotator.

In order to correct the changes of optical characteristics of the projection optical units PL1 to PL5, the main control system 20 controls first drive section 39a to sixth drive section 43 in accordance with the correction amounts (projection optical characteristic information) of the projection optical system PL contained in an exposure data file stored in a storage device 23. In this case, what is meant by the correction amounts of the projection optical system PL is correction amounts for making the optical characteristics of the projection optical system PL suitable (i.e. a condition in which image shift etc. is not produced in the image of the pattern DP formed by the projection optical units PL1 to PL5, the image is arranged in accordance with its design values and aberrations of the projection optical units PL1 to PL5 are reduced to the utmost) for transfer of the pattern DP of the mask M onto the plate P when the wavelength selection filters 6 and 7 are respectively arranged on the optical path.

Also, as shown in FIG. 8, since the projection optical units PL1 to PL5 are constituted of catadioptric optical systems, when the illuminating light (exposure light) passes through the projection optical unit PL1 to PL5, some of the exposure light is absorbed, resulting in heating of the refractive optical device, causing changes in their thermal expansion or refractive index and so producing aberration (spherical aberration, astigmatic aberration, distortion aberration, curvature of field aberration etc.). In addition, changes of the focal position and changes of the magnification are produced. In this embodiment, since the wavelength width of the light that is directed onto the plate P is changed over by exchanging the wavelength selection filters 6, 7, the transmittance of the projection optical units PL1 to PL5 changes in accordance with which of the wavelength selection filters 6, 7 is arranged in the optical path and in addition the magnitude of the aberrations etc. that are produced changes in accordance therewith.

Accordingly, in this embodiment, variation information indicating the relationship between the illumination time of the exposure light and the amount of aberration etc. generated (amounts of variation of the optical characteristics) in respect of the projection optical units PL1 to PL5 is found beforehand for each wavelength width of the illuminating exposure light and stored in the storage device 23; and when a plate P is exposed, first drive section 39a to sixth drive section 43 described above are driven taking into account the variation information stored in the storage device 23 and the illumination history of the exposure light indicating the time of exposure using the wavelength selection filter 6 and the time of exposure using the wavelength selection filter 7. This variation information could be in the form of a mapping of the relationship between the exposure time of the exposure light and the amount of aberration generated, as described above, or could be in a form represented by a specific calculation formula (obtained by function fitting of the relationship between the illumination time of the exposure light and the amounts of aberration generated) or, in addition, could be in a form represented by discrete values and an interpolation formula (discrete representations of the relationship between the illumination time of the exposure light and the amount of aberration generated and a specific interpolation formula for interpolating the discretely expressed relationships (obtained by function fitting of the relationship between the illumination time of the exposure light and the amount of aberration generated)). A plurality of types of such interpolation formulas could be employed.

It should be noted that, although, as described above, it is possible to perform correction of the optical characteristics of the projection optical units PL1 to PL5 by controlling the first drive section 39a to sixth drive section 43 respectively provided in the projection optical units PL1 to PL5 by means of the main control system 20, in combination with this method of correction, it could be arranged to for example adjust the focal position by changing the relative position in the Z axis direction of the projection optical units PL1 to PL5 and mask M and plate P by making the projection optical units PL1 to PL5 moveable in the Z axis direction. As will be described in detail later, in this embodiment, the main control system 20 corrects the optical characteristics of the projection optical system PL by using, in combination with the correction amounts of the projection optical system PL stored in the storage device 23, the detection results of the projection optical characteristics of the projection optical system PL such as the focal point position of the optical image of the pattern DP that is formed on the plate P, the magnification, image position and amount of rotation of the image and also the various types of aberration etc.

In this embodiment, exposure is performed with a photoresist or resin resist applied to the plate P; when a photoresist is exposed, a resolution of 3 μm is necessary, but when a resin resist is exposed a resolution of 5 μm is necessary. Also, due to increased size of the plate P, it is necessary to ensure a depth of focus that is as deep as possible, whichever wavelength selection filter 6 or 7 is arranged on the optical path. Hereinbelow, the relationship between the resolution and the depth of focus when the wavelength width is changed over will be described.

In general, when the residual aberration of the projection optical units PL1 to PL5 is small, the resolution R and depth of focus DOF are respectively expressed by the following expression (2) and expression (3).

R=k·λ/NA (2)

DOF=λ/(NA)² (3).

In the above expressions (2) and (3), λ is the central wavelength of the light passing through the respective projection optical units PL1 to PL5 and NA is the numerical aperture of the respective projection optical units PL1 to PL5. Also, in expression (2), k is a process constant determined by the photosensitivity characteristic etc. of the resist. This process constant k is of the order of 0.7 in the case of fabricating a typical liquid-crystal display element.

Let us now consider the case where a resolution of 3 μm L/S is to be obtained using the i-line (365 nm) as the exposure light. A resolution of 3 μm L/S is the resolution in order to resolve this periodic pattern when a periodic pattern (L/S pattern) formed by a single line and a single space is projected through projection optical units PL1 to PL5 within 3 μm. From the above expression (1), in order to obtain this resolution, the respective numerical apertures NA of the projection optical units PL1 to PL5 must be 0.085. Also, from the above expression (3), the depth of focus DOF of the projection optical units PL1 to PL5 when the respective numerical apertures of the projection optical units PL1 to PL5 are 0.085 is about 50.5 μm.

In contrast, if, for the exposure light, g-line (436 nm), h-line (405 nm) and i-line (365 nm) light is employed, taking the central wavelength λ of the exposure light as 402 nm, from (1) above, the numerical aperture NA of the respective projection optical units PL1 to PL5 must be 0.094. Also, from expression (3) above, the depth of focus DOF of the projection optical units PL1 to PL5 when the numerical aperture of the respective projection optical units PL1 to PL5 is 0.094 is about 45.5 μm. From the above, if the numerical apertures of the projection optical units PL1 to PL5 are set by specifying the necessary resolution, the depth of focus when exposure light of wavelength width including only the i-line is employed is of the order of 10% deeper than if exposure light is employed of wavelength width containing all of the g-line, h-line and i-line.

Next, in the condition where the numerical apertures of the projection optical unit PL1 to PL5 are set at 0.085, the case where only the i-line is employed and the case where the g-line, h-line and i-line are employed will be considered. If only the i-line is employed as the exposure light, as described above, a resolution of 3 μm L/S is obtained and the depth of focus is then 50.5 μm. In contrast, if the g-line, h-line and i-line are employed as the exposure light, assuming that the central wavelength is 402 nm, the resolution obtained is 3.3 μm L/S and, from the above expression (3), the depth of focus is then 55.6 μm. From the above, it can be seen that, if the numerical apertures of the projection optical units PL1 to PL5 are fixed, compared with the case where exposure light of wavelength width including only the i-line is employed, if exposure light of wavelength width including all of the g-line, h-line and i-line is employed, the resolution is lowered by about 10%, but the depth of focus is increased by about 10%.

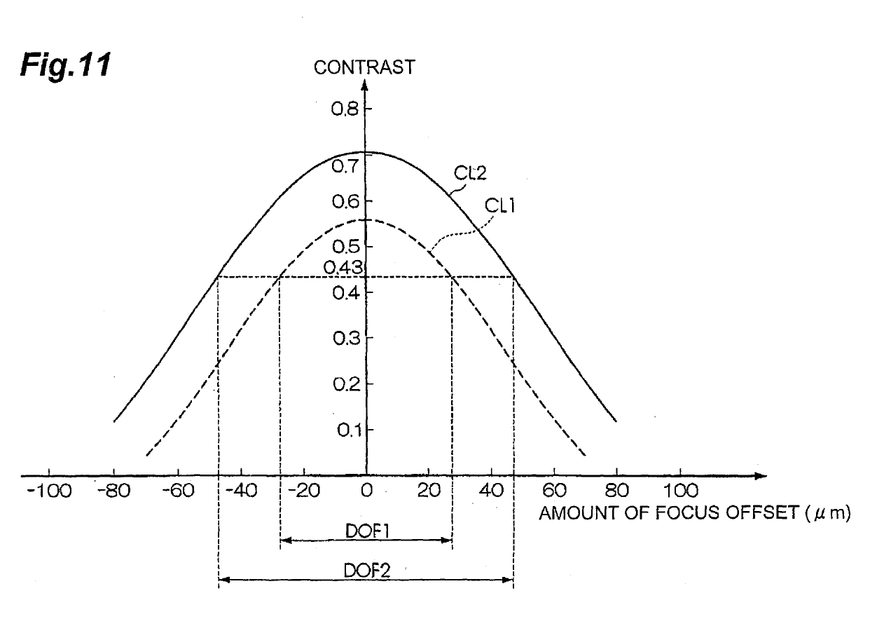

In this embodiment, the exposure power that is required when a plate P to which resin resist, which is of low sensitivity, has been applied is exposed, using exposure light of wavelength width including the g-line, h-line and i-line, is obtained; the resolution which is then necessary is 5 μm. Consequently, with the lowering of the required resolution, a greater depth of focus can be ensured. FIG. 11 is a view showing the MTF (modulation transfer function) when exposure light of wavelength width including the g-line, h-line and i-line is employed as the exposure light. In FIG. 11, the amount of offset from the best focus position of the projection optical units PL1 to PL5 is displayed along the horizontal axis. Also, in FIG. 11, taking the numerical aperture of the projection optical units PL1 to PL5 as 0.085 and taking the central wavelength of the exposure light of wavelength width including the g-line, h-line and i-line as 402 nm, the σ value is set as 1.

In FIG. 11, the curve indicated by the reference symbol CL1 is a curve indicating the MTF when a 3.3 μm L/S pattern is transferred and the curve indicated by the reference symbol CL2 is a curve indicating the MTF when a 5 μm L/S pattern is transferred. When a 3.3 μm L/S pattern is transferred, from expression (2) given above, a depth of focus of 55.6 μm is obtained; in FIG. 11, this depth of focus is represented by DOF1. As can be seen from FIG. 11, the contrast is at least 0.43 at depth of focus DOF1. Taking the region for which the contrast is at least 0.43 as the depth of focus, the depth of focus when the resolution is 5 μm L/S is DOF2 shown in FIG. 11; as can be read from FIG. 11, this depth of focus DOF2 is about 96 μm.

That is, the depth the focus is about 45 μm deeper when a 5 μm L/S pattern is transferred than in the case where a 3 μm L/S pattern is transferred. The benefit is therefore obtained that, in steps where a resolution of the order of 5 μm L/S is necessary (step of exposing a plate P to which resin resist has been applied), the fabrication cost of the mask M can be lowered, since the flatness of the mask M that is used can be downgraded by about 45 μm.

Summarizing the relationship between the exposure power, resolution and depth of focus, if light of wavelength width including only the i-line is employed as the exposure light, with the wavelength selection filter 6 arranged in the optical path, a resolution of about 3 μm and a depth of focus of about 50.5 μm are obtained; if light of wavelength width including the g-line, h-line and i-line is employed as the exposure light, with a wavelength selection filter 7 arranged in the optical path, exposure power of about three times the exposure power obtained when the wavelength selection filter 6 is arranged in the optical path is obtained and a resolution of about 5 μm and a depth of focus of about 96 μm are obtained.

Returning to FIG. 1, for the mask stage MS described above, a scanning drive system (not shown) is provided having a long stroke in order to move the mask stage MS along the X axis direction, which is the scanning direction. Also, a pair of alignment drive systems (not shown) are provided in order to move the mask stage MS by a minute amount along the Y axis direction, which is a direction orthogonal to the scanning direction and to rotate it by a minute amount about the Z axis. It is also arranged that the positional co-ordinates of the mask stage MS may be measured and may be positionally controlled by means of a laser interferometer (not shown) using a movable mirror 25. Furthermore, the position of the mask stage MS is arranged to be variable in the Z direction.

An identical drive system is provided for the plate stage PS. Specifically, there are provided a scanning drive system (not shown) having a long stroke for moving the plate stage PS along the X axis direction, which is the scanning direction, and a pair of alignment drive systems (not shown) for moving the plate stage PS by a minute amount along the Y axis direction, which is a direction orthogonal to the scanning direction, and for rotating it by a minute amount about the Z axis. It is also arranged that the positional co-ordinates of the plate stage PS may be measured and may be positionally controlled by means of a laser interferometer (not shown) using a movable mirror 26. The plate stage PS is also constituted so as to be moveable in the Z direction, like the mask stage MS. The positions in the Z direction of the mask stage MS and plate stage PS are controlled by the main control system 20.

Furthermore, as means for relative positional alignment of the mask M and plate P along the XY plane, a pair of alignment systems 27a and 27b are arranged above the mask M. As the alignment systems 27a, 27b, there maybe employed an alignment system (a so-called TTL (through the lens) type alignment system) of a type in which the position of the plate P is found from the relative position of a reference member 28 a member for defining a reference position of the plate stage PS) measured through the projection optical units PL1, PL5 and the position of a plate alignment mark formed on the plate P, or an alignment system (a so-called TTM (through the mask) type alignment system) of the type in which the relative position of a mask alignment mark formed on the mask M and a plate alignment mark formed on the plate P is found by image processing. In this embodiment a TTL type alignment system is assumed to be provided.

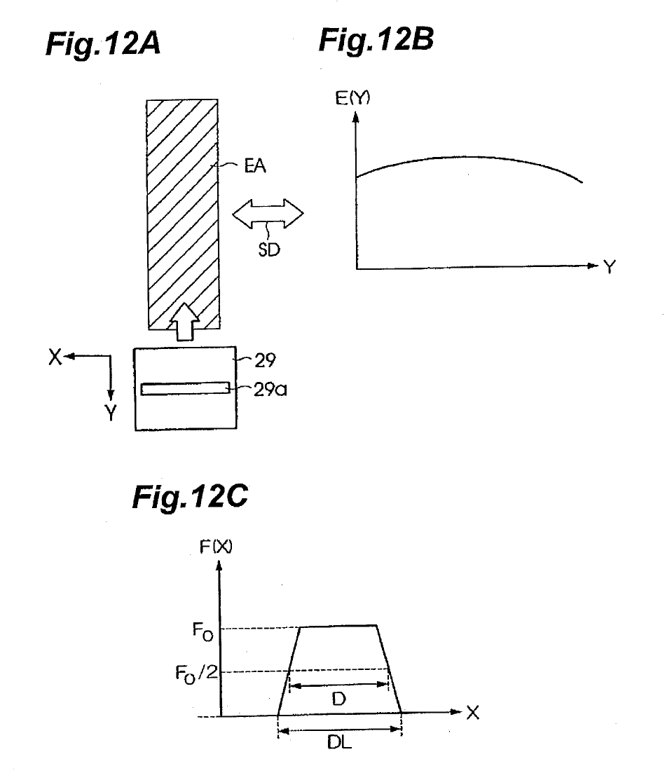

Also, in the exposure apparatus of this embodiment, an illuminance measurement section 29 is fixed on the plate stage PS, for measuring the illuminance of the light that is directed onto the plate P through the projection optical system PL. This illuminance measurement section 29 corresponds to the means for detecting an illumination optical property as referred to in the present invention. FIGS. 12A, 12B and 12C are views showing diagrammatically the construction of an illuminance measurement section 29 and given in explanation of a method of measuring illuminance unevenness. In the illuminance measurement section 29, as shown in FIG. 12A, a CCD-type line sensor 29a having a slit-shaped photodetector section that is elongate in the scanning direction SD (X direction) is fixed to the upper surface thereof. The detection signal of this line sensor 29a is supplied to the main control system 20. Also, on the upper surface of the illuminance measurement section 29, there is arranged an ordinary illuminance unevenness sensor (not shown) comprising a photoelectric sensor having a pinhole-shaped photodetector section.

A method of measuring illuminance unevenness in the non-scanning direction (Y direction) of a slit-shaped exposure region EA using the line sensor 29a will now be described with reference to FIGS. 12A, 12B and 12C. This illuminance unevenness measurement is performed for example periodically or every time the wavelength selection filters 6 and 7 in the illumination optical system IL are exchanged. First of all, FIG. 12A shows a condition in which the line sensor 29a on the illuminance measurement section 29 is moved in the horizontal plane in the non-scanning direction of the exposure region EA of the projection optical system PL by driving the plate stage PS; the illuminance distribution F(X) in the scanning direction SD (X direction) of this exposure region EA is substantially trapezoid. If, as shown in FIG. 12C, the width in the scanning direction of the bottom edge of the illuminance distribution F(X) is taken as DL, the width in the scanning direction of the photodetector section of the line sensor 29a should be set sufficiently wider than DL.

After this, as shown in FIG. 12A, the illuminance distribution E(Y) in the non-scanning direction (Y direction) of the exposure region EA as shown in FIG. 12B is calculated by successively inputting the detection signals that are output from the line sensor 29a as the line sensor 29a is moved successively to a series of measurement points with a prescribed separation in the non-scanning direction (Y direction) by driving the plate stage PS in a mode in which the exposure region EA is completely covered in the scanning direction. This illuminance distribution E(Y) may be expressed as a function of the position Y in the non-scanning direction by the following expression (4).

E(Y)=a·(Y−b)²+c·Y+d (4)

In the above expression (4), the second order coefficient a represents convex (a>0) illuminance unevenness or concave (a<0) illuminance unevenness with respect to the position Y; the shift coefficient b represents the amount of shift in the Y direction from the X axis AX of the axis of symmetry of the illuminance unevenness; the first order coefficient c represents so-called inclined unevenness; and the coefficient d represents a constant illuminance (offset) that does not depend on position Y, respectively. The values of these coefficients a to d are found by for example the method of least squares from the measurement data. In this way, the illuminance unevenness component that is rotationally symmetric with respect to the optical axis is obtained by the second order coefficient a and the inclined unevenness component is obtained by the first order coefficient c.

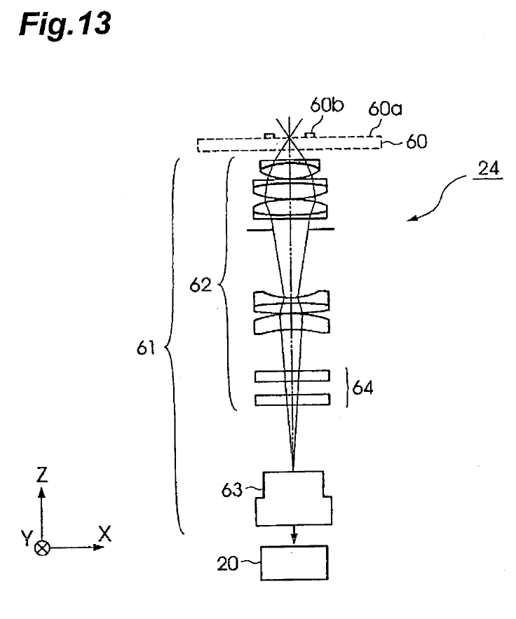

Furthermore, in this embodiment, as shown in FIG. 1, an aerial image measurement device 24 constituting means for detecting a projection optical property is provided that is mounted on the plate stage PS. The aerial image measurement device 24 comprises an index plate (reference plate) 60 that is arranged at a position (position along the Z axis direction) of substantially the same height as the image plane of the projection optical system PL and a plurality (six in the case of this embodiment, as will be described) of detection units 61 arranged with a separation along a direction orthogonal to the scanning direction i.e. the Y axis direction. FIG. 13 is a perspective view showing diagrammatically the construction of the aerial image measurement device 24. The detection units 61, as shown in FIG. 13, comprise a relay optical system 62 for forming a magnified secondary image of the optical image formed on the index plane 60a of the index plate 60 through the projection optical units 61 and a two-dimensional image pickup element 63 such as a CCD for detecting the secondary image formed through this relay optical system 62.

Consequently, a magnified image of the index 60b formed on the index plane 60a is also formed on the detection plane of the two-dimensional image pickup element 63 through the relay optical system 62. In the relay optical system 62 there is inserted a filter 64 for sensitivity correction for matching the spectral sensitivity of the two-dimensional image pickup element 63 with the spectral sensitivity of the resist that is applied to the plate P. The output from the two-dimensional image pickup element 63 of the plurality of detection units 61 is supplied to the main control system 20 (see FIG. 2).

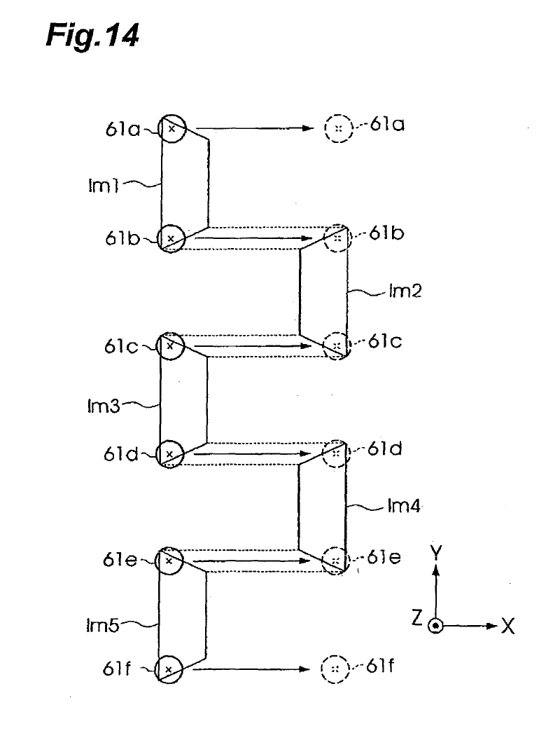

Next, a method of detecting the optical properties (position of the focal point of the optical image of the pattern DP that is projected onto the plate P, the magnification, the image position, and amount of rotation of the image and various types of aberration etc.) of the projection optical units PL1 to PL5 using the aerial image measurement device 24 will be described. FIG. 14 is a view given in explanation of a method of detecting the optical properties of the projection optical units PL1 to PL5 using the aerial image measurement device 24. In detection of the optical properties of the projection optical units PL1 to PL5, a reference pattern formed on the mask stage MS is moved in the illumination region and the detection units 61 of the aerial image measurement device 24 are arranged in prescribed positions of the projection region of the projection optical system PL. It should be noted that the aerial image measurement device 24 has six detection units 61, which are respectively distinguished by attaching symbols 61a to 61f thereto in FIG. 14.

The positional relationship of the respective detection units 61a to 61f and the projection optical units PL1 to PL5 will now be described. As shown in FIG. 14, the separation between the respective detection units 61a to 61f is set such that, as indicated by the continuous lines in the Fig., in a condition in which the six detection units 61a to 61f and the three images Im1, Im3, Im5 (these are images projected from the respective projection optical systems PL1, PL3 and PL5) that are linearly arranged in the Y axis direction are aligned along the X axis direction, the detection unit 61a and detection unit 61b respectively cover a pair of triangular regions of image Im1 formed through the projection optical unit PL1, the detection unit 61c and the detection unit 61d respectively cover a pair of triangular regions of image Im3 formed through the projection optical unit PL3 and the detection unit 61c and detection unit 61f respectively cover a pair of triangular regions of image Im5 formed through the projection optical unit PL5.

Consequently, if, from a condition in which the six detection units 61a to 61f and the three images Im1, Im3, Im5 are lined up, the plate stage PS is moved by a prescribed distance along the X axis direction, as shown by the broken line in the Fig., the six detection units 61a to 61f and the two images Im2 and Im4 can be lined up. In this condition, the detection unit 61b and detection unit 61c respectively cover the pair of triangular regions of the image Im2 formed through the projection optical unit PL2 while the detection unit 61d and the detection unit 61e respectively cover the pair of triangular regions of the image Im4 formed through the projection optical unit PL4. In this condition, the detection unit 61a and the detection unit 61f do not perform detection action.

When measuring the optical properties of the projection optical units PL1 to PL5, first of all the images of the reference patterns that are produced through the projection optical systems PL1, PL3 and PL5 are respectively measured by the detection units 61a to 61f by matching the positions in the X direction of the detection units 61a to 61f with the positions in the X direction where the images Im1, Im3 and Im5 are projected, by moving the plate stage PS in the X direction. Next, the images of the reference patterns produced through the projection optical systems PL2, PL4 are respectively measured by the detection units 61b to 61e by matching the positions of the detection units 61a to 61f in the X direction with the positions of the images Im2, Im4 in the X direction by moving the plate stage PS in the X direction. The main control system 20 finds the arrangement, size, position and amount of rotation and various types of aberration images Im1 to Im5 of the reference patterns respectively projected from the projection optical units PL1 to PL5 by performing various types of processing such as image processing on the measurement results of the aerial image measurement device 24. The optical properties of the projection optical units PL1 to PL5 can be detected by means of the above.

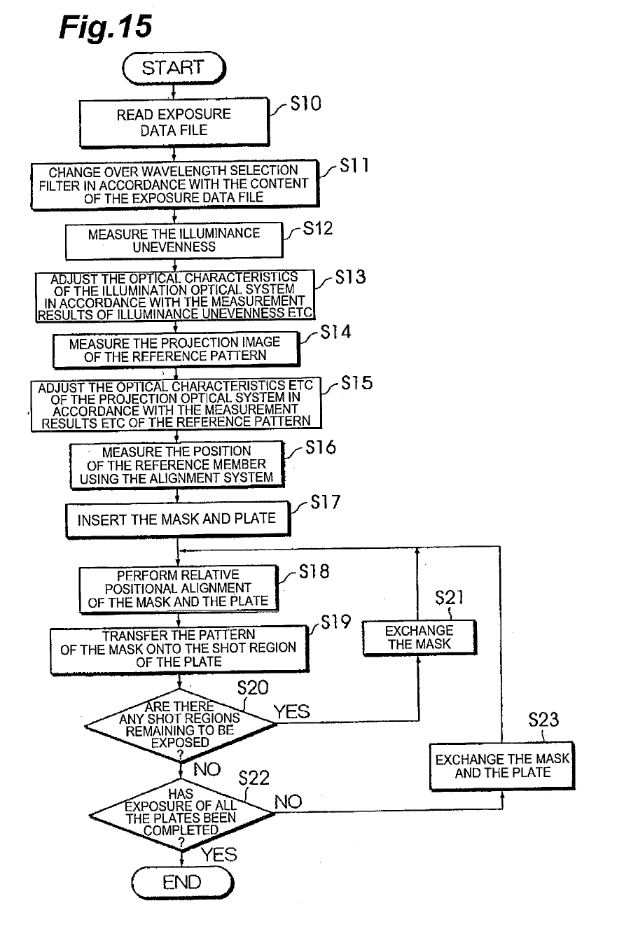

The construction of an exposure apparatus according to a first embodiment of the present invention has been described above; next, its operation during exposure will be described. FIG. 15 is a flow chart showing an example of the operation of an exposure apparatus according to a first embodiment of the present invention. The flow chart shown in FIG. 15 illustrates the operation of the exposure apparatus when an exposure step (for example the exposure step that is performed when forming TFTs or the exposure step that is performed when forming color filters) that is carried out on a plurality of plates is performed. When this step is commenced, first of all, the main control system 20 reads the exposure data file that is stored in the storage device 23 (step S10). By this step, the main control system 20 obtains information relating to the resist that is applied onto the plate P that is to be exposed in the step illustrated in FIG. 15 (for example the resist sensitivity), the required resolution, the mask M to be used, the wavelength selection filter to be used, the correction amounts of the illumination optical system IL, the correction amounts of the projection optical system PL and information relating to the flatness of the substrate.

Next, the main control system 20 performs changeover of the wavelength selection filter (step S11: changeover step) in accordance with the content of the exposure data file that is read in step S10. For example, if the resist sensitivity in the exposure data file is 20 mJ/cm² and the required resolution is 3 μm, the wavelength selection filter 6 is arranged in the optical path; if the resist sensitivity is 60 mJ/cm² and the required resolution is 5 μm, the wavelength selection filter 6 is arranged in the optical path. It should be noted that, although in this case the wavelength selection filter to be arranged in the optical path was changed over in accordance with the resist sensitivity and the required resolution, it would be possible to effect changeover of the wavelength selection filter in accordance with the resist sensitivity only or to effect changeover in accordance with the required resolution only.

When the above step is completed, the plate stage PS is put in a condition in which it is illuminated with light from the light source 1 through the illumination optical system IL and projection optical units PL1 to PL5, respectively, by directing light on to it from the light source 1 and the light illuminating the plate stage PS is measured (step S12) by the method illustrated in FIGS. 12A, 12B and 12C, using the illuminance measurement section 29. This step is performed in order to measure the amount of change of the illumination optical properties, since the illumination optical properties (for example the telecentricity or illuminance unevenness) of the illumination optical system IL change depending on which of the wavelength selection filters 6, 7 is arranged in the optical path.

Next, the main control system 20 adjusts the illumination optical properties of the illumination optical system IL (step S13: correction step) in accordance with the correction amounts of the illumination optical system IL read in step S10 and the measurement results of step S12. It should be noted that the correction amounts of the illumination optical system IL that are used at this point correspond to the wavelength selection filter that is arranged in the optical path. A specific method of adjustment is to correct the inclined component of the asymmetric illuminance unevenness with respect to the optical axis AX2 by changing the angle of inclination of the emission terminal 9b of the light guide 9 with respect to the optical axis AX2 by controlling the drive device 21b illustrated in FIG. 2. Similar corrections are effected in respect of the emission terminals 9c to 9f of the light guide 9. Also, the asymmetric illuminance unevenness component with respect to the optical axis AX2 is corrected by moving an optical element including a condenser lens system 15b along the direction of the optical axis AX2 by controlling a drive device 22b. Although not shown in the drawing, similar corrections are performed in regard to the condenser lens systems corresponding to the emission terminals 9c to 9f of the light guide 9.

The correction amounts of the illumination optical system IL contained in the exposure data file are correction amounts at the time of fabrication of the exposure apparatus; the main control system 20 basically performs a correction in accordance with the correction amounts of this illumination optical system IL. However, in this embodiment, since correction is effected taking into account the amounts of change of the optical properties of the illumination optical system IL that occur with secular change, the correction of the illumination optical properties of the illumination optical system IL is performed whilst referring to the correction amounts of the illumination optical system IL included in the exposure data file and also the measurement results of the illuminance measurement section 29.

It should be noted that the correction of the illumination optical properties of the illumination optical system IL could be performed solely in accordance with the illumination optical system IL contained in the exposure data file or correction of the illumination optical properties of the illumination optical system IL could be performed solely in accordance with the measurement results of the illuminance measurement section 29. Preferably also the sensitivity of the integrator sensor 17b is altered in accordance with the wavelength selection filter that is arranged in the optical path in conjunction with the adjustment of the illumination optical properties of the illumination optical system IL referred to above. It should be noted that it is desirable also to alter the sensitivity of the illuminance measurement section 29 when altering the sensitivity of the integrator sensor 17b. The reason for this is that, although, in the above step S13, the distribution of the illuminance of the projection light directed onto the plate stage PS was measured through the projection optical units PL1 to PL5 and the absolute value of the illuminance was unnecessary, when finding the exposure amounts, the absolute value of the illuminance is required.

Next, the reference pattern formed on the mask stage MS is moved into the illumination region and the detection units 61 provided in the aerial image measurement device 24 and the projection regions (regions where the images Im1, Im3, Im5 are projected) of the projection optical units PL1, PL2 and PL5 are aligned in the X axis direction. Then, exposure light is directed onto the reference pattern and the images of the reference pattern are respectively measured by the detection units 61. In the same way, the detection units 61 and the projection regions (regions where the images Im2 and Im4 are projected) of the projection optical units PL2 and PL4 are aligned in the X axis direction and the images of the reference pattern are measured. The main control system 20 performs various types of processing such as image processing on the measurement results of the aerial image measurement device 24 to find the arrangement, size, position and amount of rotation and various types of aberration of the images Im1 to Im5 of the reference patterns that are respectively projected from the projection optical units PL1 to PL5. In this way, the optical properties of the projection optical units PL1 to PL5 can be detected.

When the optical properties of the projection optical units PL1 to PL5 have been obtained, the main control system 20 adjusts (step S15: correction step) the projection optical properties etc. of the projection optical units PL1 to PL5, respectively, in accordance with the correction amounts of the projection optical system PL read in step S10 and the measurement results of step S14. The correction amounts of the projection optical system PL that are employed at this point correspond to the wavelength selection filter that is arranged in the optical path. A specific method of adjustment is to adjust (correct) the variations of magnification in the projection optical units PL1 to PL5 by driving a mask-side magnification correction optical system 35a or plate-side magnification correction optical system 35b by means of a first drive section 39a or a second drive section 39b. If required, variation of the image position in the projection optical units PL1 to PL5 is corrected by driving an image shifter constituted by a first plane-parallel plate 36 and second plane-parallel plate 37 by means of a third drive section 40 and fourth drive section 50.

The main control system 20 also adjusts the focal point position on the image plane side (side of the plate P) in the projection optical units PL1 to PL5 by adjusting a focus correction optical system 38 by means of a fifth drive section 42, if required. In addition, if required, it corrects the image rotation in the projection optical units PL1 to PL5 by driving a second right-angled prism 31b constituting an image rotator, by means of a sixth drive section 41. Furthermore, also, if required, the main control system 20 corrects the rotationally symmetric aberration and non-rotationally symmetric aberration by moving a lens that is effective for correction of the various aberrations along the optical axis direction or direction orthogonal to the optical axis, or inclining this with respect to the optical axis. Also, if required, the main control system 20 corrects variation of image position and image rotation of the image of the field stop by moving the field stop AS along the XY plane or by rotating it about the Z axis.

Also, as described above, in the projection optical units PL1 to PL5, there is a possibility of variation of the focus position or magnification or aberration etc. due to heat deformation of lenses and/or heat deformation of deflecting members produced by optical illumination during exposure. In order to correct these variation amounts, it is desirable to drive the first drive section 39a to sixth drive section 43 described above taking into account the previous history of illumination by the exposure light indicating the time of exposure using the wavelength selection filter 6 and the time of exposure using the wavelength selection filter 7 and the variation information stored in the storage device 23.

In addition, apart from adjusting the optical properties of the projection optical units PL1 to PL5, it is arranged to dispose the mask M and the plate P in the best focus position of the projection optical units PL1 to PL5 by adjusting the position in the Z direction of the respective projection optical units PL1 to PL5, the position in the Z direction of the mask stage MS or the position in the Z direction of the plate stage PS.

When the adjustment of the illumination optical properties of the illumination optical system IL and the adjustment of the projection optical properties of the projection optical system PL has been completed in the above step S13, the alignment systems 27a, 27b are arranged in the illumination region of the illumination optical system IL and the position of the reference member 28 is measured (step S16) at the respective alignment systems 27a, 27b. In this process, the alignment systems 27a, 27b find the position of the plate P placed on the plate stage PS by the relative relationship of the position of the reference member 28 measured through the projection optical system PL beforehand and the position of a plate alignment mark formed on the plate P. When measurement is performed by the alignment systems 27a, 27b, light having the same wavelength width as the exposure light i.e. light that has passed through the wavelength selection filter arranged in the optical path is employed, so, when the wavelength selection filter arranged in the optical path is exchanged, even though the position of the reference member 28 is unchanged, this maybe detected at a different position. In order to eliminate this inconvenience, the position of the reference member 28 that determines the reference position of the plate stage PS is measured when the wavelength selection filter arranged in the optical path is changed over.

When the above steps have been completed, the main control system 20 feeds in the mask M and places it on the mask stage MS in accordance with the exposure data file and feeds in the plate and places it on the plate stage PS (step S17). It then calculates the position of the plate PS using the alignment systems 27a, 27b and then performs relative positional alignment (step S18) of the mask M and plate P in accordance with these measurement results. Since a plurality of shot regions are pre-set on the plate P, the shot region where the pattern of the mask M is to be transferred by the main control system 20 is positionally aligned so as to be positioned in the vicinity of the exposure region. The exposure light emitted from the illumination optical system IL is then directed onto part of the mask M and part of the pattern DP formed on the mask M is successively transferred into the shot regions of the plate P through the projection optical system PL whilst moving the mask M and the plate P in the X direction (step S19: illumination step, exposure step).

When exposure of a single shot region is completed, the main control system 20 determines whether or not there are any remaining shot regions to be exposed, in accordance with the content of the exposure data file (step S20). If it determines that a shot region remains to be exposed (decision result “YES”), the mask placed on the mask stage MS is exchanged (step S21) and exposure of the other shot region is performed in accordance with steps S18 and S19. On the other hand, if, in step S20, it determines that no shot region remains to be exposed (decision result “NO”), it determines whether or not exposure has been completed in respect of all of the plates (step S22). If exposure has not been completed in respect of all of the plates (decision result “NO”), the mask M on the mask stage MS is exchanged and the plate P whose exposure has been completed is fed out and a new plate P is fed in (step S23), after which processing returns to step S18. On the other hand, if exposure has been completed in respect of all the plates (decision result “YES”), the series of processes is terminated.

[Second Embodiment]

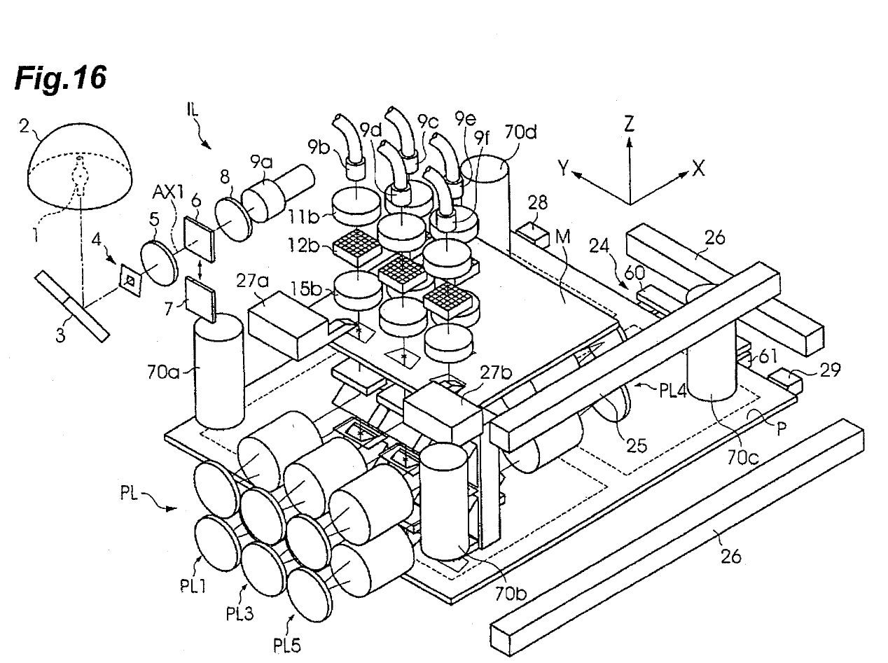

FIG. 16 is a perspective view showing diagrammatically the construction of the entire exposure apparatus according to a second embodiment of the present invention; members which are the same as members provided in the exposure apparatus of the first embodiment of the present invention shown in FIG. 1 are given the same reference symbols and further description thereof is omitted. The respect in which the exposure apparatus according to the second embodiment of the present invention shown in FIG. 16 differs from the exposure apparatus according to the first embodiment of the present invention shown in FIG. 1 is that plate alignment sensors 70a to 70d of the off-axis type are provided that are arranged at the side of the projection optical system PL. These plate alignment sensors 70a to 70d measure the position of the plate alignment marks formed on the plates P.

In the first embodiment, the position of the reference member 28 and the position of the plate alignment mark formed on the plate P were measured by the alignment systems 27a and 27b using light that had passed through the projection optical system PL and the position of the plate P was found from the relative position thereof. In this embodiment, the position (projection center) where the pattern DP formed on the mask M is projected is measured using the aerial image measurement device 24 constituting a first measurement device and the position of the plate alignment mark measured by the plate alignment sensors 70a to 70d constituting a second measurement device is measured, and the position of the plate P is found from these measurement results. The measurement results of the aerial image measurement device 24 and the measurement results of the plate alignment sensors 70a to 70d are supplied to the main control system 20 which constitutes position calculation means and the position of the plate P is found from these respective measurement results. Also, the reason for providing four plate alignments sensors 70a to 70d is in order to reduce the amount of movement of the plate stage PS as far as possible.

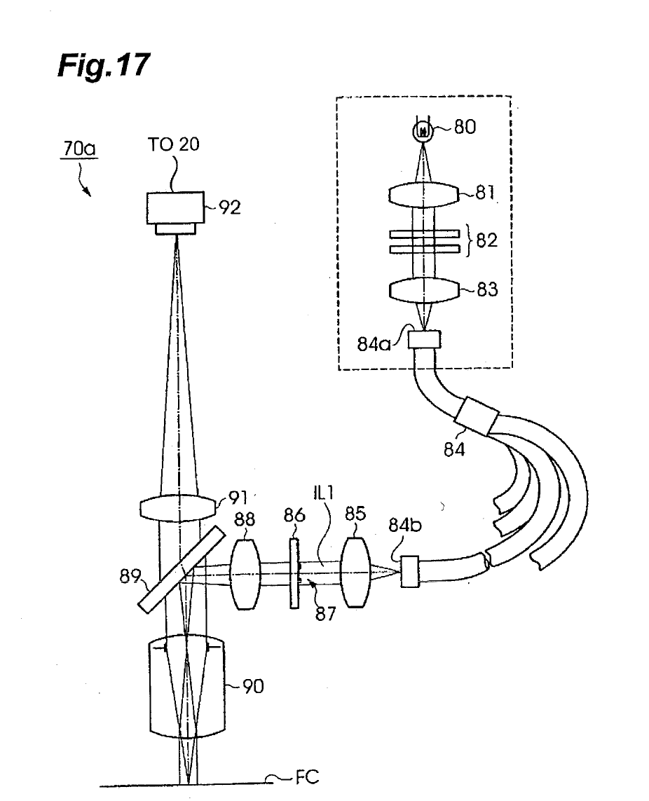

FIG. 17 is a view showing the construction of the optical system of the plate alignments sensors 70a to 70d. Since the construction of the respective plate alignment sensors 70a to 70d is identical, FIG. 17 illustrates by way of example only the construction of the plate alignment sensor 70a. In FIG. 17, 80 is a halogen lamp that emits light having a wavelength bandwidth of the order of 400 to 800 nm. The light that is emitted from the halogen lamp 80 is converted to parallel light by the condenser lens 81 and is then input to a dichroic filter 82 constructed with a variable transmission wavelength.

The light that has passed through the dichroic filter 82 is input to a condenser lens 83 that is arranged so that one focal point thereof is positioned substantially in the position of the input terminal 84a of the optical fiber 84. The optical fiber 84 comprises one input terminal (end) and four output terminals (ends), the respective output terminals being led into the interior of the respective plate alignment sensors 70a to 70d. The light that is emitted from one output terminal 84b of the optical fiber 84 is employed as detection light IL1. An index (reference) plate 86 formed with an index marking 87 of prescribed shape is illuminated by the detection light IL1 through a condenser lens 85.

The detection light IL1 that has passed through the index plate 86 is input to a half mirror 89 that branches the transmission light and the reception light, through a relay lens 88. The detection light IL1 that is reflected by the half mirror 89 is imaged on an imaging plane FC by means of an object lens 90. If the plate alignment mark formed on the plate P is arranged on the imaging plane FC, the reflected light passes through the object lens 90, the half mirror 89 and a second object lens 91 in sequence and is imaged on the image pickup surface of an image pickup element 92 comprising CCDs etc. and the detection result of the image pickup element 92 is supplied to the main control system 20.

In the above construction, the reference mark formed on the mask M arranged on the mask stage MS is moved within the illumination region and is positioned in the projection region of the aerial image measurement device 24. The position where the pattern DP formed on the mask M is projected (projection center) is then obtained by measuring with the aerial image measurement device 24 the image of the reference mark, by directing exposure light on to the reference mark which is formed on the mask M. Next, the aerial image measurement device 24 is moved directly below the plate alignment sensor 70a and the position provided on the plate alignment sensor 70a where the index mark 87 is generated is measured. The positions where the index mark 87 is generated are likewise measured for the plate alignment sensors 70b to 70d.

The respective distances (so-called baseline amounts) of the plate alignment sensors 70a to 70d with respect to the projection center are obtained from the above measurement results of the aerial image measurement device 24. After the baseline amounts are obtained, the position of the plate P is obtained by measuring the plate alignment mark formed on the plate P by one or other of the plate alignment sensors 70a to 70d.

Since the plate alignment sensors 70a to 70d measure the plate alignment marks without going through the projection optical system PL, light of a wide wavelength region emitted from the halogen lamp 80 can be employed as detection light IL. However, when the image of the reference mark formed on the mask M is measured by the aerial image measurement device 24, the image of the reference mark is projected by the projection optical system PL by illuminating the reference mark with light that has passed through the wavelength selection filter 6 or the wavelength selection filter 7, so, if the projection optical system PL has chromatic aberration, the projection center may change depending on which wavelength selection filter is arranged on the optical path.

Consequently, with the exposure apparatus of this embodiment, every time the wavelength selection filter arranged on the optical path is exchanged, the image of the reference mark formed on the mask is measured by the aerial image measurement device 24 and, in addition, the positions of the images of the index marks 87 generated by the plate alignment sensors 70a to 70d are respectively measured by the aerial image measurement device 24 so as to thereby find the baseline. In this way, whichever of the wavelength selection filter 6 and wavelength selection filter 7 is arranged on the optical path, the position of the plate P can be found at high accuracy.

In the second embodiment described above, the baseline was found by measuring the image of the reference mark formed on the mask and the images of the index marks 87 generated from the plate alignment sensors 70a to 70 using the aerial image measurement device 24, every time the wavelength selection filter on the optical path was exchanged. However, it would be possible to correct the baseline amounts by measuring beforehand the amounts of positional offset of the reference pattern when the respective wavelength selection filters 6 and 7 were arranged on the optical path, storing these correction amounts and using these correction amounts during position measurement. In this way, lowering of throughput can be prevented, since it is unnecessary to make measurements using the aerial image measurement device 24 every time the wavelength selection filters on the optical path are exchanged.

Also, in the above embodiment, a super-high pressure mercury lamp was provided as the light source 1 in the illumination optical system IL and it was arranged to select light of the g-line (436 nm), the h-line (405 nm) or i-line (365 nm) as required by a wavelength selection filter 6. However, apart from this, the present invention maybe applied when a KrF excimer laser (248 nm), ArF excimer laser (193 nm) and an F₂ laser (157 nm) are provided as the light source 1 and the laser beams emitted from these lasers are employed. When such laser beams are employed, it is desirable to change over the wavelength width that is transmitted by insertion/withdrawal etc. of wavelength selection filters and/or band narrowing means, using for example a laser beam that has been subjected to band narrowing and a laser beam that has not been subjected to band narrowing. Furthermore, if a light source that emits light of a continuous spectrum is employed, the wavelength width of the light that is directed onto the mask M may be continuously changed.

It should be noted that, although, in the first embodiment described above, the position of the reference member 28 was measured using the alignment systems 27a, 27b every time the wavelength selection filter arranged in the optical path was exchanged, if the wavelength of the exposure light and the wavelength of the alignment light are different, in order to correct for the axial chromatic aberration of the alignment systems 27a, 27b produced by this wavelength difference, it would be possible to arrange to correct the focal position of the alignment systems 27a, 27b in accordance with a map of the imaging positions in the optical axis direction prepared by finding beforehand the amounts of chromatic aberration for each image height (object height) of the projection optical system PL. For this technique for example U.S. Pat. No. 5,726,757 may be consulted. Also, in order to correct for the alignment error produced by horizontal offset of the imaging position of the alignment systems 27a, 27b due to the difference of the wavelength of the exposure light and the wavelength of the alignment light, it may be arranged to find this horizontal offset to be set beforehand and to correct the offset of the alignment systems 27a, 27b in accordance with the amount of this horizontal offset that is thus found. For this technique, for example U.S. Pat. No. 5,850,279 may be consulted.

Although, in the embodiment described above, the aerial image measurement device 24 comprised six detection units arranged along the Y direction, various modified examples are possible concerning the number and arrangement thereof. In this respect, image detection could be performed for example by a pair of detection units separated with a gap along the Y axis direction or, depending on the case, could be performed by image detection by a single detection unit.

Furthermore, although, in the embodiment described above, the present invention was applied to a multi-scanning type projection exposure apparatus wherein the projection optical units PL1 to PL5 comprised a pair of imaging optical systems, the present invention could also be applied to a multi-scanning projection exposure apparatus of the type wherein the projection optical units each comprise one or three or more imaging optical systems. Also, although, in the embodiment described above, the present invention was applied to a multi-scanning type projection optical apparatus wherein the projection optical units PL1 to PL5 comprised imaging optical systems of the catadioptric type, there is no restriction to this and the present invention could also be applied for example to a multi-scanning projection optical apparatus of the type comprising refractive type imaging optical systems.

[Third Embodiment]

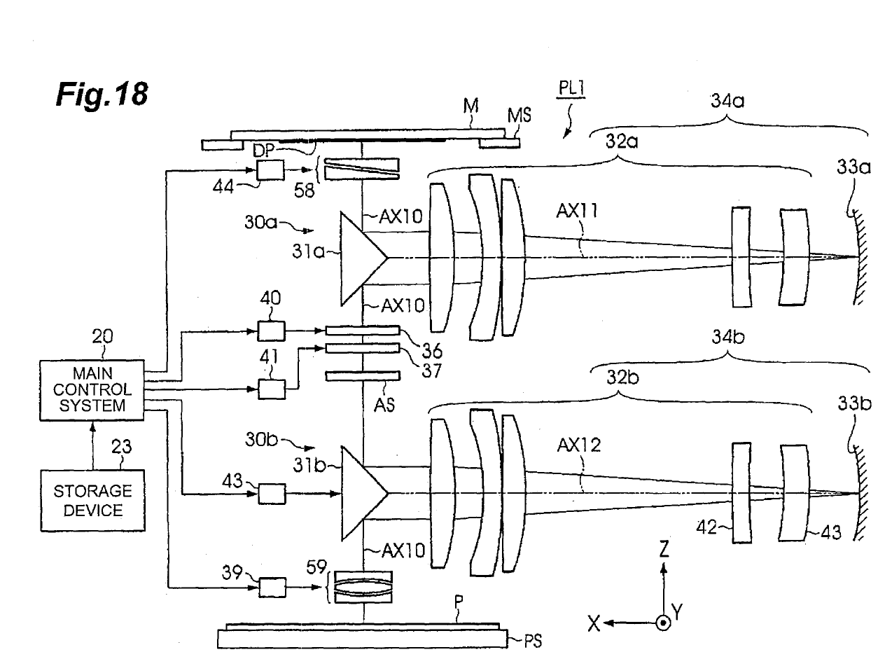

Although, in the embodiments described above, as the focus correction optical system 38, a plurality of lenses were employed, it would be possible to employ a pair of wedge-shaped optical device for this focus correction optical system. FIG. 18 is a view showing diagrammatically the construction of a projection optical unit in an exposure apparatus according to a third embodiment. Since this third embodiment differs solely in respect of the construction of the projection optical units in the exposure apparatus according to the first embodiment described above, an overall description of the exposure apparatus according to the third embodiment will be omitted.

The projection optical unit PL1 of the third embodiment shown in FIG. 18, like the projection optical unit of the first embodiment, comprises a first imaging optical system 30a that forms a primary image of the pattern DP on the mask M and a second imaging optical system 30b that forms a secondary image of this pattern DP on the plate. The construction of this first and second imaging optical system 30a and 30b is the same as that of the first embodiment described above, so further description thereof is omitted.

In the third embodiment, a focus correction optical system 58 is additionally provided on the optical path between the mask M and a first reflecting face of the first right-angled prism 31a of the first imaging optical system 30a and an image shifter constituted by the first plane parallel plate 36 and a second plane parallel plate 37 is additionally provided on the optical path between the field stop AS and the second reflective phase of the first right-angled prism 31a of the first imaging optical system 30a. In addition, a magnification correction optical system 59 is additionally provided in the optical path between the plate P and the second reflective surface of the second right-angled prism 31b of the second imaging optical system 30b. The function of the image shifter constituted by the first plane parallel plate 36 and second plane parallel plate 37 is identical with that of the first embodiment, so further description thereof will be omitted.

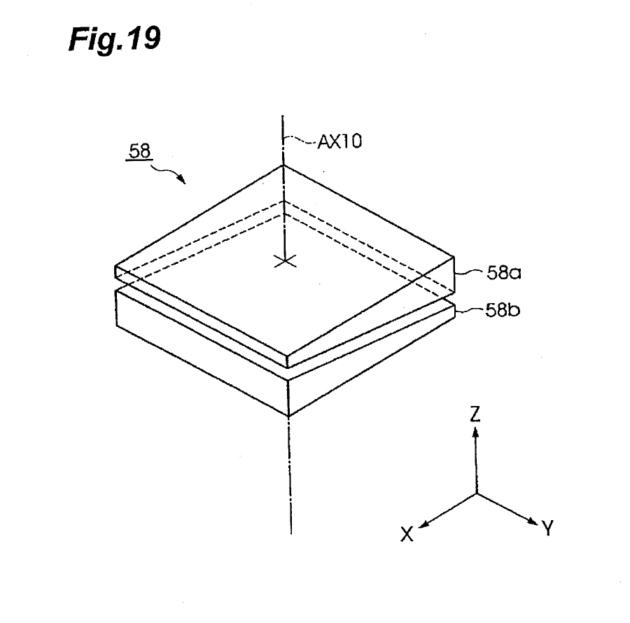

The construction and action of the focus correction optical system 58 is described below. FIG. 19 is a view showing diagrammatically the construction of the focus correction optical system 58 of FIG. 18. As shown in FIG. 18 and FIG. 19, on the optical path between the mask M and the first right-angled prism 31a, in order from the mask M, the focus correction optical system 58 comprises a first wedge-shaped optical member 58a having a wedge cross-sectional shape in the plane (XZ plane) containing the optical axis AX10 and a second wedge-shaped optical member 58b having a wedge cross-sectional shape in the plane (XZ plane) containing the optical axis AX10. The refractive plane of the first wedge-shaped optical member 58a on the side of the mask M is a plane whose normal coincides with the optical axis AX10; the refractive plane of the second wedge-shaped optical member 58b on the side of the first right-angled prism 31a is a plane whose normal coincides with the optical axis AX10. The refractive plane of the first wedge-shaped optical member 58a on the side of the first right-angled prism 31a and the refractive plane of the second wedge-shaped optical member 58b on the side of the mask M are mutually substantially parallel planes.

By relatively moving at least one or other of the first wedge-shaped optical member 58a and second wedge-shaped optical member 58b along the X direction, the optical path length between the mask M and the first right-angled prism 31a can be altered and the imaging position of the projection optical unit PL1 in the direction of the optical axis AX10 can thereby be altered. The direction of movement of the first wedge-shaped optical member 58a and of the second wedge-shaped optical member 58b may be a direction in the plane containing the optical axis AX10 (XZ plane) and may be a direction along the refractive plane of the first wedge-shaped optical member 58a on the side of the first right-angled prism 31a (refractive plane of the second wedge-shaped optical member 58b on the side of the mask M) If this is done, the optical path length can be altered whilst keeping the separation of the first wedge-shaped optical member 58a and second wedge-shaped optical member 58b constant in the direction of the optical axis.

In this embodiment, at least one or other of the first wedge-shaped optical member 58a and second wedge-shaped optical member 58b is made capable of being rotated about the optical axis AX10 (Z axis).

In the initial condition of the first wedge-shaped optical member 58a and a second wedge-shaped optical member 58b, as described above, the refractive plane of the first wedge-shaped member 58a on the side of the first right-angled prism 31a and the refractive plane of the second wedge-shaped optical member 58b on the side of the mask M are mutually parallel, and the refractive plane of the first wedge-shaped optical member 58a on the side of the mask M and the refractive plane of the second wedge-shaped optical member 58b on the side of the first right-angled prism 31a are mutually parallel. That is, the first wedge-shaped optical member 58a and the second wedge-shaped optical member 58b as a whole constitute plane-parallel plates so the input light beam thereto undergoes substantially no deviation.

When at least one or other of the first wedge-shaped optical member 58a and the second wedge-shaped optical member 58b is then rotated about the optical axis AX10 (Z axis), the first wedge-shaped optical member 58a and the second wedge-shaped optical member 58b as a whole constitute a wedge-shaped optical member having a prescribed apical (refracting) angle (vertex angle), so the input light beam is deviated and, as a result, the overall inclination (inclination in the direction of rotation about the X axis and inclination in the direction of rotation about the Y axis) of the image plane of the projection optical unit PL1 changes with respect to the XY plane (surface of the plate P).

It is preferable that both the first wedge-shaped optical member 58a and the second wedge-shaped optical member 58b should be capable of rotation about the optical axis AX10 (Z axis). By such a construction, both of the inclination direction and inclination angle of the image plane of the projection optical unit PL1 can be controlled at will. This focus correction optical system 58 is controlled by means of a seventh drive section 44.

For example the magnification control device 30 disclosed in FIG. 11 of US reissued U.S. Pat. No. 37,361 may be consulted with reference to the details of the construction and action of the magnification correction optical system 59 in the third embodiment.

Returning to FIG. 18, the aspect in which control in the exposure apparatus of the third embodiment differs from that of the first embodiment described above is that the optical properties of the projection optical units PL1 to PL5 are controlled taking into account the inclination of the image plane. Specifically, this consists solely in further addition to the inclination of the image plane (i.e. the angle of rotation of the wedge-shaped optical members 58a and 58b), with the measurement step S14 and correction step S15 in the flow chart of the exposure action shown in FIG. 15 as parameters, so further description thereof is omitted.

[Fourth Embodiment]

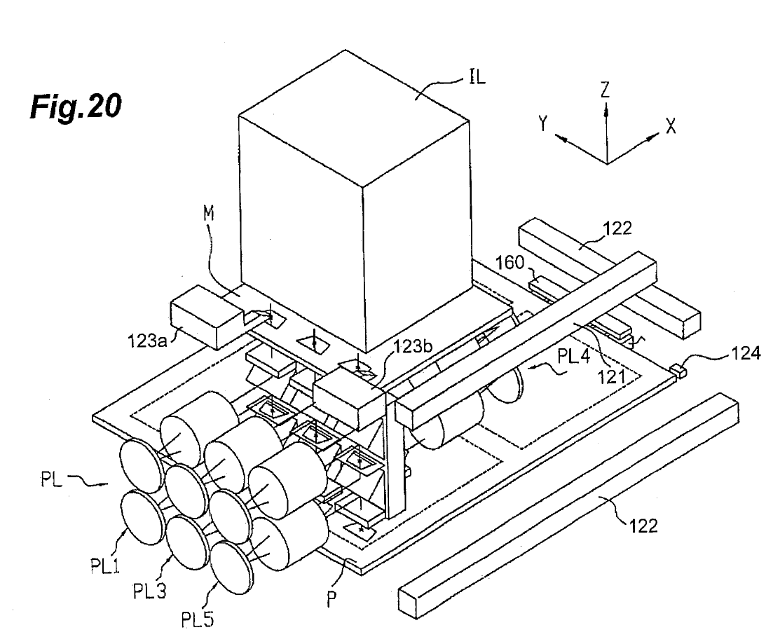

An exposure apparatus according to an embodiment of the present invention is described below with reference to the drawings. FIG. 20 is a perspective view showing the diagrammatic construction of an entire exposure apparatus according to a fourth embodiment of the present invention. In this embodiment, there is described an example in which the present invention is applied to an exposure apparatus of the step and scan type in which the image of the pattern DP (pattern) of a liquid-crystal display element formed on a mask M is transferred to a plate P constituting a photosensitive substrate to which a photosensitive material (resist) has been applied, while relatively moving the mask M and the plate (substrate) P with respect to a projection optical system comprising a plurality of projection optical units of the catadioptric type. In this embodiment, it will be assumed that a photoresist (sensitivity: 20 mJ/cm²) or resin resist (sensitivity: 60 mJ/cm²) is applied onto the plate P.

In the following description, the XYZ rectangular co-ordinate system shown in FIG. 20 is defined and the positional relationships of the respective members are described with reference to this XYZ co-ordinate system. In this XYZ rectangular co-ordinate system, the X axis and Y axis are arranged parallel with the plate P and the Z axis is arranged orthogonal to the plate P. In the XYZ co-ordinate system in the Fig., the XY plane is arranged in a plane substantially parallel with the horizontal plane and the Z axis is arranged in the vertical direction. Also, in this embodiment, the direction of movement (scanning direction) of the mask M and the plate P is set as the X axis direction.

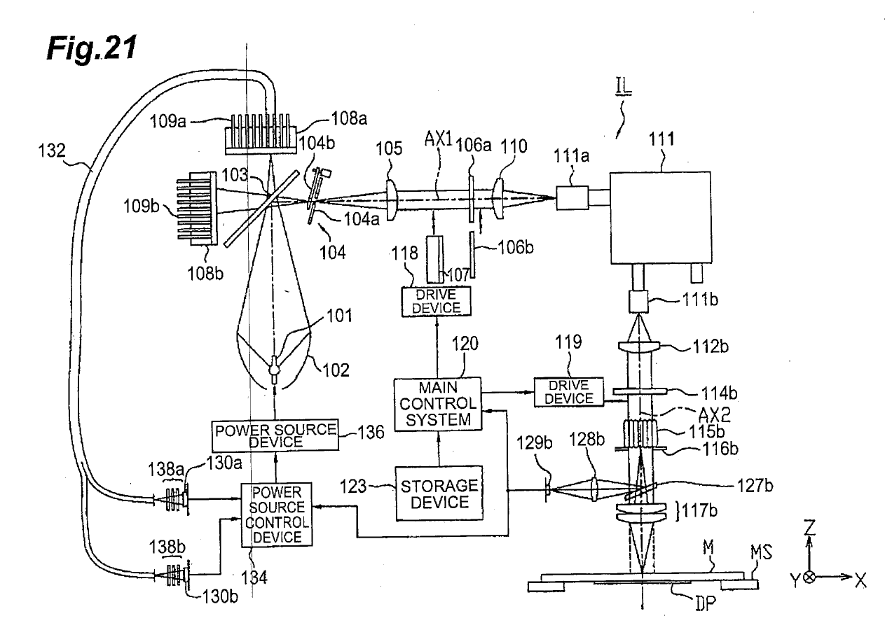

The exposure apparatus of this embodiment comprises an exposure optical system IL for uniformly illuminating a mask M that is supported parallel with the XY plane by means of a mask holder (not shown) on a mask stage MS (not shown in FIG. 20). FIG. 21 is a side view of the illumination optical system IL, members which are the same as members illustrated in FIG. 20 being given the same reference symbols. Referring to FIG. 20 and FIG. 21, the illumination optical system IL comprises a light source 101 comprising for example a super-high pressure mercury lamp. Since the light source 101 is arranged at the first focal point position of an elliptical mirror 102, the light source image of the illumination light beam that is emitted from the light source 101 produced by light of a wavelength region including g-line (436 nm) light, h-line (405 nm) light and i-line (365 nm) light is formed by means of a reflecting mirror (plane mirror) 103 at the second focal point position of the elliptical mirror 102. That is, components other than the wavelength region including the g-line, h-line and i-line which are not required for exposure are removed by reflection at the elliptical mirror 102 and reflecting mirror 103.

A shutter 104 is arranged at this second focal point position. The shutter 104 comprises an aperture plate 104a (see FIG. 21) arranged in inclined fashion with respect to the optical axis AX1 and a light-shielding plate 104b (see FIG. 21) that shields or opens the aperture formed in the aperture plate 104a. The reason why the shutter 104 is arranged at the second focal point position of the elliptical mirror 102 is so that the aperture formed in the aperture plate 104a can be shielded by a small amount of movement of the light-shielding plate 104b for achieving convergence of the illumination light beam emitted from the light source 101 and in order to be able to obtain illumination light beam of pulse form by abruptly varying the amount of light of the illumination light beam passing through the aperture.

A light-absorbent plate 108a made of a light-absorbent member is arranged in the direction of advance of the leakage light passing through the reflective mirror 103. The light-absorbent plate 108a is provided in order to prevent thermal effects or optical effects (for example stray light) being applied by such leakage light to the exposure apparatus, by absorbing the leakage light that has passed through the reflecting mirror 103. The absorbent plate 108a is formed by for example black Alumirite. A heat-radiating member constituted by a heat sink 109a is mounted on the light-absorbent plate 108a. The heat sink 109a comprises a plurality of heat-radiating plates formed of a metal of high thermal conductivity (such as for example aluminum or copper), so that heat generated when leakage light that has passed through the reflective mirror 103 is absorbed by the absorbent plate 108a can be emitted from these heat-radiating plates. The leakage light includes light of the wavelength region including the g-line, h-line and i-line, light of the infra-red region and light of the visible region.

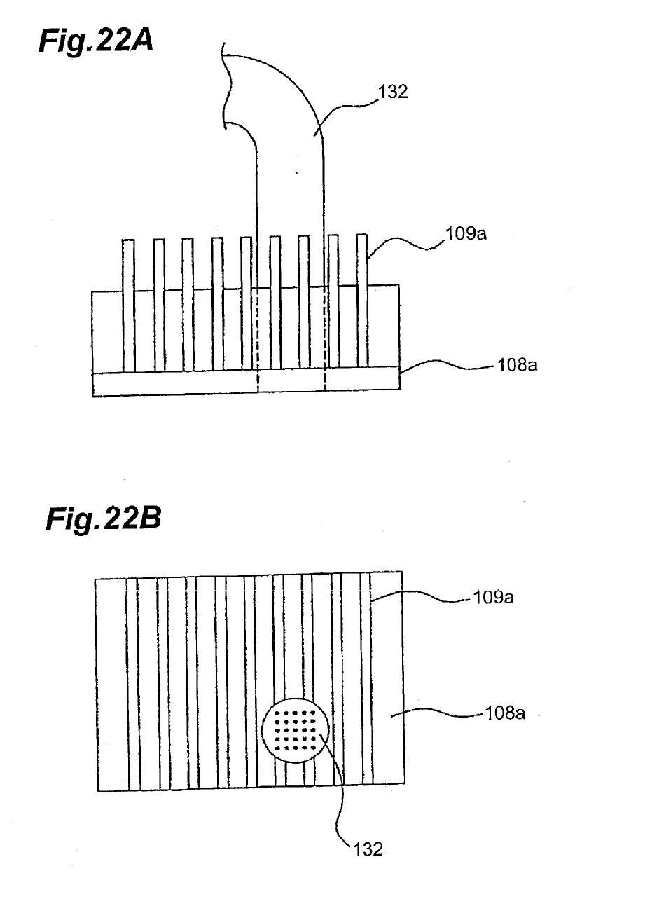

FIGS. 22A and 22B are views showing the shape of the light-absorbent plate 108a and heat sink 109a. FIG. 22A is a side view thereof and FIG. 22B is a plan view thereof. As shown in this Fig., at the position where the leakage light of the light-absorbent plate 108a is incident, one end (terminal) of an optical fiber 132 for guiding the leakage light into optical sensors 130a, 130b is arranged. That is, in the light-absorbent plate 108a, there is provided a through-hole through which passes an optical fiber 132, one end of the optical fiber 132 being arranged in this through-hole.

The other end (terminal) of the optical fiber 132 is branched to two output terminals. The leakage light emitted from one output terminal thereof is input to the optical sensor 130a through a filter 138a, while the leakage light emitted from the other output terminal is input to the optical sensor 130b through a filter 138b. This filter 138a comprises three filters, namely, a filter for passing light of the g-line, h-line and i-line, a dummy filter and a light-reducing optical filter and passes light of a wavelength region including the g-line, h-line and i-line. Also, the filter 138b comprises three filters, namely, a filter for passing light of the g-line, h-line and i-line, a filter for passing light of the i-line and a light-reducing optical filter and passes light of a wavelength region including only i-line light.

The reason for this monitoring of the leakage light produced by a plurality of wavelengths i.e. detection of the illuminance of the light of a wavelength region including light of the g-line, h-line and i-line by the optical sensor 130a and detection of the illuminance of light of a wavelength region including the i-line by the optical sensor 130b is that secular deterioration of the output of the light source 101 and, in general, deterioration of the output of short wavelengths (secular deterioration) occurs rapidly and that the sensitivity to the various wavelengths depends on the type of resist. Specifically, if the sensitivity of the resist for short wavelengths is high compared with the sensitivity of the resist for long wavelengths, only the illuminance of the g-line, h-line and i-line light is detected so controlling the output of the light source in accordance with this detected illuminance does not enable an appropriate exposure amount to be obtained; it is necessary to detect the illuminance of the i-line light and to control the output of the light source in accordance with this detected illuminance. Also, in cases where the resist has a substantially constant sensitivity from short wavelengths to long wavelengths, an appropriate exposure amount can be obtained by controlling the output of the light source in accordance with the detected illuminance by detecting the illuminance of light of the g-line, h-line and i-line.

The detection signals of light amount detected by the optical sensors 130a, 130b are input to a light source control device 134 that controls the amount of power that is supplied to the light source 101 and the amount of power that is supplied to the light source 101 from the power source device 136 is controlled in accordance with the control signal from the power source control device 134. Specifically, in accordance with the detected signals from the sensors 130a and 130b, the power source control device 134 controls the power source device 136 in accordance with the spectral characteristics of the resist that is applied to the plate P as will be described, such that the illuminance of the light from the light source 101 i.e. the illuminance of the light of the wavelength region including the g-line, h-line and i-line or the illuminance of the light of the wavelength region including light of the i-line should have a constant value.

The dispersed light beam from the light source image that is formed at the second focal point position of the elliptical mirror 102 is converted to substantially parallel light beam by the relay lens 105 and is then input to a wavelength selection filter 106a or 106b. The wavelength selection filter 106a transmits only light beam of a desired wavelength region and is arranged to be freely advanced or with drawn with respect to the optical path (optical axis AX1). Also, a wavelength selection filter 106b constructed so as to be insertable/removable with respect to the optical path in the same way as the wavelength selection filter 106a is provided together with the wavelength selection filter 106a, so that at least one other of these wavelength selection filters 106a, 106b is arranged in the optical path. One or other of the wavelength selection filters 106a, 106b is arranged in the optical path by control of the drive device 118 by the main control system 120 in FIG. 21.

In this embodiment, it will be assumed that the wavelength selection filter 106a transmits light of a wavelength region including only the i-line whereas the wavelength selection filter 106b transmits light of a wavelength region including light of the g-line, h-line and i-line. Thus, in this embodiment, the wavelength width (wavelength region) of the light that is directed onto the mask is changed over by arranging one or other of the wavelength selection filters 106a, 106b in the optical path. The wavelength selection filters 106a and 106b correspond to wavelength selection means as referred to in the present invention.

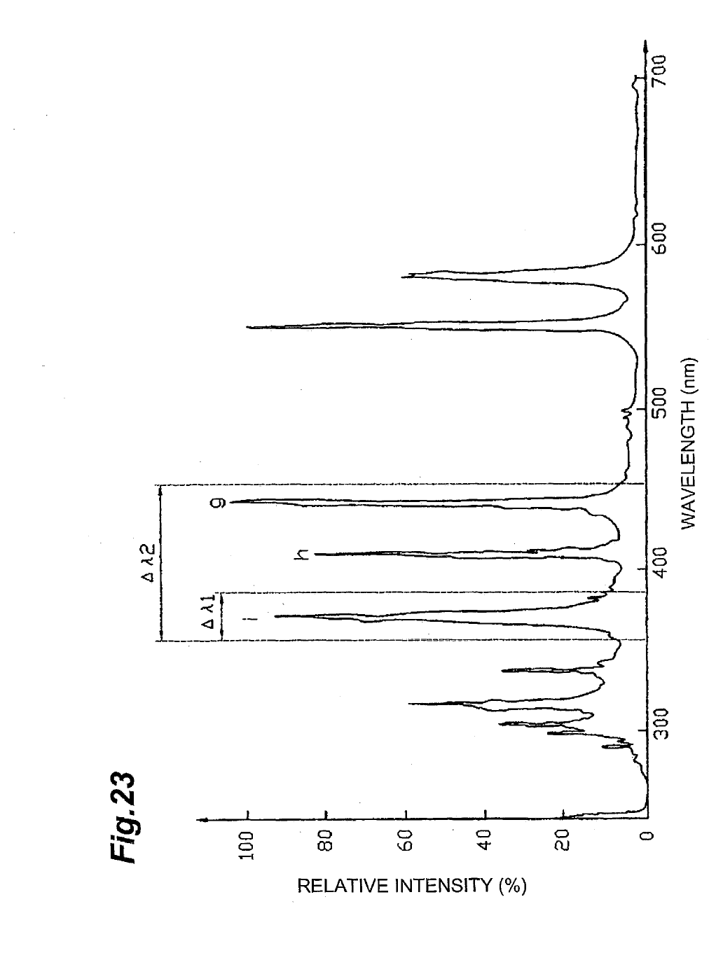

The spectrum of the light transmitted through the wavelength selection filters 106a and 106b will now be described. FIG. 23 is a view given in explanation of the spectrum of the light transmitted through the wavelength selection filters 106a, 106b. As shown in FIG. 23, light of a spectrum including a plurality of peaks (emission lines) is emitted over a wide wavelength region of the order of wavelengths 300 to 600 μm from the light source 1. Of the light that is emitted from the light source 1, wavelength components that are unnecessary for exposure are removed during reflection by the elliptical mirror 102 and reflecting mirror 103, as described above. When light from which components that are unnecessary for exposure is incident on the wavelength selection filter 106a arranged in the optical path, light of wavelength width (wavelength region) Δλ1 including the i-line shown in FIG. 23 is transmitted. In contrast, when the wavelength selection filter 106b is arranged in the optical path, light of wavelength width (wavelength region) Δλ2 including the g-line, h-line and i-line is transmitted.

The optical power that is transmitted through the wavelength selection filter 106a is obtained by integrating the spectrum within the wavelength width Δλ1 and the optical power that is transmitted through the wavelength selection filter 106b is obtained by integrating the spectrum within the wavelength width Δλ2. Since, as shown in FIG. 23, the respective spectra of the g-line, h-line and i-line show approximately the same distribution, the power of the light transmitted through the wavelength selection filter 106a and the power of the light transmitted through the wavelength selection filter 106b are roughly in a ratio of about 1:3.

Assuming at this point, as described above, in the present embodiment, that photoresist of sensitivity 20 mJ/cm² or resin resist of sensitivity 60 mJ/cm² is applied onto the plate P, the ratio of these sensitivities is 1:3. Consequently, when photoresist, which is of high sensitivity is applied to the photoresist P, the wavelength selection filter 106a which is of low optical transmission power is arranged on the optical path, producing a low exposure power and when resin resist, which is of low sensitivity, is applied, the wavelength selection filter 106b which is of high optical transmission power, is arranged on the optical path, so that the exposure power becomes high. Thus, in this embodiment, the power of the light that is directed onto the plate P is altered by changing over the wavelength width of the transmitted light, by exchanging the wavelength selection filters arranged on the optical path in accordance with the sensitivity of the resist (spectral properties of the resist) that is applied to the plate P.

Also, since the amount of light from the light source 101 can be monitored at a plurality of wavelengths i.e. it is possible to monitor the illuminance of the light when the wavelength selection filter 106a is arranged on the optical path (illuminance of the light of the wavelength region including only the i-line) and to monitor the illuminance of the light when the wavelength selection filter 106b is arranged on the optical path (illuminance of the light of the wavelength region including the g-line, h-line and i-line), the illuminance on the plate P can be detected even when the wavelength width of the light that is directed onto the plate P is changed over.

Also, from the point of view of correction of chromatic aberration of the projection optical system, higher resolution can be achieved when the wavelength width of the light employed is made narrower, so for example when exposure power is required, exposure may be performed with a broader wavelength width, albeit at some sacrifice of resolution, by arranging the wavelength selection filter 106b on the optical path, while, when high resolution is required, exposure can be performed with a narrow wavelength width, albeit with some sacrifice of exposure power and hence of throughput, by arranging the wavelength selection filter 106a on the optical path. Thus it is possible to cope with various different required resolutions simply by changing over the wavelength width. Thus, with this embodiment, it is possible to cope with various different required resolutions by changing over-the wavelength width of the transmitted light by exchanging the wavelength selection filter that is arranged on the optical path in accordance with the resolution of the pattern that is to be transferred to the plate P.

A light-reducing filter 107 that is arranged in such a way that it can be insertable/removable with respect to the optical path (optical axis AX1) is arranged between the relay lens 105 and the wavelength selection filters 106a, 106b. This light-reducing filter 107 is arranged in the optical path when exposing a plate P to which photoresist of high sensitivity has been applied. Control to arrange the light-reducing filter 107 in the optical path is effected by the main control system 120 in FIG. 21 controlling a drive device 118.

A light-absorbing plate 108b constituting a light-absorbing member is arranged in the direction of advance of the light that is reflected by the light-reducing filter 107. This light-absorbing plate 108b is provided in order to prevent thermal effects or optical effects (for example stray light) due to this reflected light affecting the exposure apparatus, by absorbing the reflected light from the light-reducing filter 107. Like the light-absorbing plate 180a, the light-absorbing plate 108b may be formed for example of black Alumirite. A heat sink 109b constituting a heat-radiating member is mounted on the light-absorbing plate 108b. The heat sink comprises a plurality of heat-radiating plates formed of a metal of high thermal conductivity (such as for example aluminum or copper), so that heat generated when light reflected by the light-reducing filter 107 is absorbed by the absorbent plate 108b can be emitted from these heat-radiating plates.

The light that has passed through the light-reducing filter 107 and the wavelength selection filter 106a or 106b is again made to converge by passing through the relay lens 110. The input terminal (end) 11a of a light guide 111 is arranged in the vicinity of this convergence position. The light guide 111 is for example a random light guide fiber constituted by randomly bundling a large number of elementary optical fibers and comprises the same number of input terminals 111a as the number of light sources 101 (a single one in the case of FIG. 20) and a number of emission terminals (output ends) 111b to 111f (only the emission terminal 111b is shown in FIG. 21) of the same number as the number of projection optical units (five in the case of FIG. 20) constituting the projection optical system PL. In this way, the light that is input to the input terminal 111a of the light guide 111 is emitted in divided fashion from the five emission terminals 111b to 111f after propagating through the interior thereof.

Between the emission terminal 111b of the light guide 111 and mask M, there are arranged in sequence collimating lens 112b, a light-reducing filter (light adjustment means) constituted by a density gradient filter 114b, a fly's eye integrator 115b, an aperture stop 116b, a half mirror 127b and a condenser lens system 117b. Likewise, between the emission terminals 111c to 111f of the light guide 111 and the mask M, there are respectively arranged in sequence collimator lenses 112c to 112f, light-reducing filters (light adjustment means) 114c to 114f, fly's eye integrators 115c to 115f, aperture stops 116c to 116f, half mirrors 127b to 127f and condenser lens systems 117c to 117f. In order to simplify the description, the construction of the optical members provided between the emission terminals 111c to 111f of the light guide 111 and the mask M will be described representatively by the collimator lens 112b, light-reducing filter 114b, fly's eye integrator 115b, aperture stop 116b, half mirror 127b and condenser lens system 117b, provided between the emission terminal 111b of the light guide 111 and the mask M.

The dispersed light beam that is emitted from the emission terminal 111b of the light guide 111 is converted to substantially parallel light beam by the collimator lens 112b and is then input to the light-reducing filter 114b. This light-reducing filter 114b is arranged in the optical path in order to obtain an illuminance of the illuminating light that is optimum in accordance with the spectral characteristics of the resist that is applied to the plate P. The control whereby this light-reducing filter 114b is arranged in the optical path is effected by the main control system 120 controlling drive means 119 so that the position of the light-reducing filter 114b in the X axis direction is set in accordance with the spectral characteristics of the resist applied to the plate P, to be described, and the illuminance of the illuminating light on the plate P.

The light beam passing through the light-reducing filter 114b is input to the fly's eye integrator (optical integrator) 115b. The fly's eye integrator 115b is constituted by arranging vertically and horizontally in closely packed fashion a large number of positive lens device such that their central axial rays extend along the optical axis AX2. Consequently, the wave surface of the light beam that is input to the fly's eye integrator 115b is divided by the large number of lens elements to form a secondary light source consisting of the same number of light source images as the number of lens device in the subsequent focal plane (i.e. the vicinity of the emission face). That is, a substantially planar light source is formed at the focal plane on the downstream side of the fly's eye integrator 115b.

The light beam from the large number of two-dimensional light sources formed in the focal plane on the downstream side of the fly's eye integrator 115b is restricted by the aperture stop 116b (not shown in FIG. 20) arranged in the vicinity of the focal plane on the downstream side of the fly's eye integrator 115b before being input to the half mirror 127b. The light beam that is reflected by the half mirror 127b is input to an illuminance sensor 129b through a lens 128b. This illuminance sensor 129b is a sensor for detecting the illuminance at a position that is optically conjugate with the plate P. By means of this illuminance sensor 129b, it is possible to detect the illuminance on the plate P without lowering the throughput even during exposure. The illuminance sensor 129b detects the illuminance of the light of the wavelength region including only the i-line that has passed through the wavelength selection filter 106a or detects the illuminance of the light of the wavelength region including the g-line, h-line and i-line that has passed through the wavelength selection filter 106b. Also, the detected value of the illuminance sensor 129b is input to the main control system 120 and the power source control device 134.

In contrast, the light beam that passes through the half mirror 127b is input to the condenser lens system 117b.

The aperture stop 116b is arranged in a position that is substantially optically conjugate with the pupil plane of the corresponding projection optical unit PL1 and has an aperture section for defining the range of the two-dimensional light source that contributes to the illumination. The aperture section of this aperture stop 116b may be of fixed aperture diameter or may be of variable aperture diameter. The case where the aperture section of the aperture stop 116b is variable will now be described. By changing the aperture diameter of this variable aperture section, the σ value (ratio of the aperture of the two-dimensional light source image on its pupil plane with respect to the aperture diameter on the pupil plane of the projection optical units PL1 to PL5 constituting the projection optical system PL) of the aperture stop 116b that determines the illumination conditions can be set to a desired value.

The light beam that has passed through the condenser lens system 117b illuminates in superimposed fashion the mask M where the pattern DP is formed. Likewise, the dispersed light beam that is emitted from the other emission terminals 111c to 111f of the light guide 111 illuminates the mask M in super imposed fashion, respectively, through collimating lenses 112c to 112f, light-reducing filters 114c to 114f, fly's eye integrators 115c to 115f, aperture stops 116c to 116f, half mirrors 127c to 127f and condenser lens systems 117c to 117f, in sequence. That is, the illuminating optical system IL illuminates a plurality (a total of five in the case of FIG. 20) of trapezoid regions which are lined up in the Y axis direction on the mask M.

The light from each of the illumination regions on the mask M is input to the projection optical system PL comprising a plurality (five in total in the case of FIG. 20) of projection optical units PL1 to PL5 which are arranged along the Y axis direction corresponding to each illumination region. The construction of all of the projection optical units PL1 to PL5 is the same. In this way, the light that has passed through the projection optical system PL constituted of the plurality of projection optical units PL1 to PL5 forms an image of the pattern DP on the plate P that is held parallel with the XY plane by means of a plate holder, not shown, on the plate stage (not shown in FIG. 20) PS.

A storage device 123 such as a hard disk is connected with the main control system 120 described above and the exposure data file is stored in this exposure apparatus 123. In the exposure data file, there are stored the processes necessary for performing exposure of the plate P and the sequence of these processes and, for each of these processes, information relating to the resist applied to the plate P (for example, the spectral characteristics of the resist), information relating to the resolution required, the mask M to be used, the wavelength selection filter to be used, the amount of correction of the illumination optical system IL (illumination optical characteristics information), the amount of correction of the projection optical system PL (projection optical characteristics information) and information relating to flatness of the substrate etc. (so-called recipe data). The main control system 120 is connected also with a power source control device 134 and controls the illuminance of the light source 101 by means of the power source control device 134 and a power source device 136, in accordance with the spectral characteristics of the resist.

It is preferable that the recipe data (illumination data file) referred to above should be capable of being updated or added to by means such as communication means. In more detail, an arrangement may be adopted whereby the exposure apparatus according to the present embodiment and a management system within the device fabrication works where this exposure apparatus is installed are connected by a local area network (LAN), and the recipe data of the exposure apparatus is updated or added to from this management system. In this management system, fabrication devices for processes of various types apart from the exposure apparatus, such as for example devices for pre-processing steps such as resist treatment apparatus, etching apparatus and film deposition apparatus and devices for after-processing steps such as assembly apparatus and inspection apparatus are connected by a local area network (LAN). Consequently, with such a management system, it is possible to manage what rod is flowing to what apparatus, so recipe data matching the rod in question can be sent to the exposure apparatus and this exposure apparatus controlled in accordance with the recipe data that is sent to it.

Returning to FIG. 20, the mask stage MS described above is provided with a scanning drive system (not shown) that has a long stroke for moving the mask stage MS along the X axis direction constituting the scanning direction. Also, a pair of alignment drive systems (not shown) is provided for rotating the mask stage MS by a minute amount about the Z axis and for moving it by a minute amount along the Y axis, which is in a direction orthogonal to the scanning direction. It is also arranged that the positional co-ordinates of the mask stage MS may be measured and positionally controlled by means of a laser interferometer (not shown) employing a moving mirror.

An identical drive system is provided for the plate stage PS. Specifically, a scanning drive system (not shown) having a long stroke for moving the plate stage PS along the X axis direction, which is the scanning direction, and a pair of alignment drive systems (not shown) for moving the plate stage PS by a minute amount along the Y axis direction, which is a direction orthogonal to the scanning direction and for rotating it by a minute amount about the Z axis are provided. Also, it is arranged that measurement and positional control of the positional co-ordinates of the plate stage PS should be effected by a laser interferometer (not shown) using a moving mirror 122. Furthermore, as means for effecting relative positional alignment of the mask M and the plate P along the XY plane, a pair of alignment systems 123a, 123b are arranged above the mask M. Furthermore, on the plate stage PS, there is provided an illuminance sensor 124 for detecting the illuminance of the illuminating light on the plate P i.e. of both the light in the wavelength region including the g-line, h-line and i-line and the light of the wavelength region including only the i-line; its detection values are input to the main control system 120 of the illumination optical system IL.

Thus, by the action of the scanning drive system on the side of the mask stage MS and the scanning drive system on the side of the plate stage PS, the mask M and the plate P are unitarily moved along the same direction (X axis direction) with respect to the projection optical system PL comprising the plurality of projection optical units PL1 to PL5 and the entire pattern region on the mask M is thereby transferred (scanning exposure) to the entire exposure region on the plate P.

Thus, as described above, in this embodiment, the optical sensor 130a detects the illuminance of the light of the wavelength region including light of the g-line, h-line and i-line and the optical sensor 130b detects the illuminance of light of the wavelength region including light of the i-line. That is, when, in accordance with the spectral characteristics of the resist that is applied to the plate P, the wavelength selection filter 106a is arranged in the optical path, the optical sensor 130b detects the illuminance of the light of the wavelength region including the light of the i-line and the power source device 136 is controlled by the power source control device 134 such that the illuminance of the light of the wavelength region including light of the i-line, in the light from the light source, is of an optimum, constant value in accordance with the spectral characteristics of the resist.

On the other hand, when, in accordance with the spectral characteristics of the resist that is applied to the plate P, the wavelength selection filter 106b is arranged in the optical path, the optical sensor 130a detects the illuminance of the light of the wavelength region including the light of the g-line, h-line and i-line and the power source device 136 is controlled by the power source control device 134 such that the illuminance of the light of the wavelength region including light of the g-line, h-line and i-line, in the light from the light source, is of an optimum, constant value in accordance with the spectral characteristics of the resist. The illuminance on the plate P of light of a prescribed wavelength region, of the light from the light source 101, can therefore be controlled such that an optimum, constant illuminance in accordance with the spectral characteristics of the resist is produced.

Also, since the optical sensor 130a detects the illuminance of light of the wavelength region including light of the g-line, h-line and i-line and the optical sensor 130b detects the illuminance of light of the wavelength region including light of the i-line, even when there is a drop with time in the illuminance of the light source 101, control to an optimum, constant illuminance in accordance with the spectral characteristics of the resist can be achieved. That is, when there is a drop with time in the illuminance of the light source 101, typically the drop in illuminance occurs more rapidly in light of shorter wavelengths, so by using the optical sensor 130b to detect the illuminance of the light of the wavelength region including the light of the i-line, drop in the illuminance of the light of the i-line, whose drop with time in illuminance occurs more rapidly, can be reliably detected. Consequently, by controlling the amount of power supplied to the light source 1, the illuminance of the light of the wavelength region including the light of the i-line can be controlled such that it is constant.

It should be noted that the wavelength selection filters 106a and 106b are not required structures in the case where the resist that is applied to the plate P has sensitivity only for light of a specific wavelength region. That is, exposure of the resist can be performed using illuminating light of optimum illuminance by detecting the illuminance of the light of the wavelength region for which the resist that is applied to the plate P has sensitivity and controlling the illuminance of the light of this wavelength region to an optimum, constant value in accordance with the spectral characteristics of the resist.

In this embodiment, it is assumed that a photoresist of sensitivity 20 mJ/cm² is applied to the plate P or that resin resist of sensitivity 60 mJ/cm² is applied, the ratio of these sensitivities being 1:3. Recipe data including the spectral characteristics of this photoresist and resin resist is stored in the storage device 123. Consequently, when a photoresist of high sensitivity is applied to the plate P, the wavelength selection filter 106a is arranged in the optical path by the drive device 118 and the photosensitive filters 114b to 114f are controlled by the drive device 119 in accordance with the recipe data including the spectral characteristics of the photoresist that is stored in the storage device 123 so that the illuminance of the illuminating light can be made to be an optimum, constant illuminance, in accordance with the spectral characteristics of the photosensitive material that is applied to the plate.

In contrast, when resin resist, which is of low sensitivity, is applied to the plate P, the wavelength selection filter 106b is arranged in the optical path by the drive device 118 and the light-reducing filters 114b to 114f are controlled by the drive device 119 in accordance with the recipe data including the spectral characteristics of the resist that is stored in the storage device 123 so that the illuminance of the illuminating light can be made to be an optimum, constant illuminance, in accordance with the spectral characteristics of the photosensitive material that is applied to the plate.

That is, the illuminance of the illuminating light on the plate P is detected by the illumination sensor 124 and this detection value is input to the main control system 120 of the illumination optical system IL. The main control system 120 uses the drive device 118 to arrange the wavelength selection filter 106a or 106b in the optical path and uses the drive device 119 to control the light-reducing filters 114b to 114f such that the illuminance of the illuminating light on the plate P is controlled to an illuminance matching the spectral characteristics of the resist that is applied to the plate P i.e. to an illuminance matching a photoresist of sensitivity 20 mJ/cm² or a resin resist of sensitivity 60 mJ/cm². Thus, the drive device 118 controls the wavelength selection filter 106a or 106b and the drive device 119 controls the light-reducing filters 114b to 114f so that the illuminance of the illuminating light on the plate P is an optimum, constant illuminance in accordance with the spectral characteristics of the resist that is applied to the plate P. Also, the illuminance of the illuminating light on the plate P can be made to be an optimum, constant illuminance in accordance with the spectral characteristics of the resist that is applied to the plate P by controlling the power source device 136 that supplies power to the light source 101 in accordance with the illuminance on the plate P detected by the illumination sensor 124.

Exposure of the resist applied to the substrate can therefore be performed using optimum, constant illuminating light in accordance with the spectral characteristics of the resist that is applied to be a substrate.

It should be noted that, during exposure, the illuminance on the plate P can be obtained from the illuminance detected by an illuminance sensor 129b that detects the illuminance at a position that is optically conjugate with the plate P. That is, the illuminance on the plate can be detected without lowering the throughput during exposure. The illuminance of the illuminating light on the plate P can therefore be made to be an optimum, constant illuminance in accordance with the spectral characteristics of the resist that is applied to the plate P, by controlling the wavelength selection filters 106a, 106b and the light-reducing filters 114b to 114f or by controlling the power source device 136 that supplies power to the power source 101 in accordance with this detected illuminance.

[Fifth Embodiment]

Next, an exposure apparatus according to a fifth embodiment of the present invention will be described with reference to the drawings. In the description of this fifth embodiment, members which are the same as members of the exposure apparatus according to the fourth embodiment are given the same reference symbols as we used in the description of the fourth embodiment.

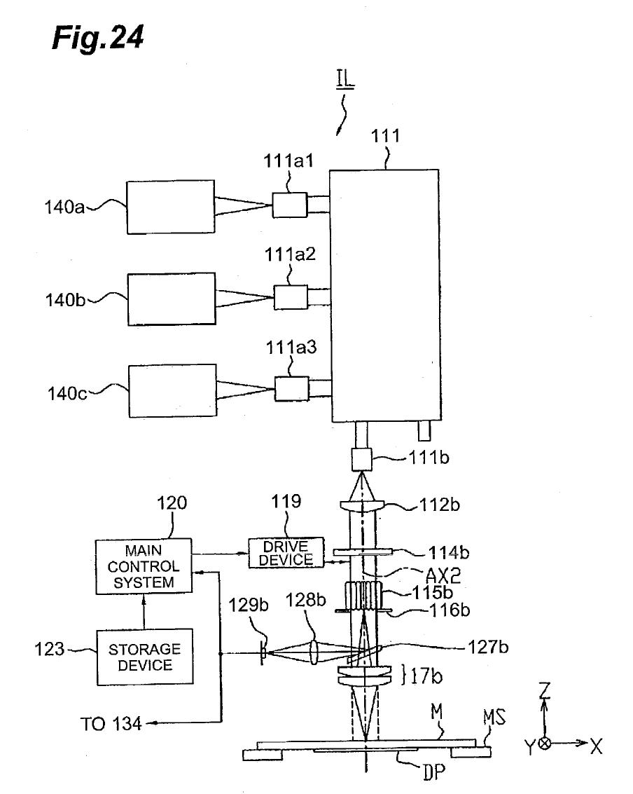

FIG. 24 is a side view of an illumination optical system IL of an exposure apparatus according to a fifth embodiment of the present invention. Apart from the portion of the exposure optical system IL, the exposure apparatus of this fifth embodiment is of the same construction as the exposure apparatus according to the fourth embodiment.

The exposure apparatus according to the fifth embodiment comprises three light sources in the illuminating optical system IL and the illuminating light from the three light sources is divided into five illuminating beams by passing through a light guide 111 of excellent random characteristics. In this embodiment also, photoresist (sensitivity: 20 mJ/cm²) or resin resist (sensitivity: 60 mJ/cm²) is assumed to be applied to the plate P. Also, the XYZ rectangular co-ordinate system shown in FIG. 24 is the same as the XYZ rectangular co-ordinate system employed in the fourth embodiment.

As shown in FIG. 24, the illumination optical system IL is provided with three light source units 140a, 140b, and 140c; the illuminating light emitted from the light source unit 140a is input to the input terminal (end) 111a1 of the light guide 111; the illuminating light emitted from the light source unit 140b is input to the input terminal (end) 111a2; and the illuminating light emitted from the light source unit 140c is input to the input terminal (end) 111a3.

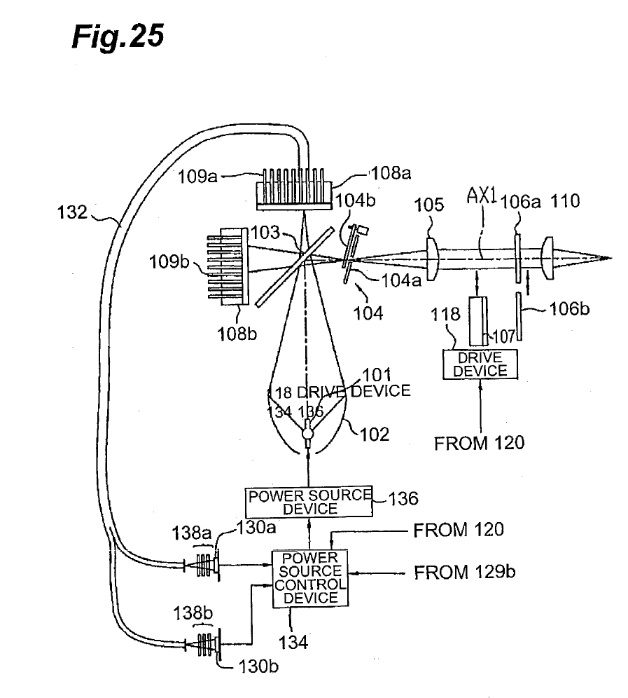

FIG. 25 shows the construction of the light source unit 140a. The light source 101 is arranged at the first focal point position of an elliptical mirror 102, so the illuminating light beam emitted from the light source 101, after being reflected by the reflecting mirror 103, forms a light source image produced by light of the wavelength region including the g-line, h-line and i-line at the position of the second focal point of the elliptical mirror 102. A shutter 104 is arranged at the position of this second focal point. The shutter 104 is constructed of an aperture plate 104a arranged in inclined fashion with respect to the optical axis AX1 and a light-shielding plate 104b that shields or opens the aperture formed in the aperture plate 104a.

A light-absorbent plate 108a constituting a light-absorbent member is arranged in the direction of advance of the leakage light that is transmitted through the reflecting mirror 103. A heat sink 109a constituting a radiating member is mounted on the light-absorbent plate 108a. A through-hole through which passes an optical fiber 132 is provided in the light-absorbent plate 108a, one end of the optical fiber 132 being arranged in this through-hole. The leakage light emitted from the other end of the optical fiber 132 is input to the optical sensors 130a, 130b.

The detection signal of the illuminance of the leakage light that is detected by the optical sensors 130a, 130b is input to the power source control device 134 that controls the amount of power supplied to the light source 101 and the amount of power supply to the light source 101 from the power source device 136 is controlled in accordance with the control signal from the power source control device 134. That is, control of the power source device 136 is performed by the power source control device 134 in accordance with the detection signal from the optical sensors 130a, 130b such that the illuminance of the illuminating light emitted from the light source 101 i.e. the illuminance of the light of the wavelength region including the g-line, h-line and i-line or the illuminance of the light of the wavelength region including the light of the i-line has a constant value.

The dispersed light beam from the light source image formed at the second focal point position of the elliptical mirror 102 is converted to substantially parallel light beam by the relay lens 105 and is then input into the relay lens 110. A light-reducing filter 107 constituting a light-reducing member and wavelength selection filters (wavelength selection means) 106a, 106b that are arranged to be insertable/removable with respect to the optical path (optical axis AX1) are arranged between the relay lens 105 and the relay lens 110. Control whereby the light-reducing filter 107 or wavelength selection filters 106a, 106b are arranged in the optical path is performed by the main control system 120 controlling the drive device 118.

A light-absorbent plate 108b constituting a light-absorbent member is arranged in the direction of advance of the light reflected by the light-reducing filter 107. The light that has passed through the light-reducing filter 107 and the wavelength selection filter 106a or 106b is again made to converge by means of the relay lens 110. An input terminal 111a1 of the light guide 111 is arranged in the vicinity of this convergence position. Consequently, illuminating light of a constant illuminance emitted from the light source unit 140a is input to the input terminal 111a1 of the light guide 111.

Likewise, illuminating light of constant illuminance that is emitted from the light source unit 140b is input to the input terminal 111a2 and illuminating light of constant illuminance that is emitted from the light source unit 40c is input to the input terminal 111a3. The construction of the light source unit 140b and light source unit 140c is identical with the construction of the light source unit 140c, so further description thereof is omitted.

The light guide 111 shown in FIG. 24 is a random light guide fiber constituted for example by bundling a large number of fiber device in random fashion and comprises a number of input terminals (ends) 111a1, 111a2, 111a3 which is the same as the number of the light source units and a number of emission terminals (ends) 111b to 111f (only the emission terminal 111b is shown in FIG. 24) which is the same as the number of projection optical units constituting the projection optical system PL. The light that is input to the input terminals 111a1, 111a2, 111a3 of the light guide 111 is propagated through the interior thereof and is divided and emitted from the five emission terminals 111b to 111f. The illuminance of the illuminating light emitted from the emission terminals 111b to 111f of the light guide 111 is controlled such that the illuminance of the illuminating light input to the input terminals 111a1, 111a2, 111a3 is constant and so is a constant illuminance.

Preferably this light guide 111 comprises a plurality of optical fiber bundles. Specifically, in this case, there is provided an optical fiber bundle which optically connects the input terminal 111a1 and emission terminal 111b whereby some of the light that is input from the input terminal 111a1 is led to the emission terminal 111b; there is provided an optical fiber bundle which optically connects the input terminal 111a2 and emission terminal 111b whereby some of the light that is input from the input terminal 111a2 is led to the emission terminal 111b; and there is provided an optical fiber bundle which optically connects the input terminal 111a3 and output terminal 111b whereby some of the light that is input from the input terminal 111a3 is led to the emission terminal 111b. Likewise, there are provided optical fiber bundles that optically connect respectively the input terminal 111a1, input terminal 111a2 and input terminal 111a3 with the emission terminals 111c to 111f.

The dispersed light beam respectively emitted from the emission terminals 111b to 111f of the light guide 111 passes sequentially through the collimator lenses 112b to 112f, light-reducing filters 114b to 114f, fly's eye integrators 115b to 115f, aperture stops 116b to 116f, half mirrors 127b to 127f and condenser lens systems 117b to 117f and respectively illuminates the mask M in super imposed fashion. Specifically, the illumination optical system IL illuminates a plurality (a total of five in FIG. 20) of trapezoid regions that are lined up in the Y axis direction on the mask M.

The light from the illumination regions on the mask M is input to the projection optical system PL comprising a plurality (a total of five in FIG. 20) of projection optical units PL1 to PL5 arranged along the Y axis direction so as to correspond to the respective illumination regions.

Thus, the entire pattern region on the mask M is transferred to the entire exposure region on the plate P (scanning exposure) by movement of the mask M and plate P in unitary fashion along the same direction (X axis direction) with respect to the projection optical system PL comprising the plurality of projection optical units PL1 to PL5, by the action of the scanning drive system on the side of the mask stage MS and the scanning drive system on the side of the plate stage PS.

In this fifth embodiment, in the respective light source units 140a, 140b, 140c, the optical sensor 130a detects the illuminance of the light of the wavelength region including light of the g-line, h-line and i-line and the optical sensor 130b detects the illuminance of the light of the wavelength region including light of the i-line. That is, when, in accordance with the spectral characteristics of the resist that is applied to the plate P, the wavelength selection filter 106a is arranged in the optical path, the optical sensor 130b detects the illuminance of the light of the wavelength region including the light of the i-line and the power source device 136 is controlled by the power source control device 134 such that the illuminance of the light of the wavelength region including light of the i-line, in the light from the light source, is of an optimum, constant value in accordance with the spectral characteristics of the resist.

On the other hand, when, in accordance with the spectral characteristics of the resist that is applied to the plate P, the wavelength selection filter 106b is arranged in the optical path, the optical sensor 130a detects the illuminance of the light of the wavelength region including the light of the g-line, h-line and i-line and the power source device 136 is controlled by the power source control device 134 such that the illuminance of the light of the wavelength region including light of the g-line, h-line and i-line, in the light from the light source, is of an optimum, constant value in accordance with the spectral characteristics of the resist. The illuminance on the plate P of light of a prescribed wavelength region, of the light from the light sources 101, can therefore be controlled such that an optimum, constant illuminance in accordance with the spectral characteristics of the resist is produced.

Also, even when there is a drop with time in the illuminance of the light sources 101, control to an optimum, constant illuminance in accordance with the spectral characteristics of the resist can be achieved just as in the case of the exposure apparatus according to the fourth embodiment.

Also, in the case where the resist that is applied to the plate P has sensitivity only for light of a specific wavelength region, just as in the case of the exposure apparatus according to the fourth embodiment, the wavelength selection filters 106a, 106b are not necessary structures.

In this embodiment, it is assumed that a photoresist of sensitivity 20 mJ/cm² is applied to the plate P or that resin resist of sensitivity 60 mJ/cm² is applied. Recipe data including the spectral characteristics of this photoresist and resin resist is stored in the storage device 123. Consequently, the wavelength selection filter 106a or 106b is arranged in the optical path by the drive device 118 and the photosensitive filters 114b to 114f are controlled by the drive device 119 in accordance with the recipe data including the spectral characteristics of the photoresist so that the illuminance of the illuminating light can be made to be an optimum, constant illuminance, in accordance with the spectral characteristics of the photosensitive material that is applied to the plate P. Also, by controlling the power source device 136 that supplies power to the light source 101 in accordance with the illuminance of the illuminating light on the plate P detected by the illumination sensor 124, the illuminance of the illuminating light on the plate P can be made to be an optimum, constant illuminance in accordance with the spectral characteristics of the resist that is applied to the plate P.

Also, just as in the case of the exposure apparatus according to the fourth embodiment, the illuminance on the plate P can be obtained from the illuminance detected by an illuminance sensor 129b even during exposure. The illuminance of the illuminating light on the plate P can therefore be made to be an optimum, constant illuminance in accordance with the spectral characteristics of the resist that is applied to the plate P, by controlling the wavelength selection filters 106a, 106b and the light-reducing filters 114b to 114f in accordance with this detected illuminance, or by controlling the power source device 136 that supplies power to the power source 101.

[Sixth Embodiment]

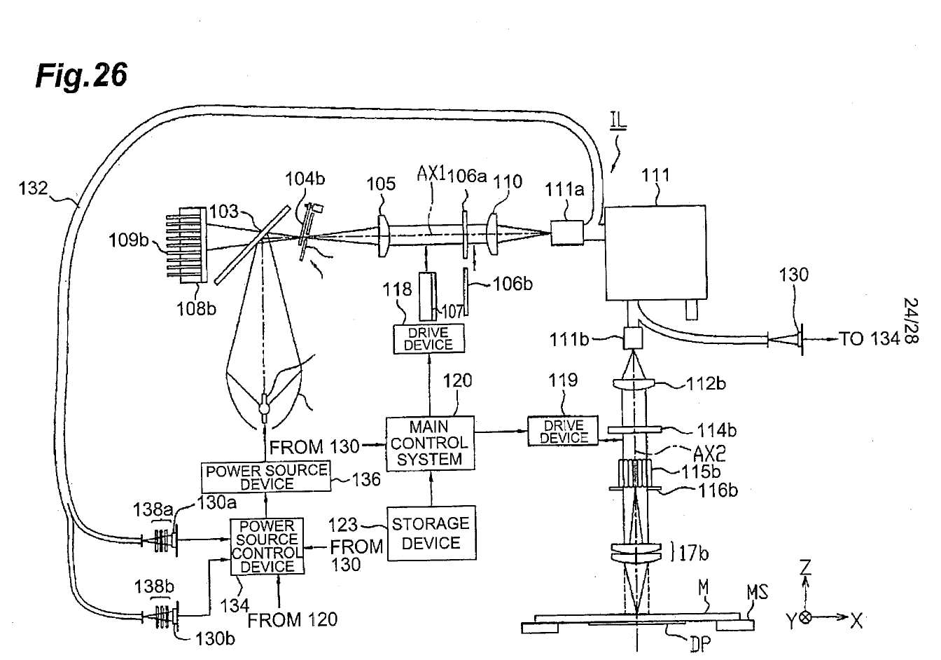

Next, an exposure apparatus according to a sixth embodiment of the present invention will be described with reference to the drawings. In the description of this sixth embodiment, members of the exposure apparatus which are the same as the members of the exposure apparatus of the fourth embodiment are described by appending the same reference symbols as are used in the description of the fourth embodiment. Also, the XYZ rectangular co-ordinate system shown in FIG. 26 is the same as the XYZ rectangular co-ordinate system employed in the fourth embodiment.

FIG. 26 is a side view of an illumination optical system IL of an exposure apparatus according to a sixth embodiment of the present invention. Apart from the portion of the exposure optical system IL, the exposure apparatus of this sixth embodiment is of the same construction as the exposure apparatus according to the fourth embodiment.

In the exposure apparatus according to the sixth embodiment, the arrangement wherein, in the exposure apparatus according to the fourth embodiment, the illuminance of the illuminating light from the light source 101 was detected by means of leakage light of the reflecting mirror 103 is altered so that the illuminance of the illuminating light from the light source 101 is detected using the illuminating light that is directed onto the input terminal 111a of the light guide 111; furthermore, the arrangement whereby the illuminance of the illuminating light at a position that is optically conjugate with the plate P was detected using the illuminating light branched by the half mirrors 127b to 127f is altered so that the illuminance of the illuminating light at a position that is optically conjugate with the plate P is detected using the illuminating light emitted from the emission terminal 111b of the light guide 111.

Specifically, the illuminating light that is emitted from the other terminal of the optical fiber that is branched from the input terminal 111a of the light guide 111 is input to the sensors 130a, 130b and the illuminance of the illuminating light is detected by the sensors 130a, 130b. The detected values obtained by the sensors 130a, 130b are input to the power source control device 134, which exercises control such that the illuminance of the illuminating light from the light source 101 produced by the power source device 136 i.e. the illuminance of the light of the wavelength region including light of the g-line, h-line and i-line or the illuminance of the light of the wavelength region including the i-line has a constant value. Also, the illuminating light that is emitted from the other terminal of the optical fiber that is branched from the emission terminal 111b is input to the sensor 130 and the illuminance of the illuminating light is detected by the sensor 130. The detected value obtained by the sensor 130 is input to the main control system 120 and power source control device 134.

In this sixth embodiment also, the illuminance of the light of the wavelength of region including light of the g-line, h-line and i-line is detected by the optical sensor 130a and the illuminance of the light of the wavelength region including light of the i-line is detected by the optical sensor 130b. That is, when, in accordance with the spectral characteristics of the resist that is applied to the plate P, the wavelength selection filter 106a is arranged in the optical path, the illuminance of the light of the wavelength region including light of the i-line is detected by the optical sensor 130b and the power source device 136 is controlled by means of the power source control device 134 such that the illuminance of the light of the wavelength region including light of the i-line, of the light from the light source, is an optimum, constant value in accordance with the spectral characteristics of the resist. On the other hand, when, in accordance with the spectral characteristics of the resist that is applied to the plate P, the wavelength selection filter 106b is arranged in the optical path, the optical sensor 130a detects the illuminance of the light of the wavelength region including the light of the g-line, h-line and i-line and the power source device 136 is controlled by the power source control device 134 such that the illuminance of the light of the wavelength region including light of the g-line, h-line and i-line, in the light from the light source, is of an optimum, constant value in accordance with the spectral characteristics of the resist. The illuminance of light of a prescribed wavelength region, of the light from the light sources 101, can therefore be controlled such that an optimum, constant illuminance in accordance with the spectral characteristics of the resist is produced.

Also, even when there is a drop with time in the illuminance of the light sources 101, control to an optimum, constant illuminance in accordance with the spectral characteristics of the resist can be achieved just as in the case of the exposure apparatus according to the fourth and fifth embodiment.

Also, in the case where the resist that is applied to the plate P has sensitivity only for light of a specific wavelength region, just as in the case of the exposure apparatus according to the fourth and fifth embodiment, the wavelength selection filters 106a, 106b are not necessary structures.

In this sixth embodiment, it is assumed that a photoresist of sensitivity 20 mJ/cm² is applied to the plate P or that resin resist of sensitivity 60 mJ/cm² is applied. Recipe data including the spectral characteristics of this photoresist and resin resist is stored in the storage device 123. Consequently, the wavelength selection filter 106a or 106b is arranged in the optical path by the drive device 118 and the photosensitive filters 114b to 114f are controlled by the drive device 119 in accordance with the recipe data including the spectral characteristics of the photoresist so that the illuminance of the illuminating light can be made to be an optimum, constant illuminance, in accordance with the spectral characteristics of the photosensitive material that is applied to the plate P. Also, by controlling the power source device 136 that supplies power to the power source 101 in accordance with the illuminance of the illuminating light on the plate P detected by the illumination sensor 124, or by controlling the light-reducing filters 114b to 114f, the illuminance of the illuminating light on the plate P can be made to be an optimum, constant illuminance in accordance with the spectral characteristics of the resist that is applied to the plate P.

Also, just as in the case of the exposure apparatus according to the fourth or fifth embodiment, the illuminance on the plate P can be obtained from the illuminance detected by an illuminance sensor 129b even during exposure. The illuminance of the illuminating light on the plate P can therefore be made to be an optimum, constant illuminance in accordance with the spectral characteristics of the resist that is applied to the plate P, by controlling the wavelength selection filters 106a, 106b and the light-reducing filters 114b to 114f in accordance with this detected illuminance, or by controlling the power source device 136 that supplies power to the power source 101.

[Seventh Embodiment]

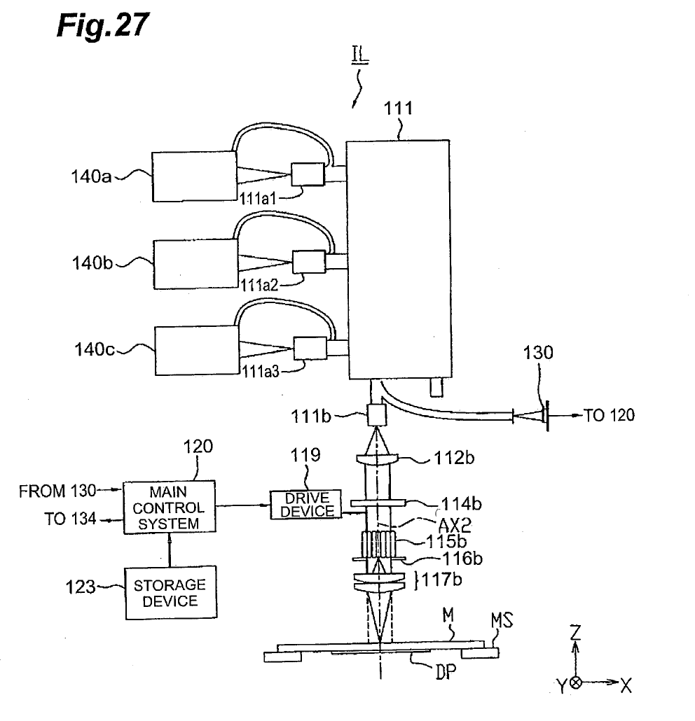

Next, an exposure apparatus according to a seventh embodiment of the present invention will be described with reference to the drawings. In the description of this seventh embodiment, members of the exposure apparatus which are the same as the members of the exposure apparatus of the fourth to sixth embodiments are described by appending the same reference symbols as are used in the description of the fourth to sixth embodiments. Also, the XYZ rectangular co-ordinate system shown in FIG. 27 is the same as the XYZ rectangular co-ordinate system employed in the fourth embodiment.

FIG. 27 is a side view of an illumination optical system IL of an exposure apparatus according to a seventh embodiment of the present invention. Apart from the portion of the exposure optical system IL, the exposure apparatus of this seventh embodiment is of the same construction as the exposure apparatus according to the fourth embodiment.

In the exposure apparatus according to the seventh embodiment, the arrangement wherein, in the light source units 140a, 140b, 140c of the exposure apparatus according to the fifth embodiment, the illuminance of the illuminating light from the light source 101 was detected by means of leakage light of the reflecting mirror 103 is altered so that the illuminance of the illuminating light from the light source is detected using the illuminating light that is directed onto the input terminals (ends) 111a1, 111a2, 111a3 of the light guide 111; furthermore, the arrangement whereby the illuminance of the illuminating light at a position that is optically conjugate with the plate P was detected using the illuminating light branched by the half mirrors 127b to 127f is altered so that the illuminance of the illuminating light at a position that is optically conjugate with the plate P is detected using the illuminating light emitted from the emission terminal (end) 111b of the light guide 111.

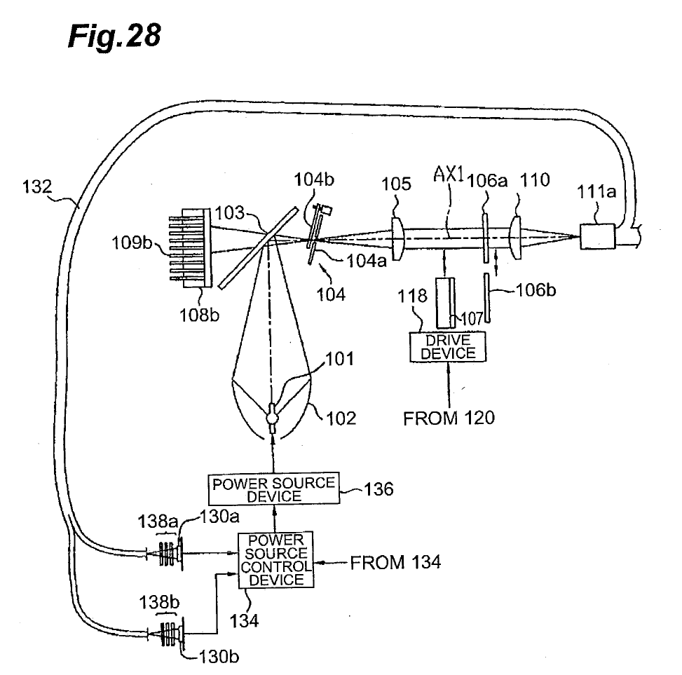

FIG. 28 shows the construction of the light source unit 140a. As shown in this Fig., in the light source unit 140a, the illuminating light that is emitted from the other end of the optical fiber that is branched from the input terminal 111a of the light guide 111 is directed onto the sensors 130a, 130b and the illuminance of the illuminating light is detected by the sensors 130a, 130b. The detected values obtained by the sensors 130a, 130b are input to the power source control device 134, which exercises control such that the illuminance of the illuminating light from the light source 101 produced by the power source device 136 i.e. the illuminance of the light of the wavelength region including light of the g-line, h-line and i-line or the illuminance of the light of the wavelength region including the i-line is constant. In the case of the light source units 140b and 140c also, the illuminance of the illuminating light is detected by an identical construction and control is exercised such that the illuminance of the illuminating light from the light source 101 produced by the power source device 136 i.e. the illuminance of the light of the wavelength region including light of the g-line, h-line and i-line or the illuminance of the light of the wavelength region including the i-line is constant.

Also, as shown in FIG. 27, the illuminating light that is emitted from the other terminal of the optical fiber that is branched from the emission terminal 111b is input to the sensor 130 and the illuminance of the illuminating light is detected by the sensor 130. The detected value obtained by the sensor 130 is input to the main control system 120 and power source control device 134.

Preferably the light guide 111 according to this seventh embodiment comprises a plurality of optical fiber bundles. Specifically, in this case, there is provided an optical fiber bundle which optically connects the input terminal 111a1 and emission terminal 111b; there is provided an optical fiber bundle which optically connects the input terminal 111a2 and emission terminal 111b; and there is provided an optical fiber bundle which optically connects the input terminal 111a3 and output terminal 111b. Likewise, there are provided optical fiber bundles that optically connect respectively the input terminal 111a1, input terminal 111a2 and input terminal 111a3 with the emission terminals 111c to 111f.

Also, the light guide 111 may comprise an emission terminal (end) for detection. In this case, apart from the optical fiber bundles that optically connect the input terminal and emission terminal as described above, there are provided an optical fiber bundle that optically connects the input terminal 111a1 with the emission terminal for detection, an optical fiber bundle that optically connects the input terminal 111a2 with the emission terminal for detection and an optical fiber bundle that optically connects the input terminal 111a3 with the emission terminal for detection.

In this seventh embodiment, in the light source units 140a, 140b, 140c, respectively, the optical sensor 130a detects the illuminance of the light of the wavelength region including the g-line, h-line and i-line and the optical sensor 130b detects the illuminance of the wavelength region including the i-line. That is, when, in accordance with the spectral characteristics of the resist that is applied to the plate P, the wavelength selection filter 106a is arranged in the optical path, the optical sensor 130b detects the illuminance of the light of the wavelength region including the light of the i-line and the power source device 136 is controlled by the power source control device 134 such that the illuminance of the light of the wavelength region including light of the i-line, in the light from the light source, is of an optimum, constant value in accordance with the spectral characteristics of the resist.

On the other hand, when, in accordance with the spectral characteristics of the resist that is applied to the plate P, the wavelength selection filter 106b is arranged in the optical path, the optical sensor 130a detects the illuminance of the light of the wavelength region including the light of the g-line, h-line and i-line and the power source device 136 is controlled by the power source control device 134 such that the illuminance of the light of the wavelength region including light of the g-line, h-line and i-line, in the light from the light source, is of an optimum, constant value in accordance with the spectral characteristics of the resist. The illuminance of the light of a prescribed wavelength region, of the light from the light sources 101, can therefore be controlled such that an optimum, constant illuminance in accordance with the spectral characteristics of the resist is produced.

Also, even when there is a drop with time in the illuminance of the light sources 101, just as in the case of the exposure apparatus according to the fourth to sixth embodiments, control to an optimum, constant illuminance in accordance with the spectral characteristics of the resist can be achieved.

Also, in the case where the resist that is applied to the plate P has sensitivity only for light of a specific wavelength region, just as in the case of the exposure apparatus according to the fourth to sixth embodiments, the wavelength selection filters 106a, 106b are not necessary structures.

In this seventh embodiment also, it is assumed that a photoresist of sensitivity 20 mJ/cm² is applied to the plate P or that resin resist of sensitivity 60 mJ/cm² is applied. Recipe data including the spectral characteristics of this photoresist and resin resist is stored in the storage device 123. Consequently, the wavelength selection filter 106a or 106b is arranged in the optical path by the drive device 118 and the photosensitive filters 114b to 114f are controlled by the drive device 119 in accordance with the recipe data including the spectral characteristics of the resist so that the illuminance of the illuminating light can be made to be an optimum, constant illuminance, in accordance with the spectral characteristics of the photosensitive material that is applied to the plate P. Also, by controlling the power source device 136 that supplies power to the power source 110 in accordance with the illuminance on the plate P detected by the illumination sensor 124, the illuminance of the illuminating light on the plate P can be made to be an optimum, constant illuminance in accordance with the spectral characteristics of the resist that is applied to the plate P.

Also, just as in the case of the exposure apparatus according to the fourth to sixth embodiments, the illuminance on the plate P can be obtained from the illuminance detected by an illuminance sensor 129b even during exposure. The illuminance of the illuminating light on the plate P can therefore be made to be an optimum, constant illuminance in accordance with the spectral characteristics of the resist that is applied to the plate P, by controlling the wavelength selection filters 106a, 106b and the light-reducing filters 114b to 114f in accordance with this detected illuminance, or by controlling the power source device 136 that supplies power to the power source 101.

Although, in the embodiments described above, the case was described in which a photoresist of sensitivity 20 mJ/cm² or a resin resist of sensitivity 60 mJ/cm² was applied to the plate P, even when various different types of resist applied to the plate P are employed whose sensitivity is for example 20 mJ/cm² to 200 mJ/cm², exposure of the resist that has been applied to a substrate can be performed using optimum, exposure light with constant DOSE in accordance with the spectral characteristics of the resist that is applied to the substrate, by controlling the light-reducing filters 114b to 114f in accordance with the sensitivity of the resist applied to the plate P.

Also, in an exposure apparatus according to the embodiments described above, when detecting the illuminance of the exposure light on the plate P by means of the illuminance sensor 124, both light of a wavelength region including the g-line, h-line and i-line and light of a wavelength region including only the i-line were detected; however, specifically, there are available the technique of constituting an illuminance sensor 124 by adjacently arranging on the plate stage a first illuminance sensor that detects light of a wavelength region including the g-line, h-line and i-line and a second illuminance sensor that detects light of a wavelength region including only the i-line, the technique of providing wavelength branching means comprising for example a dichroic mirror in the illuminance sensor and using this wavelength branching means to direct light of a wavelength region including the g-line, h-line and i-line to the first illuminance sensor and light of a wavelength region including only the i-line to a second illuminance sensor, and the technique of providing wavelength filters in switchable fashion immediately upstream of an illuminance sensor so as to effect changeover of the light that is fed to the illuminance sensor between light of a wavelength region including the g-line, h-line and i-line and light of a wavelength region including only the i-line.

While embodiments of the present invention have been described above, the present invention is not restricted to the above embodiments but could be freely modified within the scope of the present invention. For example, although, in the embodiments described above, an exposure apparatus of the step and scan type was described by way of example, application would also be possible to an exposure apparatus of the step and repeat type.

Also, although, in the embodiments described above, the case was described of fabricating a liquid crystal display element, the present invention could of course be applied not merely to exposure apparatuses employed for fabricating liquid crystal display device but also to exposure apparatuses for transfer of a device pattern to a semiconductor substrate used in the fabrication of displays including semiconductor device etc., exposure apparatuses for transfer of device patterns to a ceramic wafer employed in the fabrication of thin-film magnetic heads and to exposure apparatuses employed for fabrication of image pickup device such as CCDs.

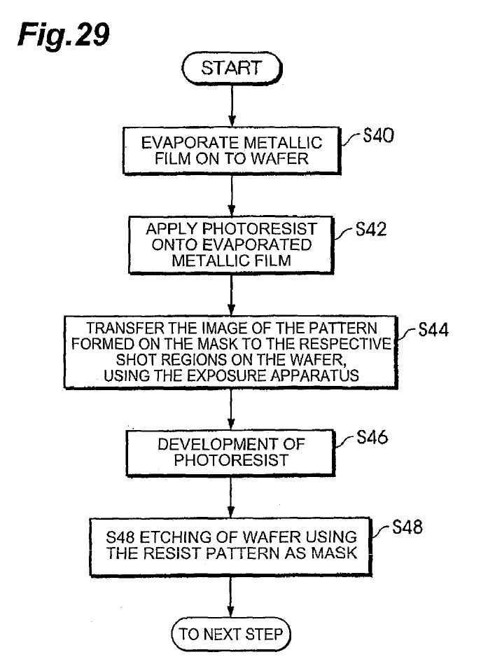

Next, a method of fabricating a microdevice wherein an exposure apparatus according to an embodiment of the present invention is employed in a lithographic step will be described. FIG. 29 is a flow chart of a technique used when obtaining a semiconductor device constituting a microdevice. First of all, in step S40 of FIG. 29, a metallic film is evaporated onto one lot of wafers. Next, in step S42, photoresist is applied onto the metallic film on this one lot of wafers. After this, instep S44, using an exposure apparatus according to an embodiment of the present invention, the image of a pattern on a mask M is transferred by successive exposure to shot regions on the wafers of this one lot, through the projection optical system (projection optical units) thereof. That is, the image of the pattern on the mask M is projected onto the substrate using the projection optical system by illuminating the mask M using the illumination device and exposure and transfer are thereby effected.

After this, in step S46, development of the photoresist on the wafers of this one lot is conducted and then, in step S48, a circuit pattern corresponding to the pattern on the mask is formed in each shot region on each wafer by performing etching using the resist patterns on the wafers of this one lot as masks. After this, devices such as semiconductor device are fabricated by forming circuit patterns in further layers thereon etc. With the method of fabricating semiconductor devices described above, semiconductor devices having very fine circuit patterns can be obtained with excellent throughput.

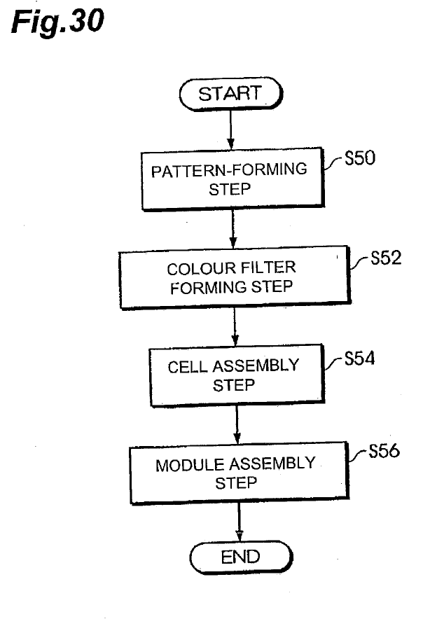

Also, with an exposure apparatus according to an embodiment of the present invention, a microdevice constituting a liquid crystal display element can be obtained by forming a prescribed pattern (circuit pattern, electrode pattern etc.) on a plate (glass or plastic substrate). An example of the technique which is then employed is described below with reference to the flow chart of FIG. 30. FIG. 30 is a flow chart given in explanation of a method of fabricating a liquid crystal display element constituting a microdevice by forming a prescribed pattern on a plate, using an exposure apparatus according to the present embodiment.

In the pattern-forming step S50 of FIG. 30, a so-called photolithographic step is performed wherein a mask pattern is transferred by exposure on to a photosensitive substrate (glass substrate to which a resist has been applied etc.) using an exposure apparatus according to this embodiment. By this photolithographic step, a prescribed pattern including a large number of electrodes etc. is formed on the photosensitive substrate. After this, the exposed substrate undergoes various steps such as a developing step, etching step and reticule exfoliation step to form a prescribed pattern on the substrate, which is then forwarded to the subsequent color filter forming step S52.

Next, in the color filter forming step S52, color filters are formed with a large number of sets of three dots corresponding to R (Red), G (Green) and B (blue) arranged in matrix fashion or a plurality of sets of filters with three R, G and B stripes arranged in the horizontal scanning direction. Then, after the color filter forming step S52, a cell assembly step S54 is performed. In the cell assembly step S54, liquid crystal panels (liquid crystal cells) are assembled using substrates having a prescribed pattern obtained in the pattern-forming step S50 and the color filters etc. obtained in the color filter forming step S52.

In the cell assembly step S54, the liquid crystal panels (liquid crystal cells) are fabricated by for example pouring in liquid crystal between these substrates having the prescribed patterns obtained in the pattern-forming step S50 and the color filters obtained in the color filter forming step S52. After this, in the module assembly step S56, the liquid crystal display device are completed by mounting the various components such as the back lights and electrical circuitry whereby the display action of the assembled liquid crystal panel (liquid crystal cell) is performed. With the method of fabricating liquid-crystal display device described above, liquid-crystal display device having extremely fine circuit patterns can be obtained with excellent throughput.

As described above, with an exposure apparatus according to the first aspect of the present invention, the benefit is obtained that photosensitive substrates having various different photosensitivity characteristics can be exposed in an appropriate manner, since it is arranged to obtain the exposure power required for the exposure in accordance with the photosensitivity characteristics of the photosensitive substrate by varying the exposure power by changing over the wavelength width of the light that is directed onto the mask in accordance with the photosensitivity characteristics of the photosensitive substrate.

Also, with an exposure apparatus according to the second aspect of the present invention, transfer of a pattern can be performed with a fully sufficient required resolution both in the case where a fine pattern that requires high resolution is transferred and in the case where a pattern that does not require such a high resolution is transferred, since the wavelength width of the light that is directed onto the mask is changed over in accordance with the resolution of the pattern that is transferred to the photosensitive substrate. Also, the exposure power is changed when the wavelength width of the light that is directed onto the mask is changed over. Consequently, the benefit is obtained that a pattern with the required resolution can be formed in an excellent manner both in the case where for example a pattern must be formed with high resolution on a photosensitive substrate having photosensitivity characteristics such that high exposure power is not required and in the case where a pattern is formed with a resolution which is not particularly high on a photosensitive substrate having photosensitivity characteristics such that high exposure power is required.

Furthermore, with an exposure apparatus according to the third aspect of the present invention, the benefit is obtained that the mask pattern can be faithfully transferred to the photosensitive substrate, since illumination optical characteristics information indicating the optical characteristics of the illumination system that are suitable for transfer of the mask pattern to the photosensitive substrate are found beforehand for each wavelength width of the light that is directed onto the mask, the optical characteristics of the illumination optical system are adjusted in accordance with the illumination optical characteristics information when the wavelength width of the light that is directed onto the mask is changed over, and the illumination conditions of the mask can thereby be optimized for each wavelength width of the light that is directed onto the mask.

Furthermore, with an exposure apparatus according to the fourth aspect of the present invention, the benefit is obtained that the mask pattern can be faithfully transferred to the photosensitive substrate by adjusting the optical characteristics of the illumination optical system optimally in accordance with the actually detected optical characteristics, since the optical characteristics of the illumination optical system are detected when the wavelength width of the light that is directed onto the mask is changed over, and the optical characteristics of the illumination optical system are adjusted in accordance with the result of this detection.

Yet further, with an exposure apparatus according to the fifth aspect of the present invention, the benefit is obtained that the intensity at each wavelength width of the light that is directed onto the mask can be accurately detected even when for example the sensor has wavelength dependence, since the characteristics of the sensor that detects the intensity of the light that is directed onto the mask are adjusted every time the wavelength width of the light that is directed onto the mask is changed over.

Also, with an exposure apparatus according to the sixth aspect of the present invention, the benefit is obtained that, since the projection conditions of the pattern that is transferred to the photosensitive substrate can be optimized for each wavelength of the light that is directed onto the mask by adjusting at least one of the optical characteristics of the projection optical system, the position of the projection optical system along the optical axis direction, the position of the mask along the optical axis direction and the position of the photosensitive substrate along the optical axis direction in accordance with projection optical characteristics information when the wavelength width of the light that is directed onto the mask is changed over, by finding beforehand projection optical characteristics information indicating the optical characteristics of the projection optical system that are appropriate to the transfer of the pattern on the mask to the photosensitive substrate, for each wavelength width of the light that is directed onto the mask, the mask pattern can be faithfully transferred to the photosensitive substrate.

Furthermore, with an exposure apparatus according to the seventh aspect of the present invention, the benefit is obtained that, since the optical characteristics of the projection optical system are detected when the wavelength width of the light that is directed onto the mask is changed over and at least one of the optical characteristics of the projection optical system, the position of the projection optical system along the optical axis direction, the position of the mask along the optical axis direction and the position of the photosensitive substrate along the optical axis direction is adjusted in accordance with the results of this detection, the mask pattern can be faithfully transferred to the photosensitive substrate by optimally adjusting the optical characteristics of the projection optical system in accordance with the optical characteristics that are actually detected.

Also, with an exposure apparatus according to the eighth aspect of the present invention, the benefit is obtained that, since variation information indicating the relationship between the period of illumination in respect of the projection optical system and the amount of variation of the optical characteristics of the projection optical system for each wavelength width that is changed over is obtained beforehand and at least one of the optical characteristics of the projection system, the position of the projection optical system along the optical axis direction, the position of the mask along the optical axis direction and the position of the photosensitive substrate along the optical axis direction is adjusted in accordance with the variation information when the wavelength width of the light that is directed onto the mask is changed over and the projection conditions of the pattern that is transferred to the photosensitive substrate can thereby be optimized for each wavelength width of the light that is directed onto the mask, the mask pattern can be faithfully transferred to the photosensitive substrate.

Also, with an exposure apparatus according to the ninth aspect of the present invention, the benefit is obtained that, since, when the wavelength width of the light that is directed onto the mask is changed over, the position measurement device that measures the position of the photosensitive substrate placed on the substrate stage using this light finds a reference position of the substrate stage by measuring the position of a reference member provided on the substrate stage that specifies a reference position of the substrate stage, the position of the photosensitive substrate on the substrate stage can be accurately measured even when the wavelength width of the light that is directed onto the mask is changed over.

Furthermore, with an exposure apparatus according to the tenth aspect of the present invention, the benefit is obtained that, since the position where the pattern that is formed on the mask is projected is measured by a first measurement device when the wavelength width of the light that is directed onto the mask is changed over even when the wavelength width of the light that is directed onto the mask is changed, an accurate value of the position of the photosensitive substrate with respect to the projection position of the pattern can be found from the measurement results of the first measurement device and the measurement results of a mark on the photosensitive substrate obtained by a second measurement device provided laterally with respect to the projection optical system.

With an exposure apparatus according to the eleventh aspect of the present invention, the illuminance of the light from the light source is detected by illuminance detection means arranged in the illumination device, so the illuminance of the light from the light source can be controlled so as to be a constant illuminance in accordance with the spectral characteristics of the photosensitive material, by using this detected value and recipe data including information regarding the spectral characteristics of the photosensitive material. Exposure of the photosensitive material can therefore be performed using illuminating light of optimum, constant illuminance in accordance with the spectral characteristics of the photosensitive material that is applied to the substrate.

Also, with the method of exposure according to the present invention, exposure of the photosensitive material can be performed using illuminating light of optimum, constant illuminance in accordance with the spectral characteristics of the photosensitive material that is applied to the substrate, since, by the illumination step, the mask is illuminated with an illuminance based on the sensitivity of the photosensitive material that was applied to the substrate.

The basic Japanese Application Nos. 2002-002623 filed on Jan. 9, 2002 and 2002-99814 filed on Apr. 2, 2002 are hereby incorporated by reference.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An exposure apparatus for transferring a pattern formed on a mask to a photosensitive substrate, comprising:
a light source; and
an illumination optical system that illuminates the mask with light from this light source,
wherein said illumination optical system comprises wavelength width changeover means that changes over the wavelength width of the light that is directed onto said mask in accordance with the photosensitivity characteristics of said photosensitive substrate.

2. The exposure apparatus according to claim 1 comprising:
storage means that stores processing information indicating the processes and the processing sequence in respect of said photosensitive substrate; and
control means that controls said wavelength width changeover means in accordance with said processing information.

3. The exposure apparatus according to claim 2, wherein said storage means stores beforehand illumination optical characteristics information indicating the optical characteristics of said illumination optical system that are appropriate for transfer of said pattern onto said photosensitive substrate for each wavelength width to which changeover is effected by said wavelength width changeover means; and
said control means adjusts the optical characteristics of said illumination optical system in accordance with said illumination optical characteristics information stored in said storage means when the wavelength width of the light that is directed onto said mask is changed over, by controlling said wavelength width changeover means.

4. The exposure apparatus according to claim 3, comprising illumination optical characteristics detection means that detects the optical characteristics of said illumination optical system, and
wherein said control means adjusts the optical characteristics of said illumination optical system while referring to the detection results of said illumination optical characteristics detection means, when the wavelength width of the light that is directed onto said mask is changed over by controlling said wavelength width changeover means.

5. The exposure apparatus according to claim 1, further comprising a projection optical system that projects the pattern of said mask onto said photosensitive substrate;
a mask stage on which said mask is placed; and
a substrate stage on which said photosensitive substrate is placed;
wherein at least one of said mask stage and said substrate stage is constructed to be capable of movement in a direction along the optical axis of said projection optical system.

6. The exposure apparatus according to claim 5, wherein said storage means stores beforehand projection optical characteristics information indicating the optical characteristics of said projection optical system appropriate to transfer of said pattern onto said photosensitive substrate for each wavelength width that is changed over by said wavelength width changeover means; and
said control means adjusts at least one of the optical characteristics of said projection optical system, the position of said mask along said optical axis direction and the position of said photosensitive substrate along said optical axis direction in accordance with said projection optical characteristics information stored in said storage means when the wavelength width of the light that is directed onto the mask is changed over by controlling said wavelength width changeover means.

7. The exposure apparatus according to claim 6, comprising projection optical characteristics detection means that detects the optical characteristics of said projection optical system, and
wherein said control means adjusts at least one of the optical characteristics of said projection optical system, the position of said mask along said optical axis direction and the position of said photosensitive substrate along said optical axis direction while referring to the detection results of said projection optical characteristics detection means when the wavelength width of the light that is directed onto said mask is changed over by controlling said wavelength width changeover means.

8. The exposure apparatus according to claim 7, wherein said storage means stores beforehand variation information indicating the relationship between the period of illumination in respect of said projection optical system and the amount of variation of the optical characteristics of said projection optical system for each wavelength width that is changed over by said wavelength width changeover means; and
said control means adjusts at least one of the optical characteristics of said projection system, the position of said mask along said optical axis direction and the position of said photosensitive substrate along said optical axis direction in accordance with the illumination history in respect of said mask and said variation information.

9. An exposure method comprising:
an illumination step of illuminating said mask using an exposure apparatus according to claim 1; and
an exposure step of transferring a pattern formed on said mask onto said photosensitive substrate.

10. An exposure apparatus for transferring a pattern formed on a mask to a photosensitive substrate, comprising:
a light source; and
an illumination optical system that illuminates the mask with light from this light source,
wherein said illumination optical system comprises wavelength width changeover means that changes over the wavelength width of the light that is directed onto said mask in accordance with the resolution of the pattern that is transferred onto said photosensitive substrate.

11. The exposure apparatus according to claim 10 comprising:
storage means that stores processing information indicating the processes and the processing sequence in respect of said photosensitive substrate; and
control means that controls said wavelength width changeover means in accordance with said processing information.

12. The exposure apparatus according to claim 11, wherein said storage means stores beforehand illumination optical characteristics information indicating the optical characteristics of said illumination optical system that are appropriate for transfer of said pattern onto said photosensitive substrate for each wavelength width to which changeover is effected by said wavelength width changeover means; and
said control means adjusts the optical characteristics of said illumination optical system in accordance with said illumination optical characteristics information stored in said storage means when the wavelength width of the light that is directed onto said mask is changed over, by controlling said wavelength width changeover means.

13. The exposure apparatus according to claim 12, comprising illumination optical characteristics detection means that detects the optical characteristics of said illumination optical system; and
wherein control means adjusts the optical characteristics of said illumination optical system while referring to the detection results of said illumination optical characteristics detection means, when the wavelength width of the light that is directed onto said mask is changed over by controlling said wavelength width changeover means.

14. The exposure apparatus according to claim 10, further comprising:
a projection optical system that projects the pattern of said mask onto said photosensitive substrate;
a mask stage on which said mask is placed; and
a substrate stage on which said photosensitive substrate is placed; and
wherein at least one of said mask stage and said substrate stage is constructed to be capable of movement in a direction along the optical axis of said projection optical system.

15. The exposure apparatus according to claim 14, wherein said storage means stores beforehand projection optical characteristics information indicating the optical characteristics of said projection optical system appropriate to transfer of said pattern onto said photosensitive substrate for each wavelength width that is changed over by said wavelength width changeover means; and
said control means adjusts at least one of the optical characteristics of said projection optical system, the position of said mask along said optical axis direction and the position of said photosensitive substrate along said optical axis direction in accordance with said projection optical characteristics information stored in said storage means when the wavelength width of the light that is directed onto the mask is changed over by controlling said wavelength width changeover means.

16. The exposure apparatus according to claim 15, comprising projection optical characteristics detection means that detects the optical characteristics of said projection optical system; and
wherein said control means adjusts at least one of the optical characteristics of said projection optical system, the position of said mask along said optical axis direction and the position of said photosensitive substrate along said optical axis direction while referring to the detection results of said projection optical characteristics detection means when the wavelength width of the light that is directed onto said mask is changed over by controlling said wavelength width changeover means.

17. The exposure apparatus according to claim 16, wherein said storage means stores beforehand variation information indicating the relationship between the period of illumination in respect of said projection optical system and the amount of variation of the optical characteristics of said projection optical system for each wavelength width that is changed over by said wavelength width changeover means; and
said control means adjusts at least one of the optical characteristics of said projection system, the position of said mask along said optical axis direction and the position of said photosensitive substrate along said optical axis direction in accordance with the illumination history in respect of said mask and said variation information.

18. An exposure method comprising:
an illumination step of illuminating said mask using an exposure apparatus according to claim 10; and
an exposure step of transferring a pattern formed on said mask onto said photosensitive substrate.

19. An exposure apparatus for transferring a pattern formed on a mask to a photosensitive substrate, comprising:
a light source; and
an illumination optical system that illuminates the mask with light from this light source,
wherein said illumination optical system comprises:
wavelength width changeover means that changes over the wavelength width of the light that is directed onto said mask;
storage means that stores illumination optical characteristics information indicating the optical characteristics of said illumination optical system appropriate to transfer of said pattern onto said photosensitive substrate for each wavelength width to which changeover is effected by said wavelength width changeover means; and
control means that adjusts the optical characteristics of said illumination optical system in accordance with said illumination optical system characteristics information stored in said storage means when the wavelength width of the light that is directed onto said mask is changed over by controlling said wavelength width changeover means.

20. The exposure apparatus according to claim 19, wherein the optical characteristics of said illumination optical system include at least one of the telecentricity of said illumination optical system and the illuminance unevenness of the light that is directed onto said mask.

21. The exposure apparatus according to claim 20, wherein said illuminating optical system comprises a plurality of illumination optical paths for forming a plurality of illumination regions on said mask; and
said control means adjusts the optical characteristics of said illumination optical system for each of said plurality of illumination optical paths.

22. The exposure apparatus according to claim 19, wherein said illuminating optical system comprises a sensor that detects the intensity of the light that is directed onto said mask; and
said control means adjusts the characteristics of said sensor in accordance with said wavelength width when the wavelength width of the light that is directed onto said mask is changed over by controlling said wavelength width changeover means.

23. The exposure apparatus according claim 19, further comprising:
a projection optical system that projects the pattern on said mask onto said photosensitive substrate;
a mask stage on which said mask is placed; and
a substrate stage on which said photosensitive substrate is placed;
wherein at least one of said mask stage and said substrate stage is constructed so as to be capable of movement in the direction along the optical axis of said projection optical system.

24. The exposure apparatus according to claim 23, wherein said storage means stores beforehand projection optical characteristics information indicating the optical characteristics of said projection optical system that are appropriate for transfer of said pattern onto said photosensitive substrate for each wavelength width to which changeover is effected by said wavelength width changeover means; and
said control means adjusts at least one of the optical characteristics of said projection optical system, the position of said mask along said optical axis direction and the position of said photosensitive substrate along said optical axis direction in accordance with said projection optical characteristics information stored in said storage means when the wavelength width of the light that is directed onto said mask is changed over by controlling said wavelength width changeover means.

25. The exposure apparatus according to claim 24, comprising projection optical characteristics detection means that detects the optical characteristics of said projection optical system; and
wherein said control means adjusts at least one of the optical characteristics of said projection optical system, the position of said mask along said optical axis direction and the position of said photosensitive substrate along said optical axis direction while referring to the detection results of said projection optical characteristics detection means, when the wavelength width of the light that is directed onto said mask is changed over by controlling said wavelength width changeover means.

26. The exposure apparatus according to claim 25, wherein said storage means stores beforehand variation information indicating the relationship between the period of illumination in respect of said projection optical system and the amount of variation of the optical characteristics of said projection optical system for each wavelength width that is changed over by said wavelength width changeover means; and
said control means adjusts at least one of the optical characteristics of said projection system, the position of said mask along said optical axis direction and the position of said photosensitive substrate along said optical axis direction in accordance with the illumination history in respect of said mask and said variation information.

27. An exposure method comprising:
an illumination step of illuminating said mask using an exposure apparatus according to claim 1; and
an exposure step of transferring a pattern formed on said mask onto said photosensitive substrate.

28. An exposure apparatus for transferring a pattern formed on a mask to a photosensitive substrate, comprising:
a light source; and
an illumination optical system that illuminates the mask with light from this light source;
wherein said illumination optical system comprises:
wavelength width changeover means that changes over the wavelength width of the light that is directed onto said mask;
illumination optical characteristics detection means that detects the optical characteristics of said illumination optical system; and
control means that adjusts the optical characteristics of said illumination optical system in accordance with the detection results of said illumination optical characteristics detection means when the wavelength width of the light that is directed onto said mask is changed over by controlling said wavelength width changeover means.

29. The exposure apparatus according to claim 28, wherein the optical characteristics of said illumination optical system include at least one of the telecentricity of said illumination optical system and the illuminance unevenness of the light that is directed onto said mask.

30. The exposure apparatus according to claim 29, wherein said illuminating optical system comprises a plurality of illumination optical paths for forming a plurality of illumination regions on said mask; and
said control means adjusts the optical characteristics of said illumination optical system for each of said plurality of illumination optical paths.

31. The exposure apparatus according to claim 28, wherein said illuminating optical system comprises a sensor that detects the intensity of the light that is directed onto said mask; and
said control means adjusts the characteristics of said sensor in accordance with said wavelength width when the wavelength width of the light that is directed onto said mask is changed over by controlling said wavelength width changeover means.

32. The exposure apparatus according claim 28, further comprising:
a projection optical system that projects the pattern on said mask onto said photosensitive substrate;
a mask stage on which said mask is placed; and
a substrate stage on which said photosensitive substrate is placed;
wherein at least one of said mask stage and said substrate stage is constructed so as to be capable of movement in the direction along the optical axis of said projection optical system.

33. The exposure apparatus according to claim 32, wherein said storage means stores beforehand projection optical characteristics information indicating the optical characteristics of said projection optical system that are appropriate for transfer of said pattern onto said photosensitive substrate for each wavelength width to which changeover is effected by said wavelength width changeover means; and
said control means adjusts at least one of the optical characteristics of said projection optical system, the position of said mask along said optical axis direction and the position of said photosensitive substrate along said optical axis direction in accordance with said projection optical characteristics information stored in said storage means when the wavelength width of the light that is directed onto said mask is changed over by controlling said wavelength width changeover means.

34. The exposure apparatus according to claim 33, comprising projection optical characteristics detection means that detects the optical characteristics of said projection optical system; and
wherein said control means adjusts at least one of the optical characteristics of said projection optical system, the position of said mask along said optical axis direction and the position of said photosensitive substrate along said optical axis direction while referring to the detection results of said projection optical characteristics detection means, when the wavelength width of the light that is directed onto said mask is changed over by controlling said wavelength width changeover means.

35. The exposure apparatus according to claim 34, wherein said storage means stores beforehand variation information indicating the relationship between the period of illumination in respect of said projection optical system and the amount of variation of the optical characteristics of said projection optical system for each wavelength width that is changed over by said wavelength width changeover means; and
said control means adjusts at least one of the optical characteristics of said projection system, the position of said mask along said optical axis direction and the position of said photosensitive substrate along said optical axis direction in accordance with the illumination history in respect of said mask and said variation information.

36. An exposure method comprising:
an illumination step of illuminating said mask using an exposure apparatus according to claim 28; and
an exposure step of transferring a pattern formed on said mask onto said photosensitive substrate.

37. An exposure apparatus for transferring a pattern formed on a mask to a photosensitive substrate, comprising:
a light source; and
an illumination optical system that illuminates the mask with light from this light source
wherein said illumination optical system comprises:
wavelength width changeover means that changes over the wavelength width of the light that is directed onto said mask;
a sensor that detects the intensity of the light directed onto said mask; and
control means that adjusts the characteristics of said sensor in accordance with said wavelength width when the wavelength width of the light that is directed onto said mask is changed over by controlling said wavelength width changeover means.

38. The exposure apparatus according to claim 37, wherein said illuminating optical system comprises a plurality of illumination optical paths for forming a plurality of illumination regions on said mask; and
said sensor comprises a plurality of sensors for detecting the intensity of the light on each of said plurality of illumination optical paths.

39. The exposure apparatus according claim 37, further comprising:
a projection optical system that projects the pattern on said mask onto said photosensitive substrate;
a mask stage on which said mask is placed; and
a substrate stage on which said photosensitive substrate is placed;
wherein at least one of said mask stage and said substrate stage is constructed so as to be capable of movement in the direction along the optical axis of said projection optical system.

40. The exposure apparatus according to claim 39, wherein said storage means stores beforehand projection optical characteristics information indicating the optical characteristics of said projection optical system that are appropriate for transfer of said pattern onto said photosensitive substrate for each wavelength width to which changeover is effected by said wavelength width changeover means; and
said control means adjusts at least one of the optical characteristics of said projection optical system, the position of said mask along said optical axis direction and the position of said photosensitive substrate along said optical axis direction in accordance with said projection optical characteristics information stored in said storage means when the wavelength width of the light that is directed onto said mask is changed over by controlling said wavelength width changeover means.

41. The exposure apparatus according to claim. 40, comprising projection optical characteristics detection means that detects the optical characteristics of said projection optical system, and
wherein said control means adjusts at least one of the optical characteristics of said projection optical system, the position of said mask along said optical axis direction and the position of said photosensitive substrate along said optical axis direction while referring to the detection results of said projection optical characteristics detection means, when the wavelength width of the light that is directed onto said mask is changed over by controlling said wavelength width changeover means.

42. The exposure apparatus according to claim 41, wherein said storage means stores beforehand variation information indicating the relationship between the period of illumination in respect of said projection optical system and the amount of variation of the optical characteristics of said projection optical system for each wavelength width that is changed over by said wavelength width changeover means; and
said control means adjusts at least one of the optical characteristics of said projection system, the position of said mask along said optical axis direction and the position of said photosensitive substrate along said optical axis direction in accordance with the illumination history in respect of said mask and said variation information.

43. An exposure method comprising:
an illumination step of illuminating said mask using an exposure apparatus according to claim 37; and
an exposure step of transferring a pattern formed on said mask onto said photosensitive substrate.

44. An exposure apparatus comprising:
a light source;
an illumination optical system that illuminates a mask with light from this light source;
a projection optical system that projects a pattern formed on said mask onto a photosensitive substrate using light from this illumination optical system;
a mask stage on which said mask is placed;
a substrate stage on which said photosensitive substrate is placed;
wavelength width changeover means that changes over the wavelength width of the light that is directed onto said mask;
storage means that stores projection optical characteristics information indicating the optical characteristics of the projection optical system that are appropriate for transfer of said pattern onto said photosensitive substrate for each wavelength width that is changed over by said wavelength width changeover means; and
control means that controls said wavelength width changeover means;
wherein at least one of said mask stage and said substrate stage is constructed so as to be capable of movement in the direction along the optical axis of said projection optical system; and
said control means adjusts at least one of the optical characteristics of said projection optical system, the position of said mask along said optical axis direction and the position of said photosensitive substrate along said optical axis direction in accordance with said projection optical characteristics information stored in said storage means when the wavelength width of the light that is directed onto said mask is changed over by controlling said wavelength width changeover means.

45. The exposure apparatus according to claim 44, wherein the optical characteristics of said projection optical system include at least one of the position of the focal point of said projection optical system, the magnification, the image position, the image rotation, curvature of field aberration, astigmatic aberration and distortion aberration.

46. The exposure apparatus according to claim 45, wherein said projection optical system comprises a plurality of projection optical systems for projecting respective mask images onto said photosensitive substrate; and
said control means adjusts the optical characteristics of said projection optical system for each of said plurality of projection optical systems.

47. The exposure apparatus according to claim 44, comprising a position measurement device that measures the position of a reference member formed on said substrate stage and a mark formed on said photosensitive substrate using light of wavelength width that is changed over by said wavelength width changeover means and that finds the position of the photosensitive substrate placed on said substrate stage based on the respective measurement results,
wheein said position measurement device finds the reference position of said substrate stage by measuring the position of said reference member every time the wavelength width of the light that is directed onto said mask is changed over by said control means controlling said wavelength width changeover means.

48. The exposure apparatus according to claim 44, comprising:
a first measurement device that measures the position where the pattern that is formed on said mask is projected;
a second measurement device provided laterally with respect to said projection optical system and that measures the mark that is formed on said photosensitive substrate that is placed on said substrate stage; and
position calculating means that finds the position of said photosensitive substrate with respect to the position where said pattern is projected based on the measurement result of the said first measurement device and the measurement result of the said second measurement device;
wherein the first measurement device finds the position where said pattern is projected every time the wavelength width of the light that is directed onto said mask is changed over by said control means control ling said wavelength width changeover means.

49. An exposure method comprising:
an illumination step of illuminating said mask using an exposure apparatus according to claim 44; and
an exposure step of transferring a pattern formed on said mask onto said photosensitive substrate.

50. An exposure apparatus comprising:
a light source;
an illumination optical system that illuminates a mask with light from this light source
a projection optical system that projects a pattern formed on said mask onto a photosensitive substrate using light from this illumination optical system;
a mask stage on which said mask is placed;
a substrate stage on which said photosensitive substrate is placed;
wavelength width changeover means that changes over the wavelength width of the light that is directed onto said mask;
projection optical characteristics detection means that detects the optical characteristics of said projection optical system; and
control means that controls said wavelength width changeover means;
wherein at least one of said mask stage and said substrate stage is constructed so as to be capable of movement in the direction along the optical axis of said projection optical system; and
said control means adjusts at least one of the optical characteristics of said projection optical system, the position of said mask along said optical axis direction and the position of said photosensitive substrate along said optical axis direction in accordance with the detection results of said projection optical characteristics detection means when the wavelength width of the light that is directed onto said mask is changed over by controlling said wavelength width changeover means.

51. The exposure apparatus according to claim 50, wherein the optical characteristics of said projection optical system include at least one of the position of the focal point of said projection optical system, the magnification, the image position, the image rotation, curvature of field aberration, astigmatic aberration and distortion aberration.

52. The exposure apparatus according to claim 51, wherein said projection optical system comprises a plurality of projection optical systems for projecting respective mask images onto said photosensitive substrate; and
said control means adjusts the optical characteristics of said projection optical system for each of said plurality of projection optical systems.

53. The exposure apparatus according to claim 50, comprising a position measurement device that measures the position of a reference member formed on said substrate stage and a mark formed on said photosensitive substrate using light of wavelength width that is changed over by said wavelength width change over means and that finds the position of the photosensitive substrate placed on said substrate stage based on the respective measurement results,
wherein said position measurement device finds the reference position of said substrate stage by measuring the position of said reference member every time the wavelength width of the light that is directed onto said mask is changed over by said control means controlling said wavelength width changeover means.

54. The exposure apparatus according to claim 50, comprising:
a first measurement device that measures the position where the pattern that is formed on said mask is projected;
a second measurement device provided laterally with respect to said projection optical system and that measures the mark that is formed on said photosensitive substrate that is placed on said substrate stage; and
position calculating means that finds the position of said photosensitive substrate with respect to the position where said pattern is projected based on the measurement result of the said first measurement device and the measurement result of the said second measurement device;
in which said first measurement device finds the position where said pattern is projected every time the wavelength width of the light that is directed onto said mask is changed over by said control means controlling said wavelength width changeover means.

55. An exposure method comprising:
an illumination step of illuminating said mask using an exposure apparatus according to claim 50; and
an exposure step of transferring a pattern formed on said mask onto said photosensitive substrate.

56. An exposure apparatus comprising:
a light source;
an illumination optical system that illuminates a mask with light from this light source;
a projection optical system that projects a pattern formed on said mask onto a photosensitive substrate using light from this illumination optical system;
a mask stage on which said mask is placed;
a substrate stage on which said photosensitive substrate is placed;
wavelength width changeover means that changes over the wavelength width of the light that is directed onto said mask;
storage means that stores variation information indicating the relationship between the period of illumination in respect of said projection optical system and the amount of variation of the optical characteristics of said projection optical system for each wavelength width that is changed over by said wavelength width changeover means; and
control means that controls said wavelength width changeover means;
wherein at least one of said mask stage and said substrate stage is constructed so as to be capable of movement in the direction along the optical axis of said projection optical system; and
said control means adjusts at least one of the optical characteristics of said projection optical system, the position of said mask along said optical axis direction and the position of said photosensitive substrate along said optical axis direction in accordance with the variation information stored in said storage means when the wavelength width of the light that is directed onto said mask is changed over by controlling said wavelength width changeover means.

57. The exposure apparatus according to claim 56, wherein the optical characteristics of said projection optical system include at least one of the position of the focal point of said projection optical system, the magnification, the image position, the image rotation, curvature of field aberration, astigmatic aberration and distortion aberration.

58. The exposure apparatus according to claim 57, wherein said projection optical system comprises a plurality of projection optical systems for projecting respective mask images onto said photosensitive substrate; and
said control means adjusts the optical characteristics of said projection optical system for each of said plurality of projection optical systems.

59. The exposure apparatus according to claim 56, comprising a position measurement device that measures the position of a reference member formed on said substrate stage and a mark formed on said photosensitive substrate using light of wavelength width that is changed over by said wavelength width changeover means and that finds the position of the photosensitive substrate placed on said substrate stage based on the respective measurement results,
wherein said position measurement device finds the reference position of said substrate stage by measuring the position of said reference member every time the wavelength width of the light that is directed onto said mask is changed over by said control means controlling said wavelength width changeover means.

60. The exposure apparatus according to claim 56, comprising:
a first measurement device that measures the position where the pattern that is formed on said mask is projected;
a second measurement device provided laterally with respect to said projection optical system and that measures the mark that is formed on said photosensitive substrate that is placed on said substrate stage; and
position calculating means that finds the position of said photosensitive substrate with respect to the position where said pattern is projected based on the measurement result of the said first measurement device and the measurement result of the said second measurement device;
wherein said first measurement device finds the position where said pattern is projected every time the wavelength width of the light that is directed onto said mask is changed over by said control means controlling said wavelength width changeover means.

61. An exposure method comprising:
an illumination step of illuminating said mask using an exposure apparatus according to claim 56; and
an exposure step of transferring a pattern formed on said mask onto said photosensitive substrate.

62. An exposure apparatus comprising:
a light source;
an illumination optical system that illuminates a mask with light from this light source;
a projection optical system that projects a pattern formed on said mask onto a photosensitive substrate using light from this illumination optical system;
a mask stage on which said mask is placed;
a substrate stage on which said photosensitive substrate is placed;
wavelength width changeover means that changes over the wavelength width of the light that is directed onto said mask;
control means that controls said wavelength width changeover means; and
a position measurement device that measures the position of a reference member formed on said substrate stage and a mark formed on said photosensitive substrate using light of wavelength width that is changed over by said wavelength width changeover means and that finds the position of the photosensitive substrate placed on said substrate stage from the respective measurement results;
wherein said position measurement device finds the reference position of said substrate stage by measuring the position of said reference member every time the wavelength width of the light that is directed onto said mask is changed over by said control means controlling said wavelength width changeover means.

63. An exposure method comprising:
an illumination step of illuminating said mask using an exposure apparatus according to claim 62; and
an exposure step of transferring a pattern formed on said mask onto said photosensitive substrate.

64. An exposure apparatus comprising:
a light source;
an illumination optical system that illuminates a mask with light from this light source;
a projection optical system that projects a pattern formed on said mask onto a photosensitive substrate using light from this illumination optical system;
a mask stage on which said mask is placed;
a substrate stage on which said photosensitive substrate is placed;
wavelength width changeover means that changes over the wavelength width of the light that is directed onto said mask;
control means that controls said wavelength width changeover means;
a first measurement device that measures the position where the pattern that is formed on said mask is projected;
a second measurement device provided laterally with respect to said projection optical system and that measures the mark that is formed on said photosensitive substrate that is placed on said substrate stage; and
position calculating means that finds the position of said photosensitive substrate with respect to the position where said pattern is projected based on the measurement result of the said first measurement device and the measurement result of the said second measurement device;
wherein said first measurement device measures the position where said pattern is projected every time the wavelength width of the light that is directed onto said mask is changed over by said control means controlling said wavelength width changeover means.

65. An exposure method comprising:
an illumination step of illuminating said mask using an exposure apparatus according to claim 64; and
an exposure step of transferring a pattern formed on said mask onto said photosensitive substrate.

66. An exposure method for transferring a pattern formed on a mask to a photosensitive substrate by directing light from a light source on to this mask,
wherein said method comprises a changeover step of changing over the wavelength width of the light that is directed onto said mask in accordance with the photosensitivity characteristics of said photosensitive substrate.

67. The exposure method according to claim 66, wherein, in said changeover step, the wavelength width of the light that is directed onto said mask is changed over in accordance with the resolution of the pattern that is to be transferred onto said photosensitive substrate.

68. The exposure method according to claim 67, further comprising a correction step of correcting changes in the optical characteristics produced by changeover of said wavelength width in association with execution of said changeover step.

69. The exposure method according to claim 66, further comprising a correction step of correcting changes in the optical characteristics produced by changeover of said wavelength width in association with execution of said changeover step.

70. An exposure apparatus for transferring a pattern formed on a mask to a substrate to which a photosensitive material has been applied, comprising:
an illumination device comprising a light source and illuminance detection means that detects the illuminance of the light from this light source and that exercises control such that the light from said light source has a constant illuminance, in accordance with recipe data including the detection value from this illuminance detection means and information relating to the spectral characteristics of said photosensitive material; and
a projection optical system that projects said pattern on the mask illuminated with light from said illumination device on to said substrate.

71. The exposure apparatus according to claim 70, wherein said illumination device further comprises wavelength region alteration means that alters the wavelength region of light from said light source; and
control is exercised such that light of wavelength altered by said wavelength region alteration means has a constant illuminance in accordance with said recipe data including information relating to the spectral characteristics of said photosensitive material and the detection value from said illuminance detection means.

72. The exposure apparatus according to claim 70, wherein said illumination device comprises a plurality of light sources, a plurality of illuminance detection means that detect the illuminance of the light sources and a plurality of wavelength region alteration means that alter the wavelength regions of the light from said light sources; and
wherein control is exercised such that light whose wavelength region has been altered by said wavelength region alteration means has a constant illuminance in accordance with the detection value from said illuminance detection means.

73. The exposure apparatus according to claim 72, wherein said illuminance detection means respectively detects the illuminance of the light of a plurality of wavelength regions having mutually different wavelength distributions.

74. The exposure apparatus according to claim 73, wherein said illumination device comprises a reflecting mirror that reflects illuminating light from said light source towards said mask; and
said illuminance detection means detects the illuminance of the light from said light source by using the leakage light from said reflection mirror.

75. The exposure apparatus according to claim 74, further comprising an illuminance sensor that detects the illuminance on said substrate.

76. The illuminance device according to claim 70, further comprising an illuminance sensor that detects the illuminance on said substrate.

77. The exposure apparatus according to claim 76, wherein said illuminance sensor that detects the illuminance on said substrate is placed on said substrate stage.

78. The exposure apparatus according to claim 76, wherein said illuminance sensor that detects the illuminance on said substrate is a sensor that detects the illuminance at a position that is optically conjugate with said substrate.

79. The exposure apparatus according to claim 76, wherein said illuminance sensor respectively detects the illuminance of light of a plurality of wavelength regions having mutually different wavelength distributions.

80. The exposure apparatus according to claim 79, further comprising light-adjustment means that adjusts the illuminance of the light from said light source, and
wherein said light source or said light-adjustment means is controlled in accordance with the illuminance of the light of the plurality of wavelength regions having mutually different wavelength distribution detected by said illuminance sensor.

81. The exposure apparatus according to claim 70, wherein said illuminance detection means respectively detects the illuminance of light of a plurality of wavelength regions having mutually different wavelength distributions.

82. An exposure method employing an exposure apparatus according to claim 70, comprising:
an illumination step of illuminating the mask using said illumination device; and
a projection step of projecting an image of the pattern on said mask onto said substrate using said projection optical system.
